(19) United States
(12) Patent Application Publication
(10) Pub. No.: US 2006/0110743 A1
(43) Pub. Date: May 25, 2006

(54) Drug evolution: drug design at hot spots

(76) Inventors: Yasuo Konishi, Kirkland (CA); Sung Ju Cho, Montreal (CA); Alicja Kluczyk, Wroclaw (PL); Carmen Lazar, Montreal (CA); Taira Kiyota, Montreal (CA)

Correspondence Address: IRA S. DORMAN, 330 ROBERTS STREET, SUITE 200, EAST HARTFORD, CT, 06108, US

(21) Appl. No.: 10/992,997

(22) Filed: Nov. 19, 2004

Related U.S. Application Data
(63) Continuation of application No. 10/478,503.

(51) Int. Cl. C40B 40/08; C40B 40/10; C40B 30/02

(52) U.S. Cl. 435/6; 702/20

(57) ABSTRACT

A new method of designing and generating compounds having an increased probability of being drugs, drug candidates, or biologically active compounds, in particular having a therapeutic utility, is disclosed. The method consists of identifying a group of bioactive compounds, preferably of diverse therapeutic uses or biological activities and built on a common building block. In this group of compounds, side chains modifying the building block are identified and used to generate a second set of compounds according to the proposed methods of hybridization”, “single substitution” or “incorporation of frequently used side chains”. If the compounds in the second set built on the same building block contain an unusually large number of drugs, preferably with diverse therapeutic uses or biological activities, they constitute a “hot spot”. A focused combinatorial library of the “hot spot” is then generated, preferably by methods of combinatorial chemistry, and compounds of this library are screened for a variety of therapeutic uses or biological activities. The method generates drugs, drug candidates, or biologically active compounds with a high probability, without requiring any prior knowledge of biological targets.

### FIELD OF THE INVENTION

The invention relates to a new method of designing and generating drugs, drug candidates, or biologically active chemical compounds, in particular to a method of designing and generating chemical compounds having an increased probability of being drugs or drug candidates and to a new method of designing and generating libraries of such compounds.

### BACKGROUND OF THE INVENTION

Historically, substances having useful biological properties, in particular drugs, were discovered empirically in various natural sources, usually in plants. Natural sources of biologically active substances continue to be explored by various screening programs, resulting in an occasional discovery of compounds with a potent and useful biological activity. An example of such a relatively recent discovery is paclitaxel, one of the most effective drugs against breast and ovarian cancers, discovered in extracts of Pacific yew as a result of a large scale screening program initiated in early '60s by the National Cancer Institute, in the hope of discovering and isolating new anticancer drugs.

The advent of modern organic chemistry at the end of the 19^{th} century shifted the effort of new drug discovery and development towards synthetic organic chemistry. Initially, these efforts concentrated mostly on relatively simple compounds, frequently synthetic analogs of known bioactive compounds isolated from natural sources. An example of such a drug is aspirin (acetylsalicylic acid), commercialized by Bayer in 1899 and modelled on salicylate-type compounds found in certain plants, such as white willow or wintergreen, whose extracts were known for centuries to have analgesic and antipyretic properties.

Gradually, a more systematic approach to developing new synthetic drugs was adopted. It consisted of identifying a chemical compound with some desirable biological activity (a “lead compound”) and then synthesizing and evaluating for the same activity a large number of variants (analogs and derivatives) of the lead compound, in the hope that some of such variant compounds prove to be more active than the lead compound. Creating variant compounds may involve changing the substitution pattern of a building block present in the lead compound and/or adding some new structural units to the building block. This approach, based on the principle “structurally similar molecules are expected to exhibit similar biological properties” resulted in the development of a number of families of drugs characterized by the same or close biological activity and sharing common structural features, such as sulphonamides (bacteriostatic agents introduced in 1932) and benzodiazepines (antipsychotic compounds introduced in the '50s).

The approach of developing new drugs by starting from a lead compound, which remains in widespread use today, suffers from some important limitations. The first problem is the identification of leading compounds having the desirable biological activity. Frequently, leading compounds are those identified as promising drugs by screening compounds isolated from natural sources. For example, tens of thousands of derivatives and analogs of paclitaxel have been synthesized in search for analogous compounds having greater anticancerous activity, better solubility in aqueous solutions, bioavailability, simpler chemical structure, etc. Another limitation of the lead compound approach is the step of synthesizing a large number of variants of the lead compound. Such variants were traditionally generated by chemists using conventional, one-change-at-a-time chemical synthesis procedures, a very labor-intensive and time-consuming approach.

The limitations of the conventional lead compound approach appeared to be solved or at least greatly alleviated with the advent of combinatorial chemistry. Conceived about 20 years ago and developed mostly in the '90s, combinatorial chemistry involves a parallel synthesis of a large number of usually (but not necessarily) closely related compounds. Instead of synthesizing compounds one-by-one, combinatorial chemistry synthesizes simultaneously large “libraries” of compounds (from hundreds to millions), using automatic (robotic) computerized systems, by applying mostly solid phase techniques but also solution-phase techniques. Even though it had its beginnings in peptide and polynucleotide synthesis, combinatorial chemistry has expanded during the last ten years or so to include synthesis of a wide variety of low-molecular weight (typically below 500 daltons) organic compounds, such as pyrroles, imidazoles, diketopiperazines, triazines, benzodiazepines, benzamide/urea phenols, pyrazoles, and hydantoins, and by employing to this end a variety of reactions, such as acylation, alkylation, oxidation, reduction, aldol condensation, Michael addition, cycloadditions, Mitsunobu reaction, and Suzuki coupling. Libraries of compounds prepared by techniques of combinatorial chemistry (combinatorial libraries) may be then screened for compounds of a desired biological activity. In view of a large number of compounds involved in the screening, automatic, high throughput screening (HTS) systems have been developed for screening combinatorial libraries. As complete sequences of human genome and other genomes exponentially increase the number of possible drug targets, it has become more efficient to develop general libraries of compounds of high structural diversity, which may be screened against any drug target, than to develop libraries of compounds for a specific target or disease. Even though it is commonly acknowledged that screening such diverse combinatorial libraries reduces the cost and time of identifying potential lead compounds, it is also realized that this pseudo-random (essentially brute force) approach to identifying potential drugs by screening even the most diverse combinatorial libraries had its own limitations.

Arguably the most important limitation of the pseudo-random approach stems from the low probability of finding a potential drug among the large number of randomly synthesized potential drug candidates. The number of conceivable small organic molecules is staggering and may even exceed the number of atoms in the universe, estimated at 10⁷⁸. Assuming the number of possible candidate molecules to be “only” 10⁶⁰ and the number of drug molecules among them to be 10⁸ (10,000 times the estimated number of 10⁴ known drugs), the probability of finding a single drug molecule in a library of 10⁶ randomly synthesized compounds would be 10⁻⁴⁶. Even decreasing by several orders of magnitude the number of candidate molecules and similarly increasing the total number of possible drug molecules, the probability of finding a drug in a library of million randomly synthesized compounds remains negligible. Even if underestimated, this probability remains unquestionably low. In an example cited in U.S. Pat. No. 6,185,506, screening of 18 libraries containing a total of 43 million compounds identified only 27 active compounds. These compounds are just lead compounds, with no guarantee they will lead to drugs or drug candidates. Furthermore, the screened libraries were not structurally diverse pseudo-random libraries. Another factor to be taken into account is the cost of the screening, which may be prohibitive for a large library of compounds. Similarly prohibitive may be the cost of generating a large library of compounds, a large majority of which being unlikely to provide any useful leads.

Even if the first screening of a large random library is successful in identifying numerous biologically active compounds, it creates more difficult problems in the following steps. When a lead compound is identified, its analogs may be synthesized as a sub-library. In such a sub-library, the in vitro activity and pharmacophores may be optimized and quantitative structure-activity relationship (QSAR) can be studied. However, when too many biologically active compounds are identified in the first screening, it may not be practical to generate a sub-library for each of them, so that most of them would likely be discarded empirically. Generated sub-libraries of the remaining lead compounds would likely produce a significant number of biologically active analogs, from which only few would be selected for animal tests. Due to a poor correlation between activity assayed in vitro and in vivo, the choice of compounds to be tested in animals would be essentially arbitrary, and such a choice might result in no drugs being identified among analogs of the selected lead compounds.

In view of these drawbacks and limitations of large random libraries of compounds, various attempts have been made to design more focused, usually smaller combinatorial libraries offering at the same time greater probability of containing biologically active compounds. Such focused libraries are sometimes collectively referred to as knowledge-based libraries, as their design generally includes some a priori knowledge of properties (or desired properties) of compounds to be included in the library or their intended biochemical targets. An example of such a library is a “directed library” (Floyd et al., Prog. Med. Chem., 36, 91-168 (1999)), focused on the targeted bioactive system. For example, proteins frequently exert biological activity through relatively small, localized regions of their bioactive conformation, such as the turn conformation, and a library of compounds which contain or mimic the turn can be considered a directed library. Another example of a focused library is a library of drug-like molecules. In such a library, drug-like properties are defined in terms of indexes providing measures of various properties of candidate molecules, such as size, hydrophobicity, hydrogen bond formation capability, predicted toxicity, etc. As most organic compounds do not satisfy the criteria of being drug-like, this considerably reduces the number of compounds to be included in the library. However, excluding from the library non-drug-like compounds does not necessarily increase dramatically the probability of finding a drug among the remaining drug-like compounds. Assuming that 99.9% of 10⁶⁰ compounds of the previous example could be excluded from further consideration as non-drug-like, the probability of finding a drug in a random library of one million of such drug-like compounds would be still only 10⁻⁴³.

It is obvious in view of the above that new approaches to designing focused libraries of compounds are necessary to increase the probability of finding in the library biologically active compounds, in particular drugs or drug candidates. The present invention provides such a method, which overcomes some inherent limitations of methods and libraries of the prior art.

### SUMMARY OF THE INVENTION

The present invention is directed to a new method of developing new biologically active compounds, in particular drugs and drug candidates, and designing focused libraries of compounds having an increased probability of containing drugs, drug candidates, or biologically active compounds. The method of the present invention is based on the observation that chemical structures including certain building blocks (referred to as “hot building blocks”), such as p-aminobenzoic acid scaffold, are unusually frequently found in biologically active compounds, in particular drugs active against a variety of pathological conditions.

The proposed method of developing new drugs, drug candidates or biologically active compounds starts from identifying a group of known drugs and/or bioactive compounds of preferably diverse therapeutic uses or activities, sharing a given “hot building block”. In this group of compounds, side chains (including various functional groups and substituents) attached to the building block, are identified. This set of side chains is then used to generate a new set of side chains according to the methods proposed in this invention, to replace the original ones either at the original or other available points of substitution. The new compounds so designed are then prepared, preferably by methods of combinatorial chemistry, and tested for biological activities.

As opposed to known methods of design of biologically active compounds or drug-like molecules, the proposed method does not require any a priori knowledge of the targeted diseases or biological target molecules, such as the binding site of an enzyme. It also does not require to make any assumptions as to the biological activities of the new compounds generated by this procedure, which activity could be quite different from the activities found in the original group of compounds sharing the same “hot building block”.

### BRIEF DESCRIPTION OF THE DRAWINGS

FIG. 1 through 8 show UV spectra of 111 compounds sharing PABA “hot building block”, their 16 synthetic intermediates, and one compound with salicylic acid building block. Reference numerals identify compounds according to the numbering adopted in the Experimental section and elsewhere in the specification.

### DETAILED DESCRIPTION OF THE PREFERRED EMBODIMENTS

As used herein, the term “building block” is intended to mean a part of the structure of a chemical compound which can be traced to another single parent chemical compound. In compounds of the invention, such a building block is usually modified by additional structural elements, such as various substituents and functional groups, but must contain all the essential elements of the parent compound, in particular its carbon skeleton and functional groups, either free or derivatized. The term “hot building block” is intended to mean a building block that is unusually frequently found in drugs or biologically active compounds, preferably characterized by highly diverse therapeutic uses or biological activities. The term “side chain” is intended to encompass any structural element modifying the building block, including but not limited to extensions of its carbon skeleton, substituents to either the carbon skeleton or the functional groups of the parent compound, and addition of chemical and/or biological functional groups to the building block. The term “hot spot” is intended to mean a group of compounds of which an unusually large number are biologically active and are preferably characterized by a highly diverse biological activities. In particular, this term is applied to an unusually large number of drugs, preferably active against a variety of pathological conditions. This group of compounds must share a common building block and be generated by combination of the side chains, which are selected by certain algorithms as described below.

The present invention pertains to a new method of designing chemical compounds, in particular drugs, drug candidates, or biologically active compounds, characterized by an increased probability of being drugs, drug candidates, or biologically active compounds, for a wide range of diseases or medicinal targets, or showing biological activity against a variety of biochemical targets, and to designing libraries of such compounds. The method of the inventions stems from the observation that certain chemical structures, including certain building blocks are unusually frequently found in bioactive compounds, in particular drugs active against a variety of pathological conditions. Such structures will be referred to in the following as “hot building blocks”. Ideally, but not necessarily, hot building blocks should have a structure allowing them to be used as building blocks in combinatorial synthesis, so that a substantial number of analogs of a basic building block can be easily synthesized.

An example of a group of compounds sharing a hot building block are compounds of the following general formula:

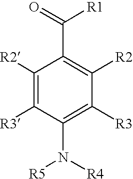

Molecules of these compounds are built on the scaffold of p-aminobenzoic acid (PABA), which constitutes their common building block, and are referred to as PABA-containing compounds. R1, R2, R2′, R3, R3′, R4 and R5 are side chains added to the building block. According to the database of Negwer (Negwer, M., Organic-chemical drugs and their synonyms. Akademic Verlag GmbH, Berlin, Germany, 1994), among 12,111 organic compounds used as drugs, 184 compounds (or about 1.5%) contain the residue of PABA. These compounds, when used as drugs, show a big variety of 84 biological activities or therapeutic uses, summarized in Table 1.

TABLE 1
Diverse activities of the drugs containing PABA residue

| Activity | Number of Drugs |
|---|---|
| antineoplastic | 37 |
| local anesthetic | 35 |
| antileukemic | 19 |
| anti-emetic | 16 |
| anti-arrhythmic | 10 |
| antibacterial | 7 |
| sunscreen agent | 6 |
| gastrokinetic | 5 |
| stomachic | 5 |
| tuberculostatic | 5 |
| anti-allergic | 4 |
| anti-inflammatory | 4 |
| peristaltic stimulant | 4 |
| proteinase inhibitor | 4 |
| analgesic | 3 |
| anesthetic | 3 |
| anti-asthmatic | 3 |
| antibiotic | 3 |
| diagnostic aid | 3 |
| neuroleptic | 3 |
| anti-arthritic | 2 |
| antidote to folic acid antagonists | 2 |
| antiprotozoal | 2 |
| antipsychotic | 2 |
| antiseptic | 2 |
| antitussive | 2 |
| anti-ulcer agent | 2 |
| antiviral | 2 |
| folic acid antagonist | 2 |
| growth factor | 2 |
| heptaene-antibiotic | 2 |
| immunosuppressive | 2 |
| sedative | 2 |
| smooth muscle relaxant | 2 |
| spasmolytic | 2 |
| tranquilizer | 2 |
| analeptic | 1 |
| anthelmintic | 1 |
| anti-anemic | 1 |
| anti-atherosclerotic | 1 |
| anticholinergic | 1 |
| anticoagulant | 1 |
| anticonvulsant | 1 |
| antidepressant | 1 |
| antifungal | 1 |
| antifungal antibiotic | 1 |
| antiglaucoma agent | 1 |
| antihyperlipidemic | 1 |
| antihypertensive | 1 |
| antipyretic | 1 |
| antirickettsial | 1 |
| aquaretic agent | 1 |
| bronchodilator | 1 |
| calcium antagonist | 1 |
| cardiac depressant | 1 |
| choleretic | 1 |
| CNS stimulant | 1 |
| coccidiostatic | 1 |
| coronary vasodilator | 1 |
| cytotoxic | 1 |
| dopamine D2-receptor antagonist | 1 |
| dopamine antagonist | 1 |
| dye | 1 |
| excretion inhibitor | 1 |
| fibrosis therapeutic | 1 |
| geriatric | 1 |
| gold therapeutic for tuberculosis and | 1 |
| leprosy | |
| hematopoietic | 1 |
| hematopoietic vitamin | 1 |
| hepatoprotectant | 1 |
| hypnotic | 1 |
| hypoglycemic | 1 |
| hypothermic | 1 |
| magnesium source | 1 |
| mercurial diuretic | 1 |
| migraine prophylactic | 1 |
| neural therapeutic | 1 |
| prothrombogenic | 1 |
| 5-HT4 receptor agonist | 1 |
| respiration catalyst | 1 |
| serotonin antagonist | 1 |
| topical anesthetic | 1 |
| treatment of diabetic neuropathy | 1 |
| trypsin inhibitor | 1 |

PABA contains two relatively reactive functional groups (amino group and carboxyl group), making it a good building block for combinatorial synthesis of a large number of analogs.

Another example of a group of compounds sharing a hot building block are compounds of the general formula:

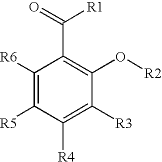

Molecules of these compounds are built on the scaffold of salicylic acid, their common building block, and are referred to as salicylic acid-containing compounds. R1, R2, R3, R4, R5, and R6 are the side chains added to the building block. According to Negwer, among 12,111 organic compounds used as drugs, 381 compounds (or about 3%) contain the residue of salicylic acid. These compounds, when used as drugs, show a similarly big variety of 137 therapeutic uses or biological activities. Also this compound contains two relatively reactive functional groups (hydroxyl group and carboxyl group) making it a good building block for combinatorial syntheses. Both p-aminobenzoic and salicylic acids are examples of hot building blocks.

The method of the invention for providing new drugs, drug candidates or biologically active compounds starts from identifying a first group of compounds sharing a hot building block. In this group of compounds, side chains that modify the hot building block or are otherwise attached to this building block are identified, providing a first set of side chains. This set is then used to generate a second set of side chains which are in turn used to generate a second group of compounds, by adding the side chains of the second group to the hot building block either at the original or other available points of substitution. The second group of compounds is called a “hot spot” if an unusually large number of compounds in this group are biologically active and preferably characterized by a highly diverse biological activities. In particular, the an unusually large number of compounds in the “hot spot” of compounds are drugs and are preferably active against a variety of pathological conditions. The compounds in the “hot spot” are then synthesized, preferably by means of combinatorial chemistry, and tested for a variety of biological activities. Those showing any desired biological activity are retained for further studies.

As would be obvious to those skilled in the art, the method of the present invention proceeds through the steps of generation of a virtual and physical combinatorial library of compounds. Such “hot spot” library is a focused library, in that it is limited to compounds built on a “hot building block” and likely containing an unusually large number of drugs or biologically active compounds characterized by a variety of therapeutic uses or biological activities. Such a library is far more likely to contain a higher percentage of drugs, drug candidates, or compounds showing some kind of biological activity than a general combinatorial library. Therapeutic uses or biological activities of the “hot spot” library of compounds cannot be predicted in advance when the starting group of biologically active compounds containing the common “hot building block” is characterized by a big diversity of biological activities and/or therapeutic uses. The therapeutic uses and biological activities of the “hot spot” library of compounds become somewhat more predictable when the starting group of biologically active compounds containing the common “hot building block” is characterized by less diverse biological activities or therapeutic uses. Testing the “hot spot” library for a wide range of therapeutic uses or biological activities is necessary to maximize the discovery of drugs, drug candidates or biologically active compounds, which may be then used as lead compounds for a variety of biochemical targets and medicinal applications.

It would be also obvious to those skilled in the art that in contrast to known methods of generating focused combinatorial libraries of candidate drugs or otherwise biologically active compounds, the method of the present invention does not require any a priori knowledge of the intended biochemical targets or properties of the generated “hot spot” compounds, such as a drug-like character. The only requirement is that the compounds in the generated library are built on a “hot building block” common with an unusually large number of compounds characterized by a highly diverse biological activities, in particular drugs active against a variety of pathological conditions.

According to a preferred embodiment of the invention, side chains included in the “hot spot” are generated by a hybridization algorithm. This algorithm mimics the biological evolution. By “merging” two or more first generation drugs or biologically active compounds built on a common “hot building block”, this algorithm mixes and re-shuffles the side chains of the first generation drugs or biologically active compounds and generates a set of side chains that are inserted, preferably but not necessarily, at the same substitution site of the building block. The compounds so generated constitute a second generation of compounds. If the compounds of the second generation contain an unusually large number of drugs or biologically active compounds, preferably characterized by diverse therapeutic uses or biological activities, the compounds of the second generation constitute a “hot spot” for further development. For “hot building blocks” comprising a substituted aromatic ring, hybridization may also mean changing the number of substituents in the ring and its substitution pattern, without changing the substituents themselves. The hybridization procedure can be applied to any subset of known biologically active compounds containing the “hot building block” compounds.

According to another preferred embodiment, side chains are modified by a single substitution. This modification, analogous to a single mutation in biological systems, may consist, for example, in adding an additional side chain to the “hot building block”, or by replacing a single side chain of a drug or biologically active compound containing the “hot building block” with a different side chain used in another drug or biologically active compound built on the same “hot building block”. This addition or replacement may take place in any part of the building block, where applicable.

According to still another preferred embodiment of the invention, side chains are modified by incorporation of side chains used frequently in drugs or biologically active compounds built on the same “hot building block”. This approach, analogous to gene prepotency in biological systems. One or several side chains used frequently in the drugs or biologically active compounds built on the same “hot building block” can be used to modify the “hot building block” when generating new library compounds.

Even though the generation of a new set of side chains from the side chains of drugs or biologically active compounds built on the same “hot building block” and the modification of the building block according to the above algorithms are preferred, combinatorial libraries of the present invention can be generated using any arbitrary set of side chains, for example a set generated entirely or in part by the preferred algorithms and additionally including side chains not found among the drugs or biologically active compounds built on the same “hot building block”.

### EXAMPLES

The following examples illustrate the above-disclosed general principles of designing new chemical compounds having an increased probability of being drugs, drug candidates, or biologically active compounds and combinatorial libraries of such compounds.

p-Aminobenzoic Acid (PABA)

A book “Organic-chemical drugs and their synonyms” [Negwer, M., Organic-chemical drugs and their synonyms. Akademic Verlag GmbH, Berlin, Germany, 1994] lists 12,111 organic compounds used as drugs, of which 184 (about 1.5%) contain the residue of p-aminobenzoic acid. These 184 drugs have 84 therapeutic uses or activities. The number of drugs including the building block of p-aminobenzoic acid and the variety of therapeutic uses or activities involving these drugs is very high and satisfy the criteria of the “hot building block”.

p-Aminobenzoic acid has two functional groups (amino group and carboxyl group) to which side chains can be attached by means of combinatorial chemistry. Side chains can also be attached to the aromatic ring, for an increased structural diversity.

Hybridization

Drugs and biologically active compounds sharing the PABA “hot building block” can be represented by the following general formula:

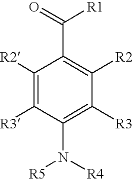

Various side chains are attached to the PABA building block in the 184 known drugs comprising the residue of p-aninobenzoic acid. There are 96 side chains for the carboxyl group, 62 side chains for the amino group, 4 side chains to form a tertiary amine, 14 side chains (R2) for the second position of the aromatic ring, and 14 side chains (R3) for the fifth position of the aromatic ring. Over 4.6 million analogs (4,666,368=96×62×4×14×14 ) may be produced just by taking the combination of these side chains at their original substitution sites. A significant portion of these compounds might be drug-like molecules, due to their components used in PABA-containing drugs. However, side chains for analogs are not limited to these side chains of the 184 PABA-containing drugs and their substitution sites. For example, the side chains of the following two drugs, whose functions are shown below their chemical structures, can be “hybridized”:

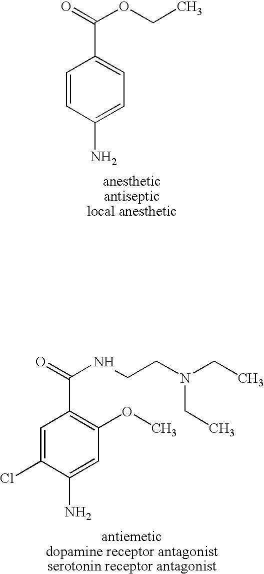

By hybridizing two substituents at the carboxy group, the following four side chains may be generated:

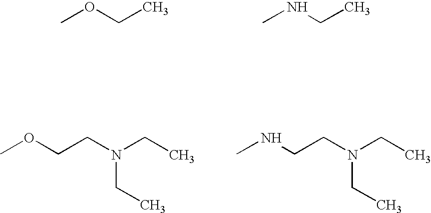

By hybridizing the aromatic ring substituents, the following four side chains may be generated for the aromatic ring: 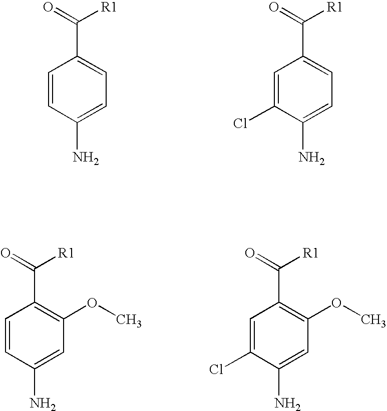
where R1 is the substitution of the carboxyl group. Combination of the above four substituents of the carboxyl group and the four aromatic ring substitutents generates a group of the following 16 compounds:

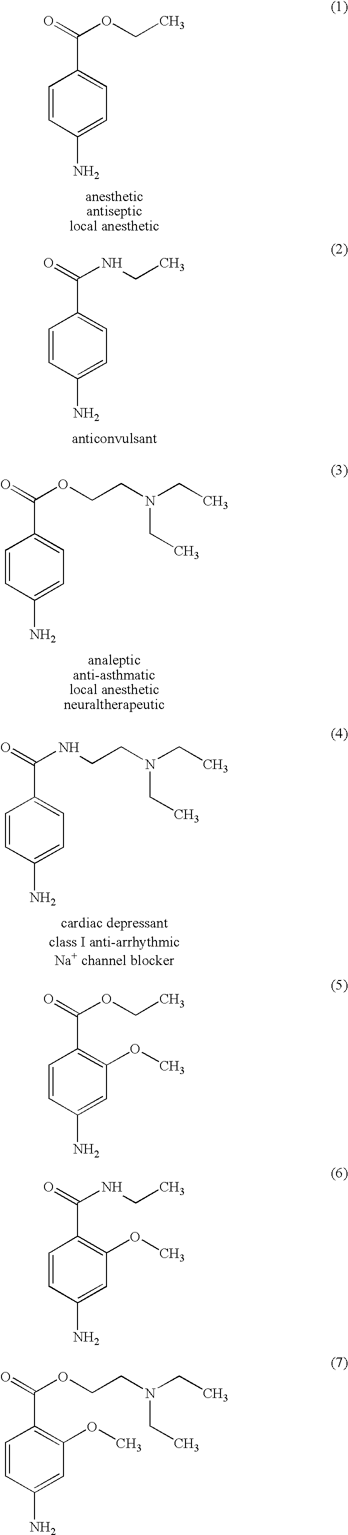

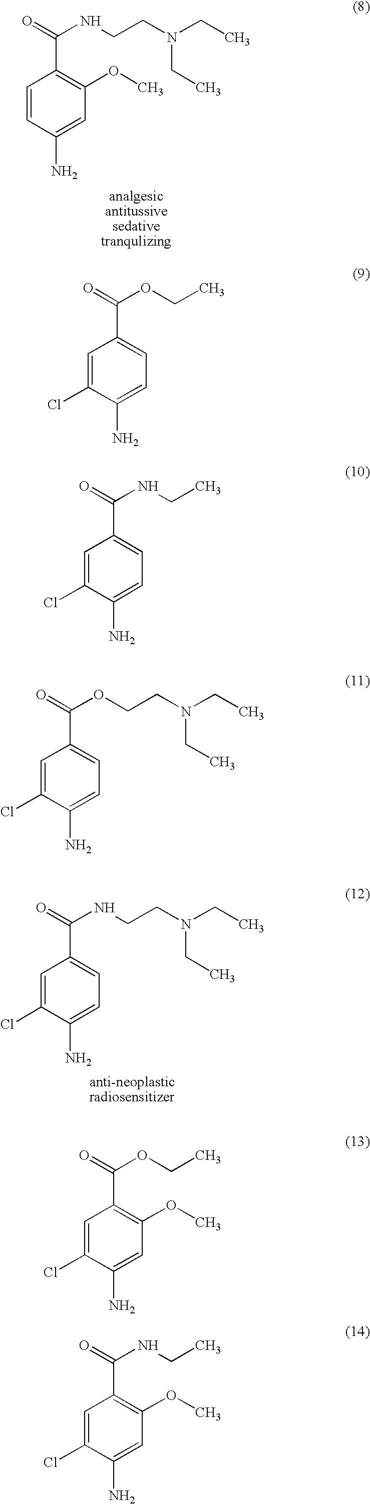

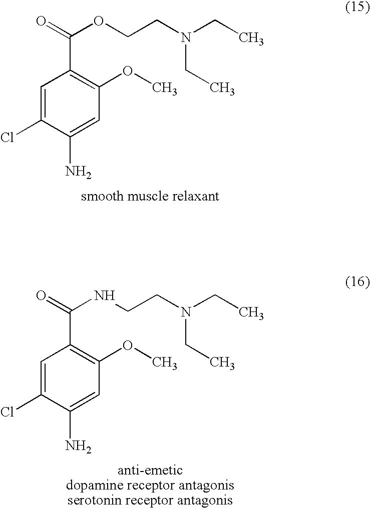

Compounds (1) and (16) are the original drugs used for the hybridization. Compounds (3), (4), (12) and (15) are also known drugs. Furthermore, functions of these 6 drugs are diversified, as shown under their structures. The high density (38%) of drugs in this group makes high the probability to find one or more drugs, drug candidates, or biologically active compounds among the remaining 10 compounds, although their functions cannot be predicted. Therapeutic activities of compounds (2) and (8) are reported as shown with underlines under their chemical structures (Clark, C. R.; Wells, M. J; Sansom, R. T.; Norris, G. N.; Dockens, R. C.; Ravis, W. R. Anticonvulsant activity of some 4-aminobenzamides. J. Med. Chem. 1984, 27, 779-782; Morimoto, A. and Takasugi, H., patent JP 52016104 19770506). The 38% drug density and 15 therapeutic uses or activities for this group of compounds are sufficiently high to qualify this group of compounds as a “hot spot”. It should be noted that the exemplified method of hybridization is not limited to two drugs and can be applied to hybridize more than two drugs.

Single Substitution

The buildng block of p-aminobenzoic acid can be also modified by a single substitution, such as adding a single side chain to it or replacing a side chain with another side chain. If only the side chains of 184 known drugs containing the residue of p-aminobenzoic acid are used for this purpose and only at their substitution site. 183 analogs can be generated. Among those, 48 compounds (26%) are known drugs having 36 therapeutic uses or activities. As the 26% drug density is high enough and 36 therapeutic uses or activities are sufficiently diverse, these 183 analogs constitute a “hot spot ”. Some of them were synthesized or purchased and their sunscreening activity was measured. Their chemical structures are the following:

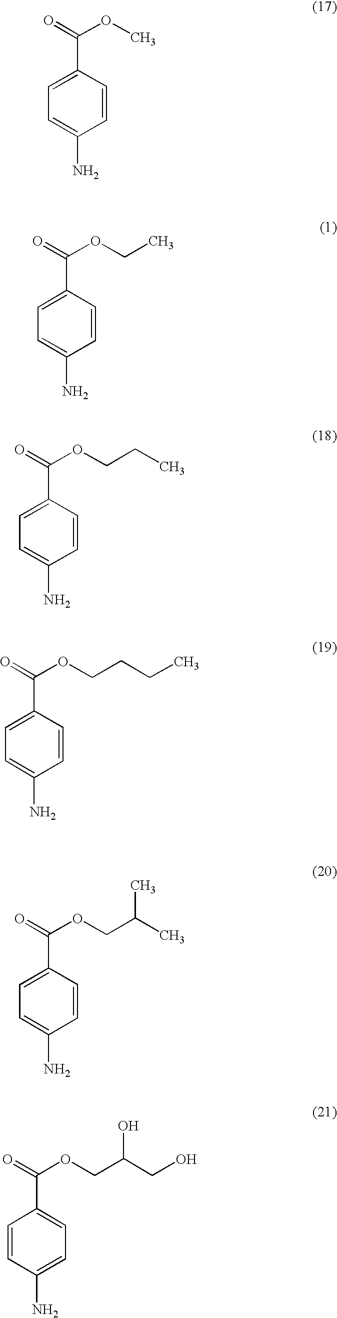

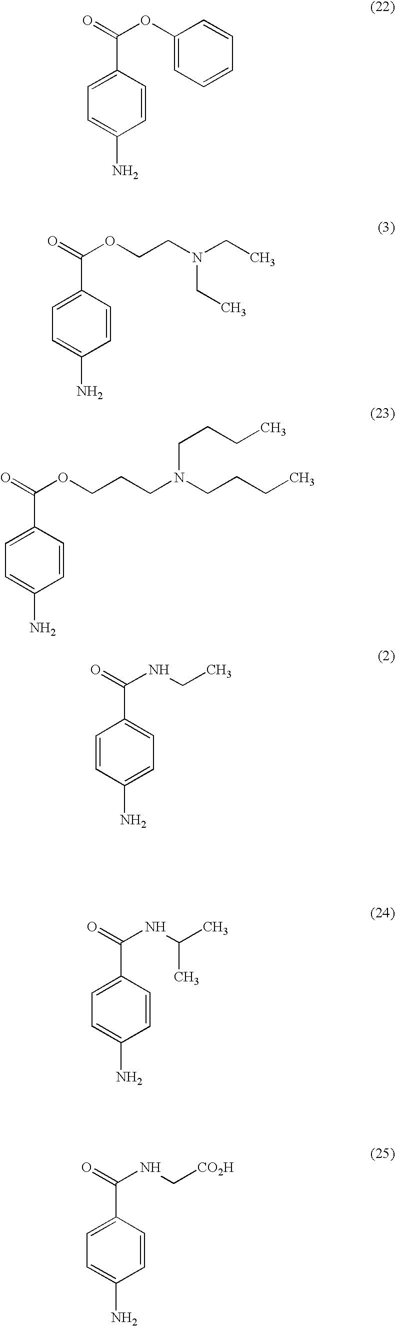

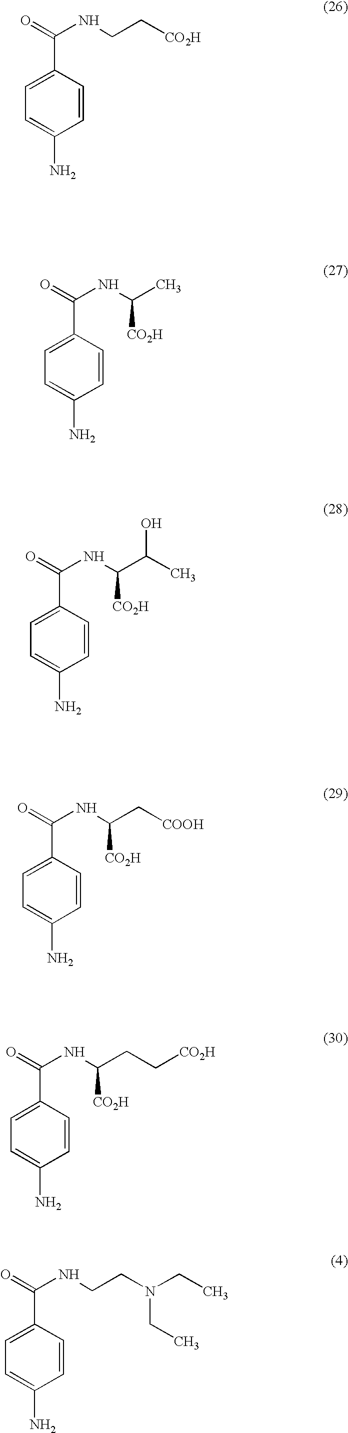

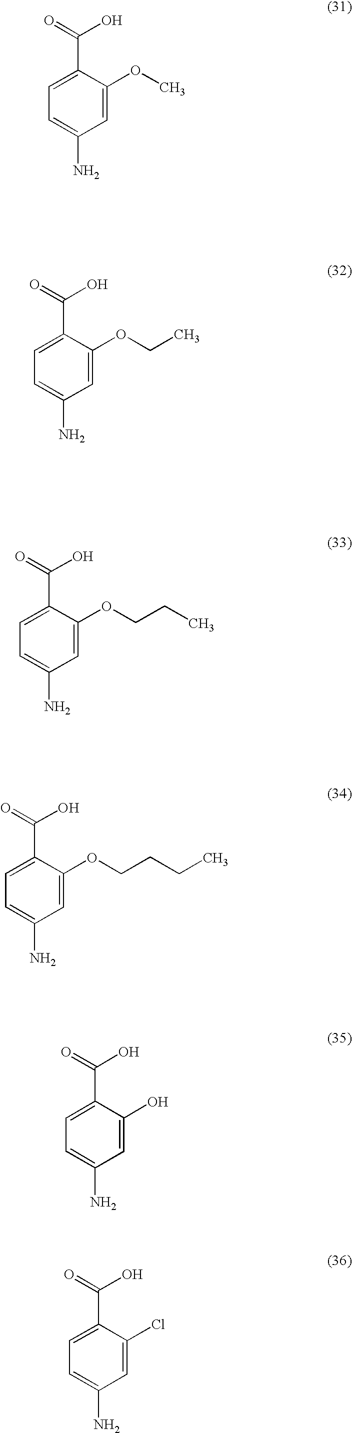

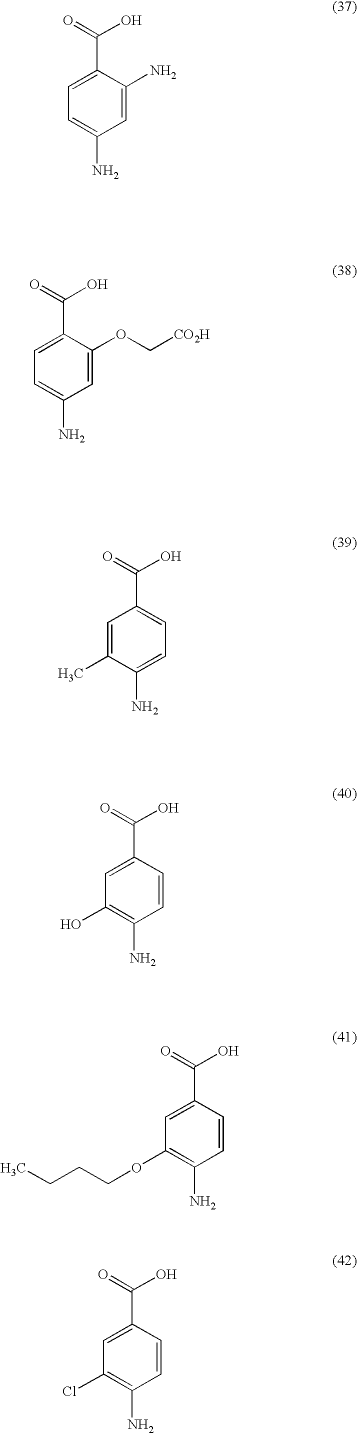

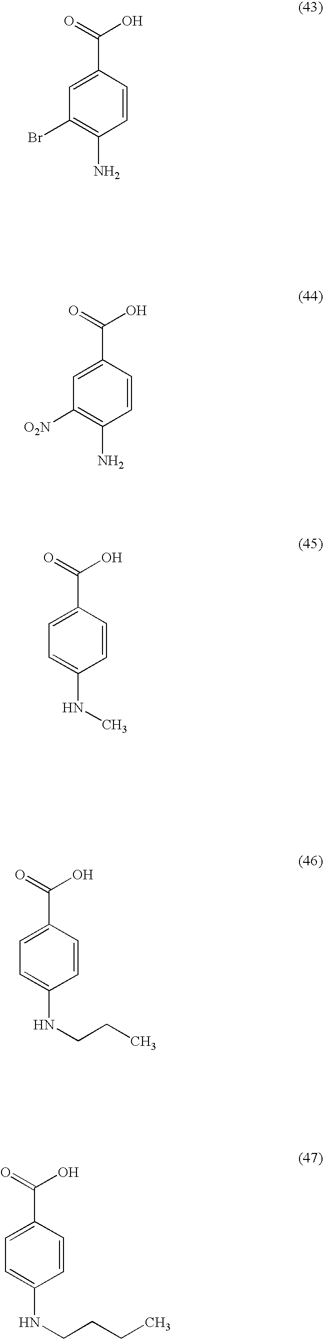

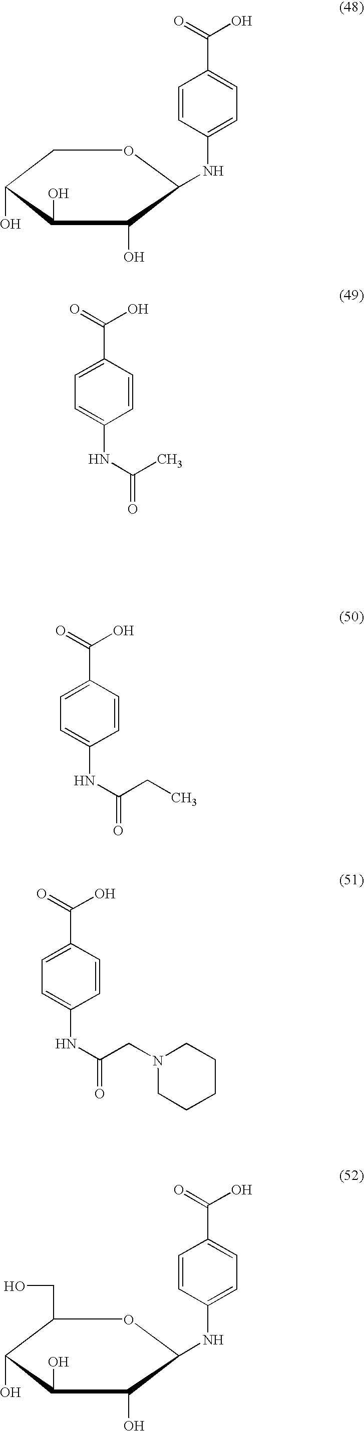

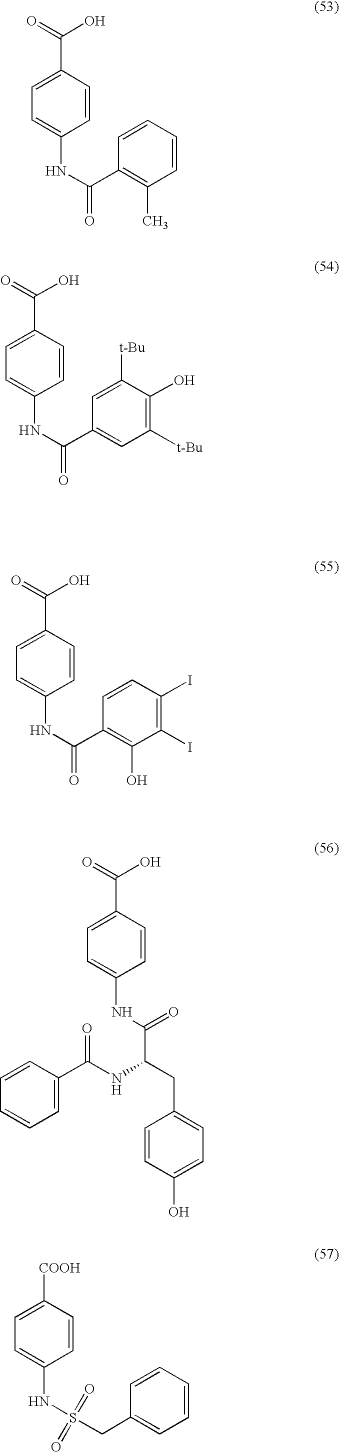

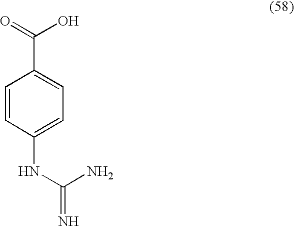

Similarly, a single substitution of the above generated 16 compounds results in approximately 3,000 analogs, for example:

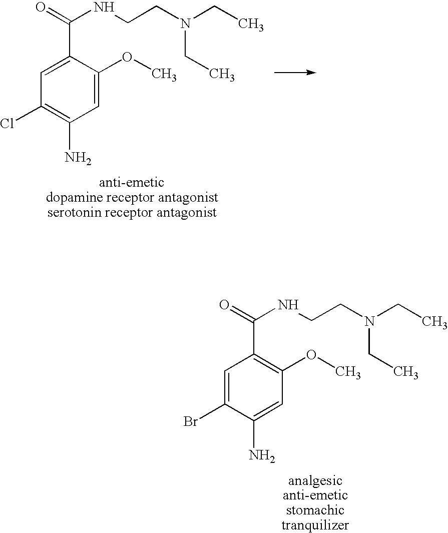

Of these 3,000 compounds, 60 compounds (2%) are known drugs having 36 therapeutic uses or activities. The 2% drug density is still high when taking into account of the large number of the generated analogs. Thus these approximately 3,000 compounds constitute a “hot spot”.

Chimera

The building block of the p-aminobenzoic acid residue can be further modified by incorporation of frequently used side chains. Five such side chains, including free carboxylic acid group, has been identified as frequently used substituents of the carboxy group in PABA-containing drugs. These side chains are shown below, together with the numbers of PABA-containing drugs sharing these side chains and the numbers of therapeutic uses or activities of these drugs:

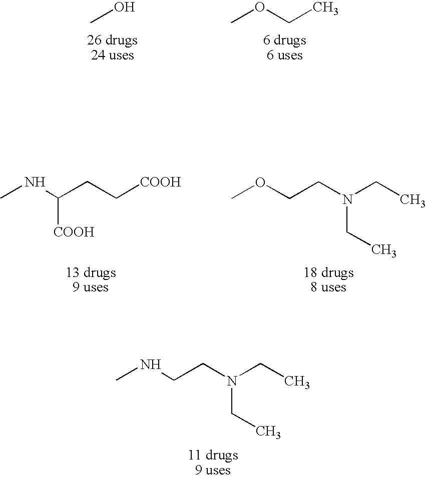

Similarly, three chains, including free amino group, have been identified as frequently used substituents of the amino group in PABA-containing drugs. These side chains are shown below, together with the numbers of PABA-containing drugs sharing these side chains and the numbers of therapeutic uses or activities of these drugs:

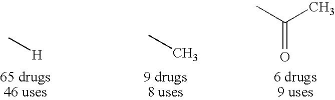

Three aromatic substitutions, including non-substitution of the aromatic ring, have been further identified as frequently used side chains of the aromatic ring in PABA-containing drugs. These side chains are shown below, together with the numbers of PABA-containing drugs sharing these side chains and the numbers of therapeutic uses or activities of these drugs:

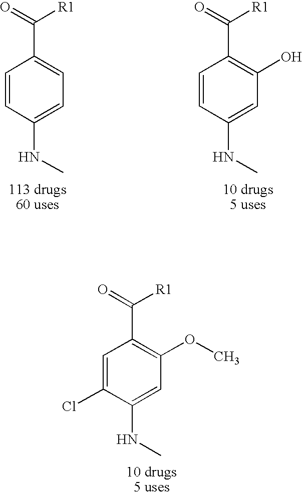

where R1 is the substitution of the carboxyl group. Combination of these three groups of side chains generates 45 (5×3×3) compounds of which 10 compounds are drugs (22% of drug density) having 24 therapeutic uses or activities. As the 22% drug density is high enough and 24 therapeutic uses or activities are sufficiently diverse, the 45 analogs constitute a “hot spot”. They were synthesized or purchased and their sunscreening activity was measured. Their chemical structures are the following: 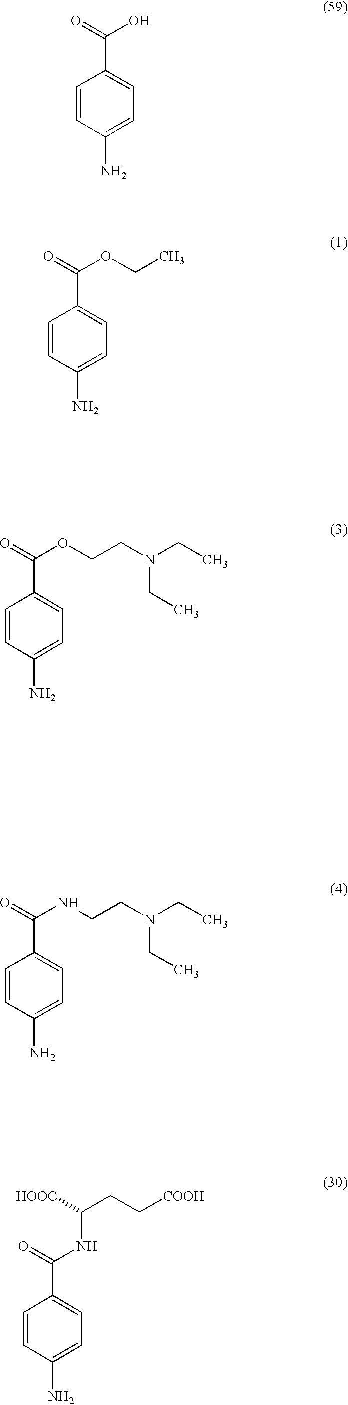 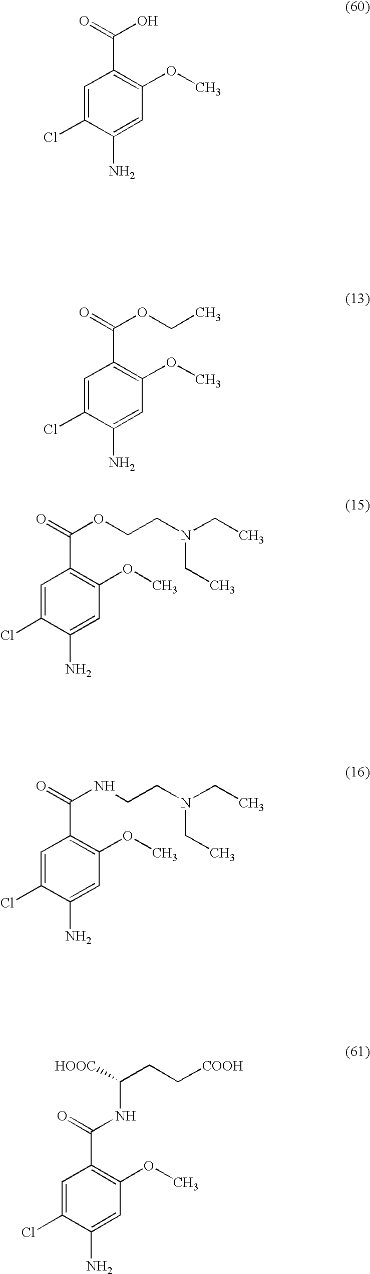 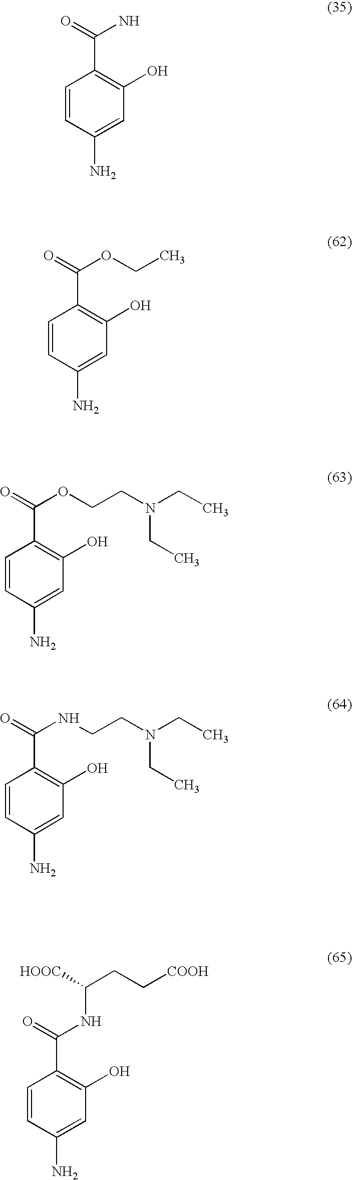 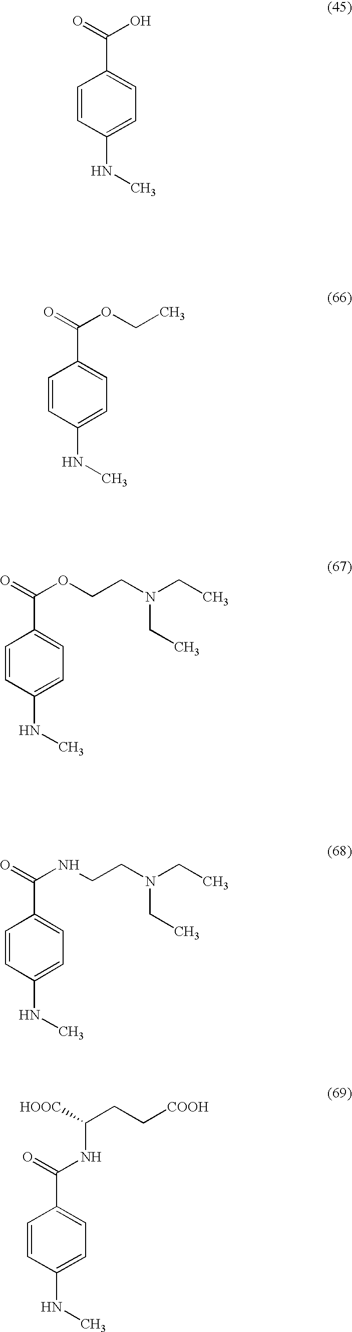 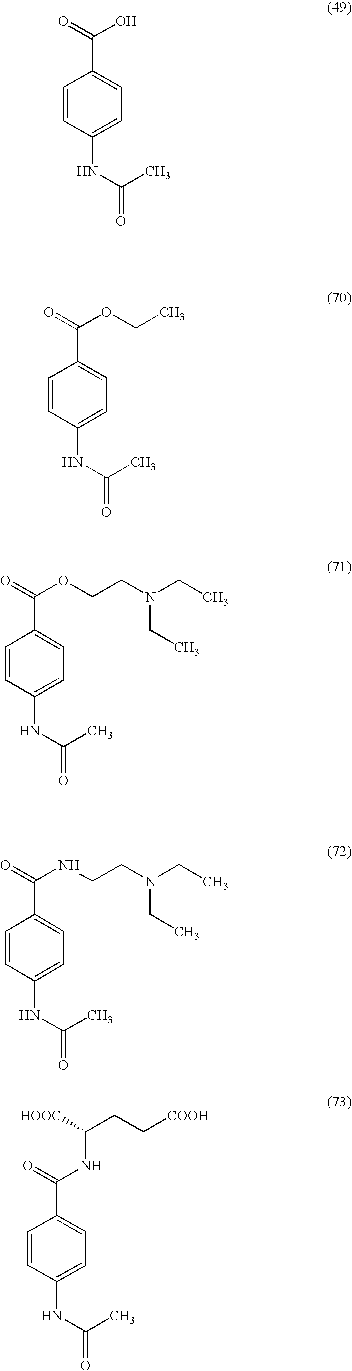 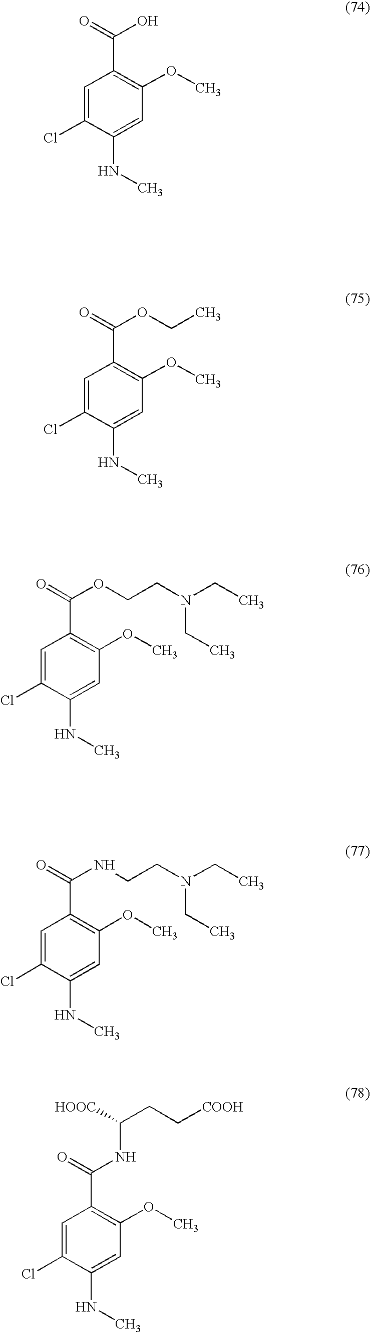 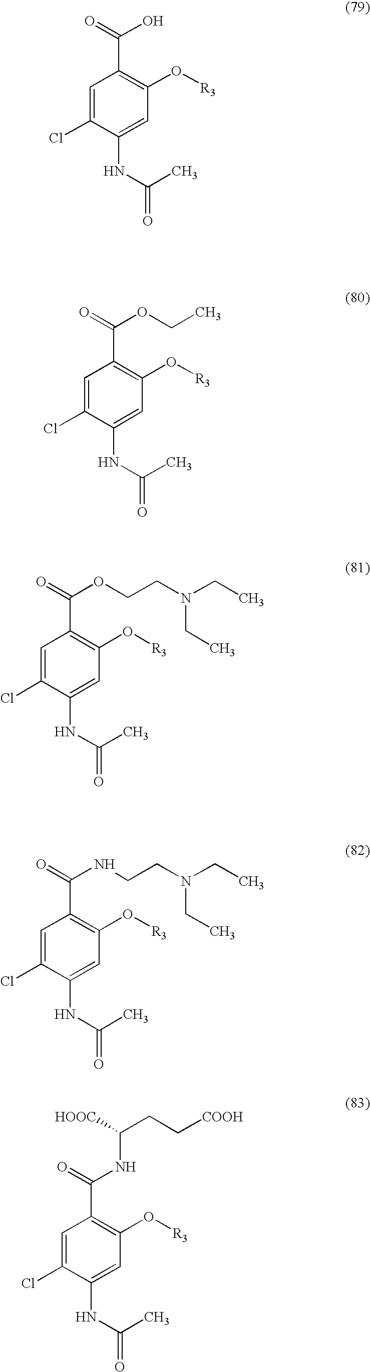 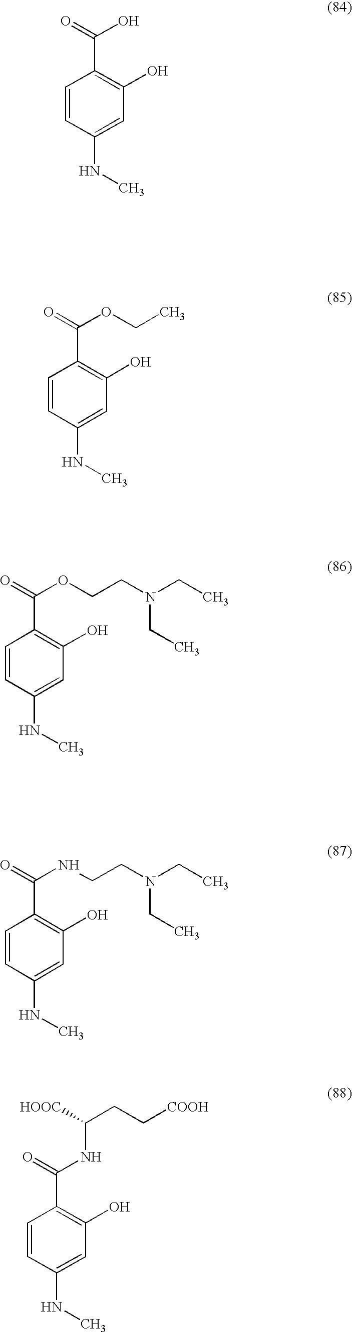 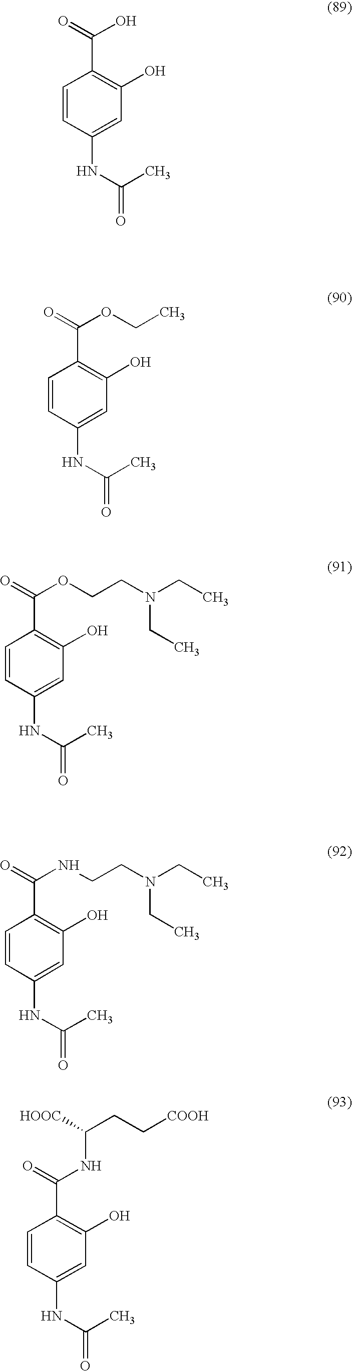
Salicylic Acid

A book “Organic-chemical drugs and their synonyms” (Negwer, M. Organic-chemical drugs and their synonyms. Akademic Verlag GmbH, Berlin, Germany, 1994) lists 12,111 organic compounds used as drugs, of which 381 drugs (3%) contain the salicylic acid residue. These 381 drugs are used in 137 applications, for a wide range of therapeutic uses or activities. The number of drugs including the building block of salicylic acid and the variety of applications in which these drugs are involved are very high and satisfy the criteria of the “hot building block”.

Salicylic acid has two functional groups (hydroxyl group and carboxyl group), to which side chains can be attached by means of combinatorial chemistry. Side chains also can be attached to the aromatic ring, for an increased structural diversity.

Various side chains are attached to the building block of salicylic acid in the known 381 drugs built on this building block. There are 165 side chains for the carboxyl group, 43 side chains for the hydroxyl group, 37 side chains for the third position of the aromatic ring, 55 side chains for the fourth position of the aromatic ring, 75 side chains for the fifth position of the aromatic ring, and 26 side chains for the sixth position of the aromatic ring. Over 28 billion analogs (28,154,733,750=165×43×37×55×75×26) may be generated just by taking the combination of these side chains at their substitution sites. However, the side chains for the analogs are not limited to these original side chains and substitution sites. New side chains can be generated by using various algorithms. For example, the side chains of two drugs can be “hybridized”, as in the case of the following two drugs, whose functions are shown below their chemical structures):

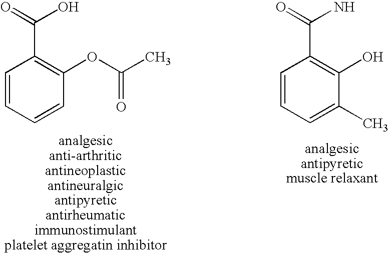

By hybridizing substituents of the carboxyl and hydroxyl groups, the following four side chains can be generated:

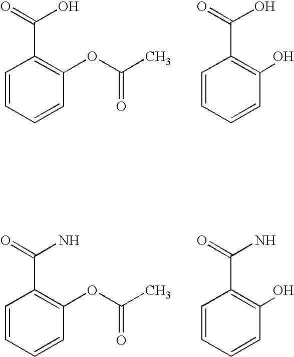

By hybridizing the aromatic ring substituents, the following four side chains can be generated: 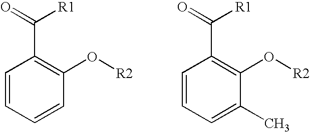
where R1 and R2 are the substituent groups of the carboxyl and the hydroxy groups, respectively. Combination of the above four carboxyl group substituents and four aromatic substituents generates a group of the following 8 compounds:

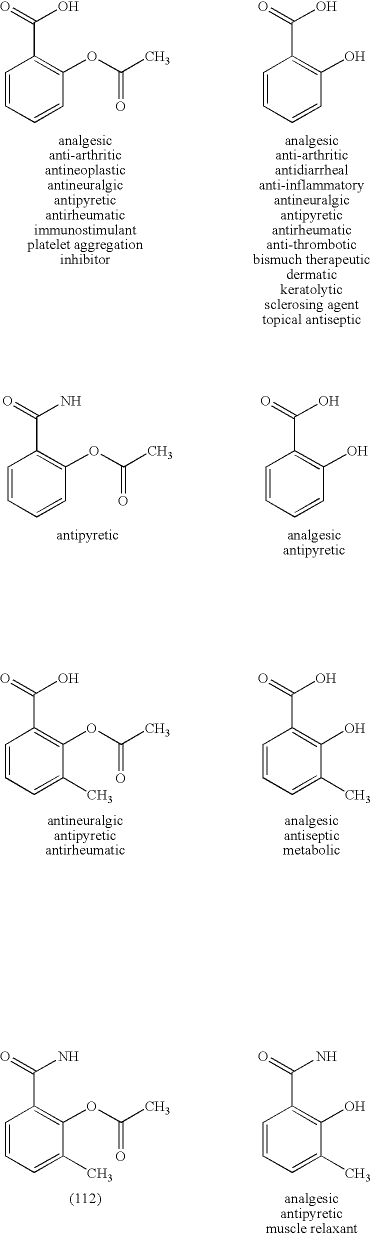

The compounds whose therapeutic uses or activities are shown under their structures are known drugs. The functions of these 7 drugs are diversified, as shown under their structures. The high density (88%) of the drugs in this group makes high the probability of finding one or more drugs, drug candidates, or biologically active compounds among the remaining compounds. As the 88% drug density is high enough and 18 therapeutic uses or activities are sufficiently diverse, the 8 analogs constitute a “hot spot”. Of course, the illustrated method of hybridization is not limited to two drugs and more than two drugs can be hybridized in the same manner.

The building block of salicylic acid can also be modified by a single substitution, such as adding a single side chain or replacing an existing side chain with another side chain. If only the side chains of known 381 drugs comprising the salicylic acid 15 residue are used for this purpose and only at their substitution sites, 401 analogs can be produced. Among them, 83 compounds (20%) are drugs having 35 therapeutic uses or activities. The drug density of 20% (83 drugs out of 401 compounds) is very high. As the 20% drug density is high enough and 35 therapeutic uses or activities are sufficiently diverse, the 401 analogs constitute a “hot spot ”.

The building block of salicylic acid can be also modified by incorporation side chains used frequently in salicylic acid contating drugs or biologically active compounds. For example, the following eight frequently used side chains (including free carboxy and hydroxy groups) may be selected: 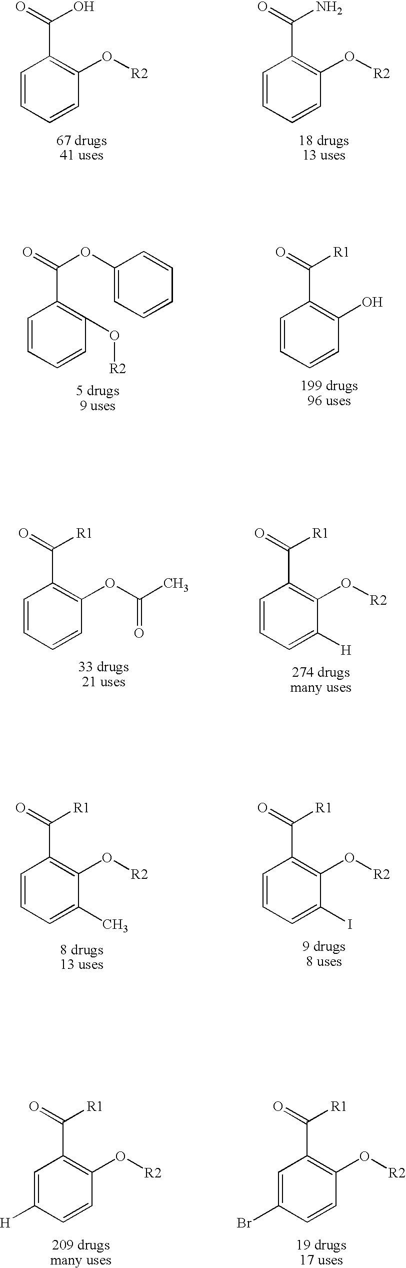
where R1 and R2 are the substitution groups of the carboxyl and the hydroxyl groups, respectively. Combination of these side chains generates 36 (3×2×3×2) compounds of which 15 compounds are known drugs (42% of drug density) having 24 therapeutic uses or activities. Again, therapeutic uses or biological activities which may be identified among the remaining 21 compounds of this group are not predictable.
Side Chain Import

Import of a foreign gene is a powerful method in biological evolution. By analogy, we introduce side chains of drugs other than those described above. Incorporating such side chains may overcome the limitations of the basic drug evolution algorithms described above. For example, hybridization algorithm is good to generate second-generation molecules that have a high probability of being drugs. However, there is a limited number of drugs that qualify as parent molecules.

Apropriate side chains were selected from among those appearing in the database of “Organic-chemical drugs and their synonyms” (ed. by M. Negwer, 1996) that lists 12,111 drugs. These side chains were selected from three types of drugs:

(A) PABA-containing drugs other than those used above,

(B) drugs whose core was homologous to PABA, and

(C) drugs whose core was not homologous to PABA.

Algorithms A, B and C were applied to design derivatives of the PABA analogs listed above. Even though these algorithms provide a new approach to the import of side chains, the validation by “hot spot” of the compounds so designed is no longer applicable, because a majority of the imported side chains have not been used in PABA-containing drugs. In the following examples, we used 2-aminobenzoic acid, 3-aminobenzoic acid and 4-hydroxybenzoic acid as core homologs of PABA, although other cores can be added to this list. Known drugs having these cores contain 127 side chains at the carboxylic acid group, of which 21 are also used in PABA-containing drugs. For the sake of simplicity, we used drugs containing the salicylic acid core as non-homologous drugs for algorithm C, although side chains from other non-homologous drugs can be added in a similar manner. Drugs containing the core of salicylic acid include 166 side chains of which 30 are also used in PABA-containing drugs. Several compounds are listed below to illustrate how the side chains were incorporated according to algorithm A, B, or C.

1-1, Algorithm A was applied to the hybrid compounds (1)-(16). The side chains were incorporated into compounds whose corresponding side chain was homologous. For example, compound (20) is a result of importing isobutyl ester, used in a local anesthetic drug isobutamben, into compound (1) that has a homologous side chain of ethyl ester. Similarly, compound (94) is an analog of compound (6).

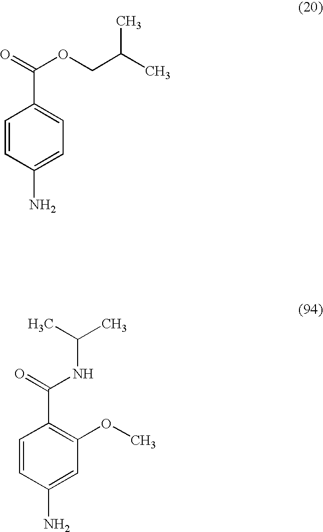

1-2, Algorithm B was applied to the hybrid compounds (1)-(16). The side chains were incorporated into compounds whose corresponding side chain was homologous. For example, the side chain ethyl ester of compound (1) was replaced with a homologous side chain isobutene ester, to provide compound (95). This side chain is used in an anti-inflammatory and analgesic drug Prefenamate that contains 2-aminobenzoic acid core. Similarly, compounds (96) and (97) are analogs of compounds (10) and (14), respectively.

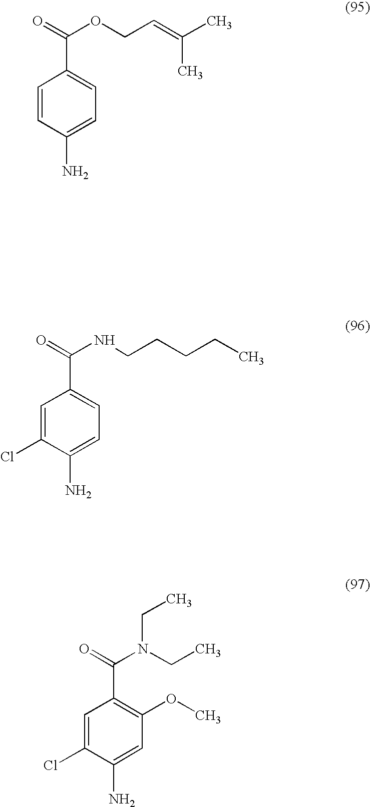

1-3, Algorithm C was applied to the hybrid compounds (1)-(16). The side chains were incorporated into compounds whose corresponding side chain was homologous. For example, the side chain ethyl ester of compound (1) was replaced with a homologous side chain 2-hydroxyethyl ester in compound (98). This side chain is used in an antirheumatic and counterirritant drug hydroxyethyl salicylate that contains salicylic acid core. Similarly, compound (99) is an analogue of compound (14).

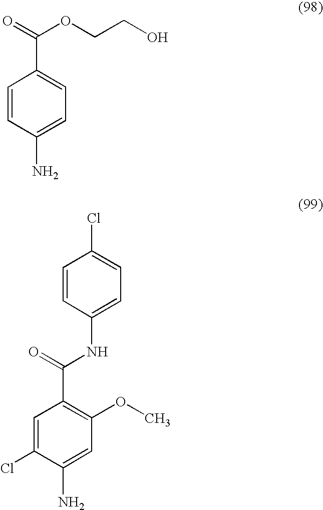

1-4, Algorithm A could not be applied to compounds generated by single substitution of PABA (compounds (1)-(4) and (17)-(58)), as this would result in the same compounds.

1-5, Algorithm B was applied to compounds generated by single substitution of PABA (compounds (1)-(4) and (17)-(58)). The side chains were incorporated into compounds whose corresponding side chain was homologous, resulting in the following compounds:

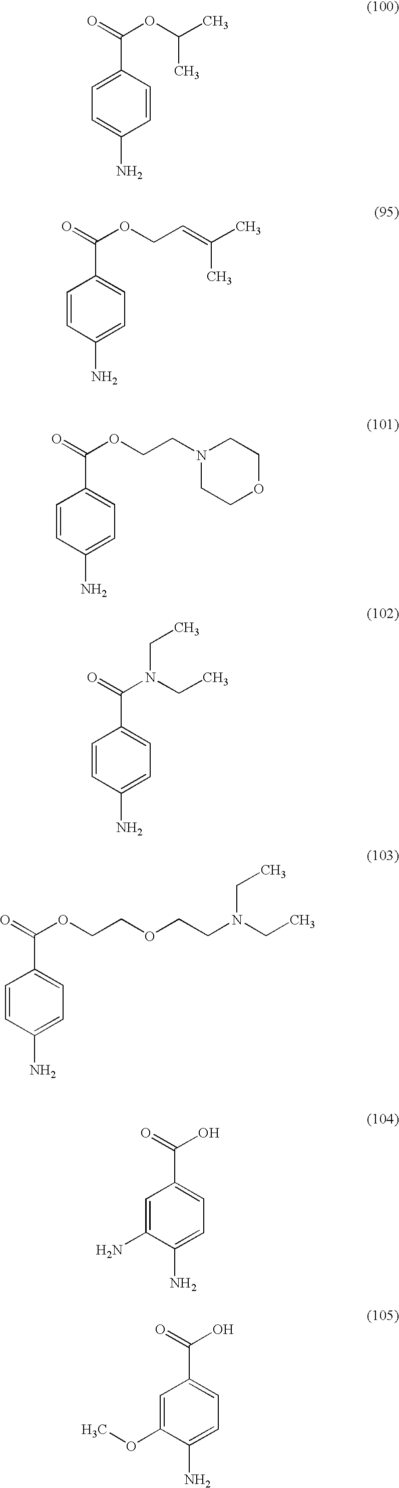

1-6, Algorithm C was applied to compounds generated by single substitution of PABA (compounds (1)-(4) and (17)-(58)). The side chains were incorporated into 5 compounds whose corresponding side chain was homologous. For example, the side chain phenyl ester of compound (22) was replaced with a homologous side chain used in an antipyretic and antifungal drug salicylanilide, resulting in compound (106).

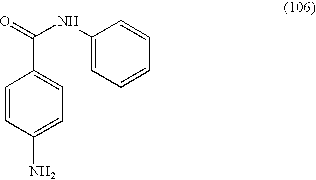

1-7, Algorithm A was applied to the “Chimera” molecules. The side chains were incorporated into compounds whose corresponding side chain was homologous. For example, the N-ribose side chain in compound (107) is used in an antineoplastic drug Benaxibine. Similarly, compounds (108) and (109) are analogs obtained by incorporating frequently used side chains of PABA-containing drugs.

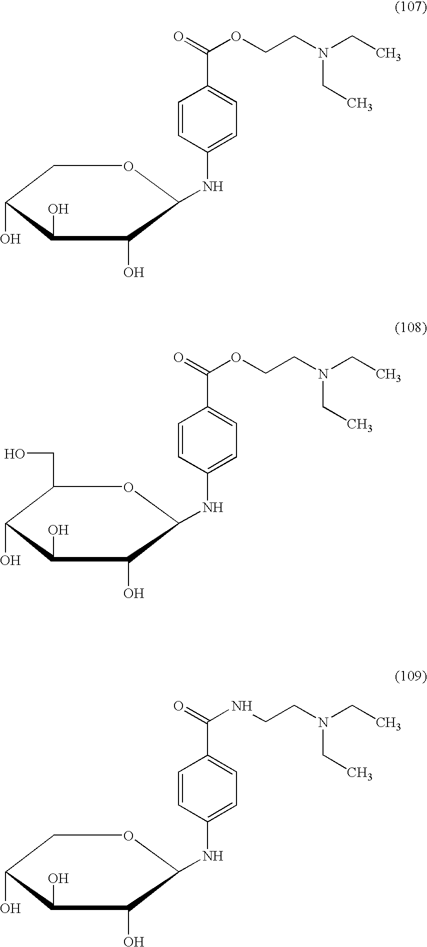

1-8, Algorithm B was applied to the “Chimera” molecules. The side chains were incorporated into compounds whose corresponding side chain was homologous, resulting in compounds (110) and (111).

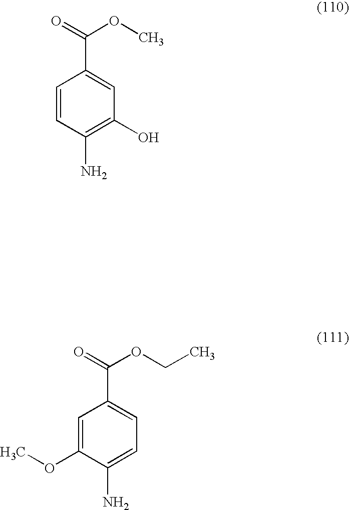

### EXPERIMENTAL

Synthesis of PABA-containing compounds (1)-(111)

General

All synthetic products were purified using preparative HPLC (C₈ and C₁₈ reverse-phase columns, in acetonitrile gradients in water, 0.1% trifluoroacetic acid (TFA)). The purity was established using an analytical HPLC system (Waters Symmetry 3.5?m 2.1 by 50 mm C₁₈ reverse-phase column, gradient 0-80% acetonitrile in water, 0,1%TFA; flow rate 0.8 mL/min; 10 min [system 1], or Vydac 4.6×150 mm C₁₈ column, gradient 0-80% acetonitrile in water, 0,1%TFA; flow rate 1.0 mL/min; 60 min [system2]). The compounds were characterized using an electrospray ionization mass spectrometer (ESI-MS) (Sciex API III mass spectrometer) and ¹H NMR (Bruker AMX2-500).

### Compound (1) Ethyl 4-aminobenzoate (benzocaine) was Purchased from TCI.

### Compound (2) Ethyl 4-aminobenzamide acetate

### Ethyl 4-Boc-aminobenzamide

The ethylamine hydrochloride (4 g, 50 mmol) was dissolved in water (10 mL) and poured into dichloromethane (DCM, 10 mL) and water phase was adjusted to pH 12 by adding concentrated NaOH solution. Then the free amine was extracted with DCM. Combined organic layers were washed with brine and dried over sodium sulphate. 4-Boc-aminobenzoic acid (400 mg, 2 mmol), TBTU (650 mg) and DIEA (350 μL) were added to the DCM solution and left overnight at room temperature. After evaporation of the solvent, the residue was dissolved in ethyl acetate, washed with 10% sodium carbonate, water and brine, and dried over sodium sulphate. After evaporation, the residue was used for further reaction without purification.

Rt. 29.4 min [system 2], MS [M+1] 265.2,

### Ethyl 4-aminobenzamide

Ethyl 4-Boc-aminobenzamide (300 mg, 1.13 mmol) was dissolved in 20 mL trifluoroacetic acid solution containing water (0.5 mL) and triisopropylsilane (0.5 mL) and left for 3 h at room temperature. After evaporating the solvents, the residue was dissolved in 1 N HCl and washed with ethyl acetate. The water layer was adjusted to pH 12 by adding sodium carbonate and the product was extracted with ethyl acetate. The organic layer was washed with 10% sodium carbonate, water and brine, and dried over sodium sulphate. After evaporation, the residue was purified using preparative HPLC and transformed into acetate salt.

Rt. 9.15 min [system 2]; MS [M+1] 165.1; 1H NMR (500 MHz, (CD₃)₂CO): d (ppm) 1.13 (t, J=6.8 Hz, 3H), 3.33 (q, J=6.8 Hz, 2H), 6.63 (d, J=9 Hz, 2H), 7.62 (d, J=7.9 Hz, 2H).

### Compound (3) (2-Diethylamino)ethyl 4-aminobenzoate (procaine), hydrochloride was Purchased from Aldrich.

### Compound (4) N-(2-Diethylaminoethyl)-4-aminobenzamide (procainamide), hydrochloride was Purchased from RBI.

### Compound (5) Ethyl 4-amino-2-methoxybenzoate acetate

### Ethyl 2-methoxy-4-nitrobenzoate

2-Methoxy4-nitrobenzoic acid was esterified according to standard procedure. The acid (1.0 g, 5 mmol) was dissolved in ethanol (50 mL) in the presence of sulphuric acid (0.5 mL) and gently refluxed at the boiling point temperature. Alcohol was evaporated in vacuo. The residue was poured into 10% sodium carbonate and extracted with ethyl acetate. The organic layer was washed with 10% sodium carbonate, water and brine, and dried over sodium sulphate. The solution was evaporated to dryness and the resulting yellow residue was used for further reaction without purification.

Rt. 34.14 min [system 2], MS [M+1] 226.3.

### Ethyl 4-amino-2-methoxybenzoate

Ethyl 2-methoxy-4-nitrobenzoate (200 mg, 0.9 mmol) was dissolved in methanol (30 mL) and hydrogenated at room temperature under atmospheric pressure over 10% palladium on carbon. The reaction was completed after 3 h. The catalyst was filtered, and after evaporation the residue was purified by preparative HPLC and transformed into acetate salt.

Rt 19.48 min [system 2]; MS [M+1] 196.2; 1H NMR (500 MHz, (CD₃)₂CO): d (ppm) 1.25 (t, J=6.8 Hz, 3H), 3.75 (s, 3H), 4.15 (q, J=6.8 Hz, 2H), 6.23 (d, J=7.9 Hz, 1H), 6.29 (s, 1H), 7.58 (d, J=9 Hz,1H).

### Compound (6) Ethyl 4-amino-2-methoxy-benzamide acetate

### Ethyl 2-methoxy-4-nitrobenzamide

The ethylamine hydrochloride (4 g, 50 mmol) was dissolved in water (10 mL) and poured into dichloromethane (DCM, 10 mL) and water phase was adjusted to pH 12 by adding concentrated NaOH solution. Then the free amine was extracted with DCM. Combined organic layers were washed with brine and dried over sodium sulphate. 2-Methoxy4-nitrobenzoic acid (400 mg, 2 mmol), TBTU (650 mg) and DIEA (350 μL) were added to the DCM solution and left overnight at room temperature. After evaporation of the solvent, the residue was dissolved in ethyl acetate, washed with 10% sodium carbonate, water and brine, and dried over sodium sulphate. After evaporation, the residue was used for further reaction without purification.

Rt 24.8 min [system 2]; MS [M+1] 225.3

### Ethyl 4-amino-2-methoxy-benzamide

Ethyl 2-methoxy4-nitrobenzamide (400 mg, 1.78 mmol) was dissolved in methanol (50 mL) and hydrogenated at room temperature under atmospheric pressure over 10% palladium on carbon. The reaction was completed after 5 h. The catalyst was filtered, and after evaporation the residue was purified by preparative HPLC and transformed into acetate salt.

Rt. 13.56 min [system 2]; MS [M+1] 195.4; 1H NMR (500 MHz, (CD₃)₂CO): d (ppm) 1.13 (t, J=6.8 Hz, 3H), 3.34 (q, J=6.8 Hz, 2H), 3.88 (s, 3H), 6.3 (d, J=7.9, 1H), 6.32 (s, 1H), 7.84 (d, J=9 Hz, 1H).

### Compound (7) (2-Diethylamino)ethyl 4-amino-2-methoxvbenzoate acetate

### (2-diethylamino)ethyl 2-methoxy4-nitrobenzoate

2-Methoxy4-nitrobenzoic acid (600 mg; 3.0 mmol) was dissolved in 20 mL toluene containing N,N-diethylaminoethanol (400 μL; 30 mmol) and sulphuric acid (3 mL). The mixture was gently heated on water bath for 1 hour and left overnight at room temperature. Then the reaction solution was poured into 10% sodium carbonate. After the organic layer was separated, the product in the water layer was additionally extracted with ethyl acetate. The combined organic layers were washed with 10% sodium carbonate, water and brine, and dried over sodium sulphate. After evaporation the product was used for further reaction without purification.

Rt. 25.1 min [system 2], MS [M+1] 297.3,

### (2-diethylamino)ethyl 4-amino-2-methoxybenzoate

(2-diethylamino)ethyl 2-methoxy-4-nitrobenzoate (200 mg, 0.67 mmol) was dissolved in methanol (30 mL) and hydrogenated at room temperature under atmospheric pressure over 10% palladium on carbon. The reaction was completed after 4 h. The catalyst was filtered, and after evaporation the residue was purified by preparative HPLC and transformed into acetate salt.

Rt. 13.76 min [system 2]; MS [M+1] 267.2; 1H NMR (500 MHz, (CD₃)₂CO): d (ppm) 1.36 (t, J=6.8 Hz, 6H), 3.39 (q, J=6.8 Hz, 4H), 3.55 (t, J=4.5 Hz, 2H), 3.78 (s, 3H), 4.6 (t, J=4.5 Hz, 2H), 6.26 (d, J=7.9 Hz,1H), 6.35 (s, 1H), 7.68 (d, J=9 Hz, 1H).

### Compound (8) N-(2-Diethylaminoethyl) 4-amino-2-methoxybenzamide acetate

### N-(2-diethylaminoethyl) 4-amino-2-methoxybenzamide

2-Methoxy-4-nitrobenzoic acid (500 mg; 2.5 mmol) was dissolved in DMF (10 mL). 2-Diethylaminoethylamine (360 μL; 2.5 mmol), TBTU (800 mg) and DIEA (550 μL) were added and the mixture was left at room temperature for 2 h. Then mixture was poured into 10% sodium carbonate and extracted with ethyl acetate. The organic layer was washed with 10% sodium carbonate, water and brine, and dried over sodium sulphate. After evaporation, the product was used for further reaction.

Rt. 23.3 min [system 2], MS [M+1] 296.5.

### N-(2-diethylaminoethyl) 4-amino-2-methoxybenzamide

N-(2-diethylaminoethyl) 4-amino-2-methoxybenzamide (200 mg, 0.67 mmol) was dissolved in methanol (30 mL) and hydrogenated at room temperature under atmospheric pressure over 10% palladium on carbon. The reaction was completed after 4 h. The catalyst was filtered, and after evaporation the residue was purified by preparative HPLC and transformed into acetate salt.

Rt. 12.50 min [system 2]; MS [M+1] 266.2; 1H NMR (500 MHz, (CD₃)₂CO): d (ppm) 1.33 (t, J=6.8 Hz, 6H), 3.28 (m, 6H), 3.77 (t, J=4.5 Hz, 2H), 3.88 (s, 3H), 6.31 (d, J=7.9 Hz,1H), 6.38 (s, 1H), 7.82 (d, J=9 Hz, 1H).

### Compound (9) Ethyl 4-amino-3-chlorobenzoate acetate

Ethyl 4-aminobenzoate [compound (1)] (8.25 g; 0.05 mol) was dissolved in acetonitrile (100 mL). The solution was heated to boiling point and N-chlorosuccinimide (7.0 g; 0.0525 mol) was added gradually. The mixture was refluxed for 5 h and left overnight at room temperature. Acetonitrile was evaporated in vacuo and the solid residue was dissolved in DCM, washed with 5% NaOH, water and brine and dried over sodium sulphate. The product was purified using the preparative HPLC and transformed into acetate salt.

Rt 33.58 min [system 2]; MS [M+1] 200.1; 1H NMR (500 MHz, (CD₃)₂CO): d (ppm) 1.31 (t, J=6.8 Hz, 3H), 4.25 (q, J=6.8 Hz, 2H), 5.66 (bs, 2H), 6.89 (d, J=7.9 Hz, 1H), 7.68 (d, J=9 Hz,1 H), 7.83 (d, J=1.8 Hz, 1H).

### Compound (10) Ethyl 4-amino-3-chlorobenzamide acetate

### 4-Amino-3-chlorobenzoic acid

Ethyl 4-amino-3-chlorobenzoate [compound (9)] (1.0 g, 5 mmol) was refluxed for 3 h in methanol (50 mL) and water (100 mL) containing NaOH (2 g). The mixture was concentrated, acidified and extracted with ethyl acetate, the organic phase was washed with water, brine and dried over sodium sulphate. The final product was used for further reactions.

Rt. 4.75 min [system 1]; MS [M+1] 172.2

### Ethyl 4-amino-3-chlorobenzamide

The ethylamine hydrochloride (4 g, 50 mmol) was dissolved in water (10 mL) and poured into dichloromethane (DCM, 10 mL) and water phase was adjusted to pH 12 by adding concentrated NaOH solution. Then the free amine was extracted with DCM. Combined organic layers were washed with brine and dried over sodium sulphate. Amino-3-chlorobenzoic acid (350 mg, 2 mmol), TBTU (650 mg) and DIEA (350 μL) were added to the DCM solution and left overnight at room temperature. After evaporation of the solvent, the residue was dissolved in ethyl acetate, washed with 10% sodium carbonate, water and brine, and dried over sodium sulphate. After evaporation, the residue was purified by the preparative HPLC and transformed into acetate salt.

Rt. 18.06 min [system 2]; MS [M+1] 198.9; 1H NMR (500 MHz, (CD₃)₂CO): d (ppm) 1.13 (t, J=6.8 Hz, 3H), 3.34 (q, J=6.8 Hz, 2H), 5.45 (bs, 2H), 6.85 (d, J=7.9 Hz, 1H), 7.46 (bs, 1H), 7.60 (d, J=9 Hz, 1H), 7.78 (d, J=1.8 Hz, 1H).

### Compound (11) (2-Diethylamino)ethyl 4-amino-3-chlorobenzoate acetate

(2-Diethylamino)ethyl 4-aminobenzoate [compound (3)] (500mg; 1.8 mmol) was dissolved in acetonitrile (40 mL). The solution was heated to boiling point and N-chlorosuccinimide (256 mg; 1.9 mmol) was added gradually. The mixture was refluxed for 5 h and left overnight at room temperature. Acetonitrile was evaporated in vacuo and the solid residue was dissolved in DCM, washed with 5% NaOH, water and brine and dried over sodium sulphate. The product was purified using the preparative HPLC and transformed into acetate salt.

Rt. 19.36 min [system 2]; MS [M+1] 270.9; 1H NMR (500 MHz, (CD₃)₂CO): d (ppm) 1.36 (t, J=6.8 Hz, 6H), 3.36 (q, J=6.8 Hz, 4H), 3.61 (t, J=4.1 Hz, 2H), 4.66 (t, J=4.5 Hz, 2H), 5.75 (bs, 2H), 6.9 (d, J=7.9 Hz, 1H), 7.78 (d, J=9 Hz, 1H), 7.88 (d, J=1.8 Hz, 1H).

### Compound (12) N-(2-Diethylaminoethyl) 4-amino-3-chlorobenzamide acetate

N-(2-Diethylaminoethyl) 4-aminobenzamide [compound (4)] (500mg; 1.8 mmol) was dissolved in acetonitrile (40 mL). The solution was heated to boiling point and N-chlorosuccinimide (256 mg; 1.9 mmol) was added gradually. The mixture was refluxed for 5 h and left overnight at room temperature. Acetonitrile was evaporated in vacuo and the solid residue was dissolved in DCM, washed with 5% NaOH, water and brine and dried over sodium sulphate. The product was purified using the preparative HPLC and transformed into acetate salt.

Rt. 16.1 min [system 2]; MS [M+1] 269.9; 1H NMR (500 MHz, (CD₃)₂CO): d (ppm) 1.32 (t, J=6.8 Hz, 6H), 3.31 (q, J=6.8 Hz, 4H), 3.41 (t, J=4.5 Hz, 2H), 3.76 (q, J=4.5 Hz, 2H), 5.44 (bs, 2H), 6.85 (d, J=7.9 Hz, 1H), 7.68 (d, J=9 Hz, 1H), 7.85 (s, 1H), 8.8 (bs, 1H).

### Compound (13) Ethyl 4-amino-5-chloro-2-methoxybenzoate acetate

4-Amino-5-chloro-2-methoxybenzoic acid (0.4 g, 2 mmol) was dissolved in ethyl alcohol (50 mL) in the presence of sulphuric acid (0.5 mL) and gently refluxed at the boiling point temperature overnight. Alcohol was evaporated in vacuo. The residue was poured into 10% sodium carbonate and extracted with ethyl acetate. The organic layer was washed with 10% sodium carbonate, water and brine, and dried over sodium sulphate. The solution was evaporated to dryness and the resulting residue was purified using preparative HPLC and transformed into acetate salt.

Rt 30.97 min [system 2]; MS [M+1] 230.0; 1H NMR (500 MHz, (CD3)2CO): d (ppm) 1.28 (t, J=6.8 Hz, 3H), 3.77 (s, 3H), 4.19 (q, J=6.8 Hz, 2H), 5.55 (bs, 2H), 6.55 (s, 1 H), 7.69 (s, 1H).

### Compound (14) Ethyl 4-amino-5-chloro-2-methoxybenzamide acetate

Ethylamine hydrochloride (4 g, 50 mmol) was dissolved in water (10 mL) and poured into dichloromethane (DCM, 10 mL) and water phase was adjusted to pH 12 by adding concentrated NaOH solution. Then the free amine was extracted with DCM. Combined organic layers were washed with brine and dried over sodium sulphate. 4-Amino-5-chloro-2-methoxybenzole acid (400 mg, 2 mmol), TBTU (650 mg) and DIEA (350 μL) were added to the DCM solution and left overnight at room temperature. After evaporation of the solvent, the residue was dissolved in ethyl acetate, washed with 10% sodium carbonate, water and brine, and dried over sodium sulphate. After evaporation, the residue was purified by the preparative HPLC and transformed into acetate salt.

Rt 22.73 min [system 2]; MS [M+1] 229.0; 1H NMR (500 MHz, (CD₃)₂CO): d (ppm) 1.12 (t, J=6.8 Hz, 3H), 3.32 (m, 2H), 3.9 (s, 3H), 5.39 (d, J=9.3 Hz, 2H), 6.59 (s, 1H), 7.84 (d, J=2.4 Hz, 1H), 7.95 (s, 1H).

### Compound (15) (2-diethylamino)ethyl-4-amino-5-chloro-2-methoxybenzoate acetate

4-Amino-5-chloro-2-methoxybenzoic acid (400 mg, 2 mmol) was dissolved in toluene (20 mL) containing N,N-diethylaminoethanol (400 μL; 30 mmol) and sulphuric acid (3 mL). The mixture was gently heated with stirring on water bath for 1 h and left overnight at room temperature. Then it was poured into 10% sodium carbonate. After the organic layer was separated, the water layer was additionally extracted with ethyl acetate. The combined organic layers were washed with 10% sodium carbonate, water and brine, and dried over sodium sulphate. After evaporation, the product was purified by preparative HPLC and transformed into acetate salt.

Rt. 18.9 min [system 2]; MS [M+1] 301.3; 1H NMR (500 MHz, (CD₃)₂CO): d (ppm) 1.35 (t, J=6.8 Hz, 6H), 3.31 (m, 6H), 3.8 (s, 3H), 4.62 (t, J=4.5 Hz, 2H), 5.85 (bs, 2H), 6.57 (s, 1H), 7.75 (s, 1H).

### Compound (16) N-(2-diethylaminoethyl)4-amino-5-chloro-2-methoxybenzamide (metoclopramide)hydrochloride was purchased from ICN.

### Compound (17) Methyl-4-aminobenzoate was purchased from Aldrich.

### Compound (18) Propyl-4-aminobenzoate was purchased from Fluka.

### Compound (19) Butyl-4-aminobenzoate was purchased from Aldrich.

### Compound (20) Isobutyl-4-aminobenzoate was purchased from TCI.

### Compound (21) Glyceryl p-aminobenzoic acid was purchased from ICN.

### Compound (22) 4-Aminobenzoic acid phenyl ester

A mixture of 4-aminobenzoic acid (200 mg, 1.46 mmol), phenol (280 mg, 3.92 mmol), DCC (300 mg, 1.46 mmol) and catalytic amount of DMAP (20 mg, 0.15 mmol) in acetonitrile (10 mL) was stirred at room temperature for 18 h. The reaction mixture was filtered and subjected to silica-gel column chromatography (ethyl acetate:hexane=1:1) and re-crystallized with ambient solvent.

Rt. 7.46 min [system 1]; MS [M+1] 214.2; 1H NMR (500 MHz, CD₃OD): d (ppm) 4.00 (bs, —NH₂),6.68 (d, J=8.61 Hz, 2H), 7.15 (d, J=7.5 Hz, 2H), 7.24 (t, J=7.5 Hz, 1H), 7.4 (t, J=7.89 Hz, 2H), 7.87 (d, J=8.86 Hz, 2H).

### Compound (23) Butacaine was Purchased from Sigma.

### Compound (24) 4-Amino-N-isopropyl-benzamide

A mixture of 4-aminobenzoic acid (200 mg, 1.46 mmol), isopropylamine (1.0 mL, 11.7 mmol), and TBTU (480 mg, 1.50 mmol) in acetonitrile (10 mL) was stirred at room temperature for 18 h. The reaction mixture was extracted with ethyl acetate, treated with 10% aq. NaOH solution and the extracted organic layer was dried over Na₂SO₄ and concentrated in vacuo. The residue was subjected to silica-gel column chromatography (ethyl acetate:hexane=2:1) and re-crystallized with ambient solvent.

Rt. 2.85 min [system 1]; MS [M+1] 179.2; 1H NMR (500 MHz, CD₃OD): d (ppm) 1.21 (d, J=6.6 Hz, 6H), 4.00 (bs, —NH₂), 4.15 (m, J=6.3 Hz, 1H), 6.65 (dd, J=1.46 Hz J=4.45 Hz, J=2,59 Hz, 2H), 7.57 (dd, J=1.72 Hz, J=4.57 Hz, J=2.26 Hz, 2H), 8.00 (bs, —COOH).

### Compound (25) 4-Aminohippuric acid was Purchased from Fluka.

### Compound (26) N-(4-aminobenzoyl)β-alanine was purchased from Avocado Research Chemicals Ltd.

### Compound (27) N-(4-aminobenzoyl)-alanine

This compound was synthesized by solid phase synthesis. Fmoc-Ala-Wang resin (571 mg; 0.4 mmol) was swelled in DMF and washed with DMF. Fmoc group was removed by 20% piperidine/DMF (15 min, twice). After washing the resin with DMF (4 times), 4-aminobenzoic acid (247 mg; 4 eq.), TBTU (640 mg), HOBT (60 mg) and DIEA (516 mg) in DMF (10 ml) was added to the resin and mixed for 2 h. Then the solution was removed and the resin was washed with DMF (3 times) and DCM (3 times) and dried in vacuo. The product was cleaved from the resin with TFA (92.5%), water (5.0%) and triisopropylsilane (2.5%) at room temperature for 1 h and purified by preparative HPLC.

Rt.=3.98 min [system 1], MS [M+1] 209.1.

### Compound (28) N-(4-aminobenzoyl)-L-threonine

This compound was synthesized by solid phase synthesis. Fmoc-Thr(tBu)-Wang resin (800 mg; 0.4 mmol) was swelled in DMF and washed with DMF. Fmoc group was removed by 20% piperidine/DMF solution (15 min, twice). After washing with DMF (4 times), 4-aminobenzoic acid (247 mg; 4 eq.), TBTU (640 mg), HOBT (60 mg) and DIEA (516 mg) in DMF (10 mL) were added to the resin and mixed for 2 h. Then, the solution was removed and the resin was washed with DMF (3 times) and DCM (3 times) and dried in vacuo. The product was cleaved from the resin with TFA (92.5%), water (5.0%) and triisopropylsilane (2.5%) at room temperature for 1 h and purified by preparative HPLC.

Rt. 2.42 min [system 1], MS [M+1] 238.9.

### Compound (29) N-(4-aminobenzoyl)-L-aspartic acid

This compound was synthesized by solid phase synthesis. Fmoc-Asp(OtBu)-Wang resin (640 mg; 0.4 mmol) was swelled in DMF and washed with DMF. Fmoc group was removed with 20% piperidine/DMF solution (15 min, twice). After washing with DMF (4 times), 4-aminobenzoic acid (247 mg; 4 eq.), TBTU (640 mg), HOBT (60 mg) and DIEA (516 mg) in DMF (10 ml) were added to the resin and mixed for 2 h. Then, the solution was removed and the resin was washed with DMF (3 times) and DCM (3 times) and dried in vacuo. The product was cleaved from the resin with TFA (92.5%), water (5.0%) and triisopropylsilane (2.5%) at room temperature for 1 h and purified by preparative HPLC.

Rt. 1.75 min [system 1], MS [M+1] 252.9.

### Compound (30) N-(4-aminobenzoyl)-L-glutamic acid was Purchased from Aldrich.

### Compound (31) 4-Amino-2-methoxybenzoic acid

### Ethyl 2-methoxy4-nitrobenzoate

2-Methoxy4-nitrobenzoic acid (1.0 g; 5 mmol) was dissolved in thionyl chloride (15 mL) and refluxed for 30 min, then the unreacted thionyl chloride was evaporated and the resulting acid chloride was mixed with ethanol (100 ml) containing triethylamine (3 ml). The mixture was left overnight. After evaporation the mixture was dissolved in ethyl acetate and washed with 10% sodium carbonate, water, 0.1 M HCl, water, brine and dried over sodium sulphate. After evaporation the product was used for further reaction without purification.

Rt. 8.03 min [system 1], MS [M+1] 226.3.

### Ethyl 4-amino-2-methoxybenzoate

Ethyl 2-methoxy-4-nitrobenzoate (200 mg) was dissolved in methanol (30 mL) and hydrogenated at room temperature under atmospheric pressure over 10% palladium on carbon. The reaction was completed after 3 hours. The catalyst was filtered and after evaporation the residue was used for further reaction.

Rt. 4.83 min [system 1]; MS [M+1] 196.2.

### 4-Amino-2-methoxybenzoic acid

Ethyl 4-amino-2-methoxybenzoate (0.1 g, 0.5 mmol) was refluxed in methanol (50 mL) and 10% NaOH solution (50 mL) for two hours. Then the mixture was concentrated, neutralized and extracted with ethyl acetate. The organic layer was washed with water and brine and dried over sodium sulphate. The product was finally purified by preparative HPLC.

Rt 2.60 min [system 1]; MS [M+1] 168.1; 1H NMR (500 MHz, CD₃OD): d (ppm) 3.91 (s, 3H), 4.0 (bs, —NH₂), 6.3 (dd, J=2.34 Hz, J=6.35 Hz, J=2.18 Hz, 1H), 6.37 (s, 1H); 7.69 (d, J=9.07 Hz), 11.00 (bs, —COOH).

### Compound (32) 4-Amino-2-ethoxybenzoic acid

### Methyl 2-ethoxy-4-nitrobenzoate [compound (113)]

z-Ethoxy4-nitrobenzoic acid (1 g, 5 mmol) was refluxed with thionyl chloride (15 mL) for 30 min, then the unreacted thionyl chloride was evaporated and the resulting acid chloride was mixed with methyl alcohol (100 mL) containing triethylamine (3 mL). The mixture was left overnight. After evaporation the mixture was dissolved in ethyl acetate and washed with 10% sodium carbonate, water, 0.1 M HCl, water, brine and dried over sodium sulphate. After evaporation residue was used for further reaction.

Rt. 8.04 min[system 1], MS [M+1] 226.3.

### 4-Amino-2-ethoxybenzoic acid

Methyl 2-ethoxy4-nitrobenzoate (0.1 g, 0.5 mmol) was dissolved in ammonia (30 mL) and water (30 mL) and reduced by stirring with zinc powder (1 g) for 24 h. The mixture was filtered, evaporated to dryness and extracted with acetone and methanol. The combined organic phases were evaporated and the residue was finally purified using preparative HPLC.

Rt. 3.61 min [system 1]; MS [M+1] 182.0; 1H NMR (500 MHz, CD₃OD): d (ppm) 1.47 (t, J=6.9 Hz, 3H), 4 (bs, —NH₂), 4.2 (q, J=6.9 Hz, 2H), 6.28 (dd, J=1.5 Hz, J=6.1 Hz, J=2.7,1 H), 6.33 (d, J=1.6 Hz,1H), 7.66 (d, J=8.74 Hz, 1H), 11.00 (bs, —COOH).

### Compound (33) 2-Propoxy4-aminobenzoic acid

### Ethyl-2-hydroxy4-nitrobenzoate [compound (114)]

2-Hydroxy4-nitrobenzoic acid (1.0 g, 5.46 mmol) was dissolved in ethanol (20 ml) in presence of H₂SO₄ (0.5 mL) and gently refluxed at the boiling point temperature overnight. The alcohol was then evaporated and the residue was poured into 10% sodium carbonate solution, and extracted with ethyl acetate. The organic layer was washed with water, brine and dried over sodium sulphate. After evaporation the product was used for the next reactions without further purification.

Rt. 8.9 min [system 1], MS [M+1] 213.0.

### Ethyl 2-propoxy4-nitrobenzoate [compound (115)]

Ethyl 2-hydroxy4-nitrobenzoate (50 mg, 2.37 mmol), propyl bromide (0.116 g, 4 eq.) and K₂CO₃ (0.130 g) were placed in a 100 mL round bottom flask and acetone (50 mL) were added. The mixture was heated at reflux for 24 hours and the progress of the reaction was monitored by MS. After 48 h, the reaction mixture was poured over water and then the organic layer separated. The aqueous layer was extracted 2 times with ethyl acetate and the combined organic layers were washed with water, brine and dried over Na₂SO₄. The organic extract was evaporated and the product was used for the next reaction without further purification.

Rt. 10.23 min [system 1], MS [M+1] 254.2.

### Ethyl 2-propoxy-4-aminobenzoate

Ethyl 2-propoxy4-nitrobenzoate (100 mg, 3.95 mmol) was suspended in 10% aqueous ammonia (25mL) and was stirred at room temperature with zinc dust (206 mg). The mixture was reacted for 2 days and the progress was checked by MS. The reaction mixture was then filtered to remove the zinc residue and the precipitate was washed with acetone and water. The filtrate mixture was treated with diluted HCl, poured into water and then extracted with CH₂Cl₂. Th organic layer was then washed with water and brine, dried over Na₂SO₄ and evaporated to give ethyl 2-propoxy-4-aminobenzoate which was then used for further reaction without purification.

Rt. 8.94 min [system 1], MS [M+1] 224.0.

### 2-Propoxy4-aminobenzoic acid

Ethyl 2-propyloxy4-aminobenzoate (70 mg, 0.3 mmol) was refluxed in a mixture of ethanol and water (50 mL) containing NaOH (1.0 g) for 24 hours. After cooling the mixture was extracted with CH₂Cl₂. The aqueous phase was then acidified with HCl and extracted again with CH₂Cl₂. The combined extracts were washed with water and brine, dried with Na₂SO₄ and the filtrate was evaporated and the product was purified by preparative HPLC.

Rt. 4.86 min [system 1]; MS [M+1] 196.0; 1H NMR (500 MHz, CD₃OD): d (ppm) 1.05 (t, J=7 Hz, 3H), 1.86 (m, J=6.5 Hz, 2H), 4.09 (q, J=7 Hz, 2H), 6.2 (d, J=8.9 Hz, 1H), 6.33 (s, 1H), 7.64 (d, J=8.7 Hz, 1H).

### Compound (34) 2-Butyloxy-4-aminobenzoic acid

### Ethyl-2-hydroxy4-nitrobenzoate

2-Hydroxy4-nitrobenzoic acid (1.0 g, 5.46 mmol) was dissolved in ethanol (20 ml) in presence of H₂SO₄ (0.5 mL) and gently refluxed at the boiling point temperature overnight. The alcohol was then evaporated and the residue was poured into 10% sodium carbonate solution, and extracted with ethyl acetate. The organic layer was washed with water, brine and dried over sodium sulphate. After evaporation the product was used for the next reactions without further purification.

Rt. 8.9 min [system 1], MS [M+1] 213.0.

### Ethyl 2-butyloxy-4-nitrobenzoate [compound (116)]

Ethyl 2-hydroxy4-nitrobenzoate (50 mg, 2.36 mmol), butyl bromide (0.130 g, 4 eq.) and K₂CO₃ (0.130 g) were dissolved in acetone (50 mL). The mixture was heated at reflux for 24 h and the progress of the reaction was monitored by MS. After 48 hours the reaction mixture was poured over water and then the organic layer separated. The aqueous layer was extracted two times with ethyl acetate and the combined organic layers were washed with water, brine and dried over Na₂SO₄. The organic extract was then evaporated and the product was used for the next reaction without further purification.

Rt. 9.59 min [system 1], MS [M+1] 268.2.

### 2-Butyloxy-4-aminobenzoic acid

Ethyl 2-butyloxy-4-nitrobenzoate (100 mg, 3.74 mmol) was suspended in 10% aqueous ammonia (25mL) and was stirred at room temperature with zinc dust (206 mg). The mixture was reacted for 2 days and the progress was checked by MS. The reaction mixture was then filtered to remove the zinc residue and the precipitate was washed with acetone and water. The filtrate mixture was treated with diluted HCl, poured into water and then extracted with CH₂Cl₂. Th organic layer was then washed with water and brine, dried over Na₂SO₄ and evaporated to give 2-butyloxy4-aminobenzoic acid which was then purified by preparative HPLC.

Rt. 5.98 min [system 1]; MS [M+1] 210.0; 1H NMR (500 MHz, CD₃0D): d (ppm) 0.99 (t, J=7 Hz, 3H), 1.29 (m, J=6.5 Hz, 2H), 1.52 (m, J=6.7 Hz, 2H), 4.15 (q, J=7 Hz, 2H), 6.28 (d, J=7.50 Hz, 1H), 6.33 (s,1H), 7.68 (d, J=7.6 Hz, 1H).

### Compound (35) 4-Amino salicylic acid was purchased from Acros Organics.

### Compound (36) 4-Amino-2-chlorobenzoic acid was purchased from Aldrich.

### Compound (37) 2,4-diaminobenzoic acid

A suspension of about 0.005 g of 10% Pd-C catalyst in 3 mL of THF, acetic acid (0.5 mL) and 4-amino-3-hydroxybenzoic acid (0.25 g; 1.2 mmol) were added to THF (50 mL), maintaining an inert atmosphere (under N₂). Hydrogen was passed through the reaction mixture until the solution became colorless. Then the catalyst was separated by centrifugation and the solvents were evaporated in the stream of nitrogen. After that the solid residue that is sensitive to oxygen was purified by preparative HPLC.

Rt. 1.05 min [system 1]; MS [M+1] 153.2; 1H NMR (500 MHz, CD₃OD): d (ppm) 6.39 (d, J=8.2 Hz, 1H), 6.64 (s,1H), 6.65 (d, J=8.00 Hz, 1H).

### Compound (38) 4-amino-2-acetoxybenzoic acid

### Methyl 4-nitrosalicylate [compound (117)]

4-Nitrosalicylic acid (10 g, 55 mmol) was dissolved in methyl alcohol (200 mL) in the presence of sulphuric acid (1 mL) and gently refluxed at the boiling point temperature overnight. The methyl alcohol was evaporated and the residue was poured into 10% sodium carbonate and extracted with ethyl acetate. The organic layer was washed with 10% sodium carbonate, water and brine, and dried over sodium sulphate. The solution was evaporated and the resulting ester was used for further reactions without purification.

Rt. 8.02 min [system 1], MS [M+1] 198.

### 2-Acetoxy-4-nitrobenzoic acid

Methyl 4-nitrosalicylate (0.6 g, 3 mmol) was dissolved in water containing NaOH (0.3 g) and was refluxed with iodoacetic acid (560 mg, 3.0 mmol) overnight. Then the solution was acidified and the product was extracted with ethyl acetate. The organic layer was washed with water and brine, and dried over sodium sulphate The solvent was evaporated and the product was immediately used for further synthesis.

Rt. 6.73 min [system 1], MS [M+1]242.2.

### 2-Acetoxy4-aminobenzoic acid

2-Acetoxy-4-nitrobenzoic acid (300 mg, 1.25 mmol) was dissolved in concentrated ammonia and water (50 mL), and reduced overnight using zinc powder (3 g). The reaction solution was filtered, acidified to pH 5 and evaporated to dryness. The product was extracted with acetone and methanol, dried and purified using preparative HPLC.

Rt. 2.46 min [system 1]; MS [M+1] 212.1; 1H NMR (500 MHz, CD₃0D): d (ppm) 4.73 (m, J=6 Hz, 2H), 6.098 (s,1H), 6.16 (d, J=8.2 Hz,1H), 7.54 (d, J=8.38 Hz, 1H).

### Compound (39) 4-Amino-m-toluic acid was Purchased from Aldrich.

### Compound (40) 4-Amino-3-hydroxybenzoic acid was Purchased from Aldrich.

### Compound (41) 3-Butyloxy-4-aminobenzoic acid

Benoxynate hydrochloride (100 mg, 0.29 mmol) was suspended in a mixture of ethanol and water (50 mL) containing NaOH (2.0 g) and was heated under stirring for 24 h. After cooling, the mixture was extracted with CH₂Cl₂. The aqueous phase was then acidified with HCl and extracted again with CH₂Cl₂. The combined extracts were washed with water and brine, dried with Na₂SO₄ and the filtrate was evaporated. The product was purified by preparative HPLC.

Rt. 6.12 min [system 1]; MS [M+1] 210.0; 1H NMR (500 MHz, CD₃OD): d (ppm)(.099 (t, J=6.6 Hz, 3H), 1.54 (m, J=7.7 Hz, 2H), 1.8 (m, J=7.05 Hz, 2H), 4.03 (q, J=5.8 Hz, 2H), 6.68 (d, J=7.65 Hz, 1H), 7.43 (s, 1H), 7.44 (d, J=8.18 Hz, 1H).

### Compound (42) 4-Amino-3-chlorobenzoic acid

### Ethyl 4-amino-3-chlorobenzoate

Ethyl 4-aminobenzoate (8.25 g; 50 mmol) was dissolved in acetonitrile (100 mL). The solution was heated to boiling point and N-chlorosuccinimide (7.0 g; 52.5 mmol) was added gradually. The mixture was refluxed for 5 h and left overnight at room temperature. Acetonitrile was evaporated in vacuo and the solid residue was dissolved in methylene chloride, washed with 5% NaOH, water and brine and dried over sodium sulphate. Product crystallized and was used for further reaction without purification.

Rt. 7.78 min [system 1]; MS [M+1] 200.1.

### 4-Amino-3-chlorobenzoic acid

Ethyl 4-amino-3-chlorobenzoate (1.0 g, 5 mmol) was refluxed for 3 h in methanol (50 mL) and water (100 mL) containing NaOH (2 g). The mixture was concentrated, acidified and extracted with ethyl acetate, the organic phase was washed with water, brine and dried over sodium sulphate. The final product was purified using preparative HPLC.

Rt. 4.75 min [system 1]; MS [M+1] 172.2; 1H NMR (500 MHz, CD₃OD): d (ppm) 4.00 (bs, —NH₂), 6.74 (d, J=8.9 Hz, 1H), 7.63 (dd, J=1.64 Hz, J=7.12 Hz, J=1.88 Hz, 1H), 7.79 (d, J=1.68 Hz, 1H), 11.00 (bs, —COOH).

### Compound (43) 4-Amino-3-bromobenzoic acid

### Ethyl 4-amino-3-bromobenzoate

Ethyl 4-aminobenzoate (8.25 g; 50 mmol) was dissolved in acetonitrile (100 mL). The solution was heated to boiling point and N-bromosuccinimide (52.5 mmol) was added gradually. The mixture was refluxed for 5 h and left overnight at room temperature. Acetonitrile was evaporated in vacuo and the solid residue was dissolved in methylene chloride, washed with 5% NaOH, water and brine and dried over sodium sulphate. Product crystallized and was used for further reaction without purification.

Rt. 7.99 min [system 1], MS [M+1] 244.0.

### 4-Amino-3-bromobenzoic acid

Ethyl 4-amino-3-bromobenzoate (1.2 g, 5 mmol) was refluxed for 3 h in methanol (50 mL) and water (100 mL) containing NaOH (2 g). The mixture was concentrated, acidified and extracted with ethyl acetate, the organic phase was washed with water, brine and dried over sodium sulphate. After evaporation the final product was purified using preparative HPLC.

Rt 5.00 min [system 1]; MS [M+1] 215.9; 1H NMR (500 MHz, CD₃OD): d (ppm) 6.77 (d, J=8.5 Hz, 1H), 7.7 (d, J=8.31 Hz,1H), 7.99 (s,1H).

### Compound (44) 4-Amino-3-nitrobenzoic acid was Purchased from Avocado Research Chemicals Ltd.

### Compound (45) 4-(Methylamino)benzoic acid was purchased from Aldrich.

### Compound (46) 4-(Propylamino)benzoic acid

### 4-(N-tosylamido)benzoic acid [compound (118)]

4-Aminobenzoic acid (15.0 g, 110 mmol) was dissolved in 5% NaOH solution (150 mL) and heated to 80° C. Tosyl chloride (25.0 g, 130 mmol) was added gradually to the mixture, and more NaOH solution was added to adjust pH above 8, After one hour the mixture was left to cool to room temperature, was acidified and left in the fridge. The precipitate was filtered and washed with water, giving practically pure product for further syntheses.

Rt. 6.98 min [system 1], MS [M+1] 292.1.

### Methyl 4-(N-Tosylamido)benzoate [compound (119)]

4-(N-tosylamido)-benzoic acid (5.0 g, 17 mmol) was refluxed in methanol (200 mL) and sulphuric acid (0.5 mL) overnight. Then the alcohol was evaporated and the residue was poured into 10% solution of sodium carbonate, and then the mixture was extracted with ethyl acetate. The organic phase was washed with water, brine and dried over sodium sulphate. After evaporation the product was used for further synthesis.

Rt. 8.21 min [system 1], MS [M+1] 306.2.

### Methyl 4-(N-propyl-N-Tosylamido)benzoate [compound (120)]

Methyl 4-(N-Tosylamido)benzoate (0.5 g, 1.6 mmol) was dissolved in acetone (20 mL) containing well ground potassium carbonate (1.0 g). Propyl bromide (1.0 g, 8.1 mmol) was added and the reaction was refluxed for 2 h and kept at 40° C. for 24 h. The mixture was evaporated, dissolved in water and extracted with ethyl acetate. The organic phase was washed with water, brine and dried over sodium sulphate. After evaporation the product was used for further synthesis.

Rt. 10.08 min [system 1], MS [M+1] 348.1.

### Methyl 4-(propylamino)benzoate [compound (121)]

Methyl 4-(N-propyl-N-Tosylamido)benzoate (1.0 g, 2.8 mmol) was dissolved in ice cold concentrated sulphuric acid (15 mL), after 5 min the mixture was poured over ice, alkalized and extracted with ethyl acetate. The organic phase was washed with water, brine and dried over sodium sulphate. The crude product was used for further reactions without purification.

Rt. 7.93 min [system 1], MS [M+1] 194.2

### 4-(Propylamino)benzoic acid

Methyl 4-(propylamino)benzoate (0.5 g, 2.5 mmol) was refluxed in methanol (50 mL) and water (100 mL) containing NaOH (2 g) for 3 h. The mixture was concentrated, acidified and extracted with ethyl acetate. The organic phase was washed with water, brine and dried over sodium sulphate. The final product was purified using preparative HPLC.

Rt. 5.52 min [system 1]; MS [M+1] 180.1; 1H NMR (500 MHz, CD₃OD): d (ppm) 1.00 (t, J=7.41 Hz, 3H), 1.63 (m, J=7.2 Hz, 2H), 3.1 (t, J=7.1 Hz, 2H), 4.0 (bs, —NH), 6.56 (d, J=6.68 Hz, 2H), 7.76 (d, J=6.8 Hz, 2H), 11.00 (bs, —COOH).

### Compound (47) 4-(Butylamino)benzoic acid was Purchased from Aldrich.

### Compound (48) 4-(D-Xylosylamino)benzoic acid

4-Aminobenzoic acid (0.137 g; 1 mmol) and D-xylose (0.150 g; 1 mmol) were dissolved in methanol (10 mL) and incubated at 45° C. for 24 h. Then, methanol was evaporated and the residue was dried in vacuo. The product was crystallized twice from ethanol.

Rt. 2.47 min [system 1]; MS [M+1] 269.9; 1H NMR (500 MHz, CD₃OD): d (ppm) 3.51 (m, J=2.65 Hz, 6H), 3.73 (m, J=7.9 Hz, 2H), 4.00 (bs, —NH),4.9 (m, J=7 Hz, 1H), 6.77 (d, J=14 Hz, 2H), 7.81 (d, J=12.6 Hz, 2H), 11.00 (bs, —COOH).

### Compound (49) 4-Acetamidobenzoic acid was Purchased from Aldrich.

### Compound (50) 4-Propamidobenzoic acid

4-Aminobenzoic acid (1.0 g, 7 mmol) was dissolved in aqueous sodium carbonate solution (50 mL) and propionic anhydride (2 g, 15 mmol) was added under pH control. The mixture was left overnight and acidified. The product was filtered off and purified using preparative HPLC.

Rt 4.40 min [system 1]; MS [M+1] 194.1; 1H NMR (500 MHz, CD₃OD): d (ppm) 1.17 (t, J=6.8 Hz, 3H), 2.39 (q, J=7.61 Hz, 2H), 7.62 (d, J=8.8 Hz, 2H), 7.92 (d, J=8.7 Hz, 2H), 8.00 (bs, —NH), 11.00 (bs, —COOH).

### Compound (51) 4-(2-(N-Piperidine)acetamido)benzoic acid

### 2-(N-Piperidine)acetic acid

Ethyl 1-piperidineacetate (5 mL, 28.7 mmol) was refluxed gently in methanol (50 mL) and water (100 mL) containing NaOH (3 g) for 6 h. Then the mixture was neutralized and evaporated to dryness. The residue was extracted with acetone and methanol. After evaporation the product was used for further reaction without purification.

MS [M+1] 144.2.

### Ethyl 4-(2-(N-piperidine)acetamido)benzoate [compound (122)]

2-(N-piperidine)acetic acid (2 g, 14 mmol) was dissolved in DMF (20 mL). TBTU (4.5 g), and DIEA (3mL) were then added, followed by addition of ethyl 4-aminobenzoate (1 g, 6 mmol). The reaction was left overnight, then the product was poured into 10% sodium carbonate, and extracted with ethyl acetate. Organic layer was washed with brine and dried over sodium sulphate. The product was used for further reaction without purification.

Rt. 5.08 min [system 1], MS [M+1] 291.0.

### 4-(2-(N-piperidine)acetamido)benzoic acid

Ethyl 4-(2-(N-piperidine)acetamido)benzoate (1.0 g, 3.5 mmol) was refluxed in methanol (50 mL) and water (100 mL) containing NaOH (2.0 g) for 2 h. The mixture was neutralized and evaporated. The product was extracted with acetone and methanol. The organic phase was evaporated and the product was purified using preparative HPLC.

Rt. 3.59 min [system 1]; MS [M+1] 263.1; 1H NMR (500 MHz, CD₃OD): d (ppm) 1.94 (m, J=9 Hz, 6H), 3.09 (m, J=6 Hz, J=12 Hz, 4H), 4.1 (m, J=5 Hz, 2H), 7.71 (d, L=8 Hz, 2H), 8.0 (d, J=8.4 Hz, 2H).

### Compound (52) 4-(D-Glucopyranosylamino)benzoic acid

4-aminobenzoic acid (0.137 g; 1 mmol) and D-glucose (0.180 g; 1 mmol) were dissolved in methanol (10 mL) and incubated at 45° C. for 24 h. Then, methanol was evaporated and the residue was dried in vacuo. The product was crystallized twice from ethanol.

Rt.1.09 min [system 1]; MS [M+1] 300.0; 1H NMR (500 MHz, CD₃OD): d (ppm) 3.30 (s, 4-OH), 3.314 (m, J=8.5 Hz, 1H), 3.45 (t, J=8.7 Hz, 1H), 3.66 (dd, J=5.19 Hz, J=6.83 Hz, J=4.7 Hz,1H), 3.85 (d, J=11.6 Hz, 1H), 4.0 (bs, —NH), 4.63 (d, J=8.5 Hz, 1H), 6.79 (d, J=8.11 Hz, 2H), 7.81 (d, J=8.3 Hz, 2H), 11.00 (bs, —COOH).

### Compound (53) 4-(o-Tolilamido)benzoic acid

2-Methylbenzoic acid (1 g, 7 mmol) was refluxed with thionyl chloride (10 mL) for 30 min. The excess of thionyl chloride was evaporated. The acyl chloride was dissolved in toluene (25 mL), and pyridine (2 mL) and 4-aminobenzoic acid (1 g, 7 mmol) was added. The mixture was left overnight then acidified and extracted with ethyl acetate. The organic phase was washed with water, brine and dried over sodium sulphate. The product was evaporated and purified using preparative HPLC.

Rt. 6.69 min [system 1]; MS [M+1] 256.2; 1H NMR (500 MHz, CD₃OD): d (ppm) 2.46 (s, 3H), 7.3 (m, J =3.89 Hz, 1H), 7.38 (t, J=5.9 Hz, 1H), 7.47 (d, J=7.5 Hz, 1H), 7.79 (d, J=8.9 Hz, 2H), 7.89 (bs, 1H), 8.00 (d, J=8.5 Hz, 2H), 8.05 (bs, —NH), 11.00 (bs, —COOH).

### Compound (54) 4-(3,5-Di-t-butyl4-hydroxybenzamido)benzoic acid

### Ethyl 4-(3,5-di-t-butyl-4-hydroxybenzamido)benzoate [compound (122)]

Ethyl 4-aminobenzoate (0.5 g, 3 mmol) was added to a solution of 3,5-di-t-butyl4-hydroxybenzoic acid (0.55 g, 2.2 mmol), TBTU (0.7 g), DIEA (0.75 mL) in DMF (20 mL) and the reaction was left overnight. Then the mixture was poured into 10% sodium carbonate (100 mL) and extracted with ethyl acetate. The organic layer was washed with sodium carbonate, diluted HCl, water and brine, and dried over sodium sulphate. After evaporation the product was used for further reaction without purification.

Rt. 11.1 min [system 1], MS [M+1] 398.1.

### 4-(3,5-Di-t-butyl4-hydroxybenzamido)benzoic acid

The ester was hydrolyzed by refluxing ethyl 4-(3,5-di-t-butyl4-hydroxybenzamido)-benzoate (0.5 g, 1.2 mmol) in 10% NaOH solution (50 mL) and methanol (50 mL) for 2 h. The reaction solution was left at room temperature overnight, then concentrated, and acidified. The product was extracted with ethyl acetate. The organic layer was washed with water, brine and dried over sodium sulphate. After evaporation the product was purified using preparative HPLC.

Rt. 9.40 min [system 1]; MS [M+1] 369.9; 1H NMR (500 MHz, CD₃OD): d (ppm) 1.48 (s, 18H), 7.74 (d, J=8 Hz,2H), 7.76 (s, 2H), 7.98 (d, J=8.3 Hz, 2H).

### Compound (55) 4-(3,5-Diiodo-2-hydroxybenzamido)benzoic acid

### Ethyl 4-(3,5-diiodo-2-hydroxybenzamido)benzoate

Ethyl 4-aminobenzoate (0.5 g, 3 mmol) was added to a solution of 3,5-diiodo-2-hydroxybenzoic acid (900 mg, 2.3 mmol), TBTU (0.7 g), DIEA (0.75 mL) in DMF (20 mL) and the reaction was left overnight. Then the mixture was poured into 10% sodium carbonate (100 mL) and extracted with ethyl acetate. The organic layer was washed with sodium carbonate, diluted HCl water and brine, and dried over sodium sulphate. After evaporation the product was used for further reaction without purification.

Rt. 12.07 min [system 1], MS [M+1] 537.6.

### 4-(3,5-Diiodo-2-hydroxybenzamido)benzoic acid

The ester was hydrolyzed by refluxing ethyl 4-(3,5-diiodo-2-hydroxybenzamido)-benzoate (650 mg, 1.2 mmol) in 10% NaOH solution (50 mL) and methanol (50 mL) for 2 h. The reaction solution was left at room temperature overnight, then concentrated, and acidified. The product was extracted with ethyl acetate. The organic layer was washed with water, brine and dried over sodium sulphate. After evaporation the product was purified using preparative HPLC.

Rt. 10.25 min [system 1]; MS [M+1] 509.6; 1H NMR (500 MHz, CD₃OD): d (ppm) 3.38 (s, —OH), 7.85 (d, J=8.6 Hz, 2H), 8.00 (bs, —NH), 8.06 (d, J=8.8 Hz, 2H), 8.25 (d, J=1.42 Hz, 1H), 8.34 (d, J=1.72 Hz, 1H), 11.00 (bs, —COOH).

### Compound (56) N-Benzoyl-tyrosyl-4-aminobenzoic acid was Purchased from Sigma.

### Compound (57) 4-(Benzylsulfonamido)benzoic acid was Purchased from Sigma.

### Compound (58) 4-Guanidinobenzoic acid was Purchased from Sigma.

### Compound (59) 4-Aminobenzoic acid was Purchased from Lancaster.

### Compound (60) 4-Amino-5-chloro-2-methoxybenzoic acid was Purchased from Aldrich.

### Compound (61) N-(4-Amino-5-chloro-2-methoxybenzoyl)qlutamic acid

This compound was synthesized based on solid phase synthesis. Fmoc-L-Glu(OtBu)-Wang resin (150 mg; 0.1 mmol) was swelled in DM.F and washed with DMF. Fmoc group was removed with 20% piperidine/DMF (15 min, twice). After washing with DMF (4 times), 4-amino-5-chloro-2-methoxybenzoic acid (80 mg; 4 eq.), TBTU (128 mg), HOBT (60 mg) and DIEA (103 mg) in DMF (10 ml) were added to the resin and were mixed for 16 h. Then the resin was washed with DMF (3 times) and DCM (3 times) and dried in vacuo. The product was cleaved from the resin with TFA (92.5%), water (5%) and triisopropylsilane (2.5%) at room temperature for 2 h and purified using preparative HPLC.

Rt. 4.27 min [system 1]; MS [M+1] 331.1; 1H NMR (500 MHz, CD₃OD): d (ppm) 2.26 (m, J=6 Hz, 2H), 2.37 (m, J=7.4 Hz, 2H), 4.62 (q, J=6 Hz, 1H), 5.00 (bs, —NH₂), 6.52 (s, 1H), 7.8 (s, 1H), 11.00 (bs, —COOH).

### Compound (62) Ethyl 4-aminosalicylate

4-Aminosalicylic acid (300 mg, 2 mmol) was dissolved in ethyl alcohol (50 mL) in the presence of sulphuric acid (0.5 mL) and gently refluxed at the boiling point temperature overnight. Alcohol was evaporated in vacuo. The residue was poured into 10% sodium carbonate and extracted with ethyl acetate. The organic layer was washed with 10% sodium carbonate, water and brine, and dried over sodium sulphate. The solution was evaporated and the product was purified using preparative HPLC.

Rt. 6.78 min [system 1]; MS [M+1] 182.2; 1H NMR (500 MHz, CD₃OD): d (ppm) 1.34 (t, J=7 Hz, 3H), 4.29 (q, J=7.2 Hz, 2H), 6.10 (s, 1H), 6.14 (dd, J=1.75 Hz, J=6.65 Hz, J=1.97 Hz,1H), 7.52 (d, J=8.82 Hz,1H)

### Compound (63) (2-Diethylamino)-ethyl-4-aminosalicylate was Purchased from Aldrich.

### Compound (64) N-(2-Diethylaminoethyl)-4-aminosalicylamide

4-Aminosalicylic acid (500 mg; 3.3 mmol) was dissolved in DMF (5 mL). 2-Diethylaminoethylamine (469 μL: 3.3 mmol), TBTU (1.1 g), HOBT (0.5 g) and DIEA (570 μL) were added and the mixture was left at room temperature for 12 h. The mixture was poured into 10% sodium bicarbonate and extracted with ethyl acetate. The organic layer was washed with 10% sodium bicarbonate and brine, and dried over sodium sulphate. After evaporation, the residue was purified using preparative HPLC and transformed into hydrochloride salt.

Rt. 2.99 min [system 1]; MS [M+1] 252.3; 1H NMR (500 MHz, CD₃OD): d (ppm) 1.34 (t, J=7.3 Hz, 6H), 3.31 (m, J=6.8 Hz, 4H), 3.39 (m, J=6.2 Hz, 2H), 3.97 (t, 6.3 Hz, 2H), 4.00 (bs, —NH₂), 6.9 (d, J=8.6 Hz, 1H), 6.94 (s, 1H), 7.99 (d, J=8 Hz, 1H).

### Compound (65) N-(4-Amino-2-hydroxybenzoyl)-L-glutamic acid

This compound was synthesized based on solid phase synthesis. Fmoc-L-Glu(OtBu)-Wang resin (460 mg; 0.3 mmol) was swelled in DMF and washed with DMF. Fmoc group was removed with 20% piperidine/DMF (15 min, twice). After washing with DMF (4 times), 4-aminosalicylic acid (180mg, 4eq.), TBTU (384 mg), HOBT (180 mg) and DIEA (310 mg) in DMF (10 ml) were added to the resin and were mixed for 16 h. Then the resin was washed with DMF (3 times) and DCM (3 times) and dried in vacuo. The product was cleaved from the resin with TFA (92.5%), water (5%) and triisopropylsilane (2.5%) at room temperature for 2 h and purified using preparative HPLC.

Rt. 3.10 min [system 1]; MS [M+1] 283.2; 1H NMR (500 MHz, CD₃OD): d (ppm) 2.26 (m, J=6.55 Hz, 2H), 2.44 (t, J=6.7 Hz, 2H), 4.6 (q, J=4.9 Hz, 1H), 6.15 (s, 1H), 6.23 (d, J=8 Hz,1H), 7.55 (d, J=8.5 Hz,1H).

### Compound (66) Ethyl 4-(methylamino)benzoate

4-(Methylamino)-benzoic acid (300 mg, 2 mmol) was dissolved in ethyl alcohol (50 mL) in the presence of sulphuric acid (0.5 mL) and gently refluxed at the boiling point temperature overnight. The alcohol was evaporated in vacuo. The residue was poured into 10% sodium carbonate and extracted with ethyl acetate. The organic layer was washed with 10% sodium carbonate, water and brine, and dried over sodium sulphate. The solution was evaporated to dryness. The resulting material was purified using preparative HPLC.

Rt. 6.90 min [system 1]; MS [M+1] 180.0; 1H NMR (500 MHz, CD₃OD): d (ppm) 1.33 (t, J=7.18 Hz, 3H), 2.81 (s, 3H), 4.25 (q, J=7 Hz, 2H), 6.55 (d, J=8.27 Hz, 2H), 7.77 (d, J=8.56 Hz, 2H).

### Compound (67) (2-Diethylamino)ethyl 4-(methylamino)benzoate

4-(Methylamino)-benzoic acid (300 mg, 2 mmol) was dissolved in toluene (20 mL) containing N,N-diethylaminoethanol (400 μL; 30 mmol) and sulphuric acid (3 mL). The mixture was gently heated with stirring on water bath for 1 h and left overnight at room temperature. Then it was poured into 10% sodium carbonate. After the organic layer was separated, the water layer was additionally extracted with ethyl acetate. The combined organic layers were washed with 10% sodium carbonate, water and brine, and dried over sodium sulphate. After evaporation of the solvent, the product was purified using preparative HPLC.

Rt. 4.14 min [system 1]; MS [M+1] 151.5; 1H NMR (500 MHz, (CD₃)₂O): d (ppm) 1.38 (t, J=6.8 Hz, 6H), 3.30 (s, 3H), 3.41 (q, J=4 Hz, 4H), 3.64 (t, J=4 Hz, 2H), 4.65 (t, J=4.5 Hz, 2H), 6.61 (d, J=7.9 Hz, 2H), 7.82 (d, J=9 Hz, 2H).

### Compound (68) N-(2-Diethylaminoethyl)4-(methylamino)benzamide

4-(N-methylamino)benzoic acid (73 mg: 0.48 mmol) was dissolved in DMF (3 mL). 2-Diethylaminoethylamine (46 mg: 0.4 mmol), TBTU (160 mg), HOBT (75 mg) and DIEA (90 μl) were added and the mixture was left at room temperature for 12 h. The mixture was poured into 10% sodium carbonate and extracted with ethyl acetate. The organic layer was washed with 10% sodium carbonate and brine, and dried over sodium sulphate. After evaporation, the residue was purified by preparative HPLC and transformed into hydrochloride salt.

Rt. 3.09 min [system 1], MS [M+1] 250.3; 1H NMR (500 MHz, CD₃OD): d (ppm) 1.35 (t, J=7.3 Hz, 6H), 3.06 (s, 3H), 3.31 (m, J=6.8 Hz, 4H), 3.39 (m, J=6.2 Hz, 2H), 3.76 (t, 6.3 Hz, 2H), 7.41 (d, J=8.45 Hz, 2H), 8.019 (d, J=8.29 Hz, 2H).

### Compound (69) N-(4-methylaminobenzoyl)-glutamic acid

This compound was synthesized based on solid phase synthesis. Fmoc-L-Glu(OtBu)-Wang resin (460 mg; 0.3 mmol) was swelled in DMF and washed with DMF. Fmoc group was removed with 20% piperidine/DMF (15 min, twice). After washing with DMF (4 times), 4-methylaminobenzoic acid (180mg, 4eq.), TBTU (384 mg), HOBT (180 mg) and DIEA (310 mg) in DMF (10 ml) were added to the resin and were mixed for 16 h. Then the resin was washed with DMF (3 times) and DCM (3 times) and dried in vacuo. The product was cleaved from the resin with TFA (92.5%), water (5%) and triisopropylsilane (2.5%) at room temperature for 2 h and purified using preparative HPLC.

Rt. 2.84 min [system 1]; MS [M+1] 281.0; 1H NMR (500 MHz, CD₃OD): d (ppm) 2.05 (m, J=6.55 Hz, 2H), 2.46 (t, J=6.7 Hz, 2H), 2.86 (s, 3H), 4.59 (q, J=4.9 Hz, 1H), 6.73 (d, 8.36 Hz, 2H), 7.73 (d, J=8.67 Hz, 2H).

### Compound (70) Ethyl 4-acetamidobenzoate

Benzocaine [compound (1)] (0.5 g, 3 mmol) was dissolved in DMF (10 mL), and acetic anhydride (3.0 g, 25 mmol) was added. The reaction mixture was left overnight, then poured into water, neutralized and extracted with ethyl acetate. The combined organic layer was washed with 10% sodium carbonate, water and brine, and dried over sodium sulphate. The solution was evaporated to dryness and the resulting residue was purified using preparative HPLC.

Rt. 6.17 min [system 1]; MS [M+1] 208.5; 1H NMR (500 MHz, CD₃OD): d (ppm) 1.36 (t, J=7.16 Hz, 3H), 2.15 (s, 3H), 4.33 (q, J=7 Hz, 2H), 7.66 (d, J=8.67 Hz, 2H), 7.95 (d, J=8.75 Hz, 2H).

### Compound (71) (2-Diethylamino)ethyl 4-acetamidobenzoate

Procaine [compound (3)] (400 mg, 1.7 mmol) was dissolved in DMF (10 mL), and acetic anhydride (3.0 g, 25 mmol) was added to the solution. The mixture was left overnight, then poured into water, alkalized with solid sodium carbonate and extracted with ethyl acetate. The combined organic layer was washed with 10% sodium carbonate, water and brine, and dried over sodium sulphate. The solution was evaporated to dryness and the resulting residue was purified using preparative HPLC.

Rt. 3.84 min [system 1]; MS [M+1] 279.1; 1H NMR (500 MHz, CD₃OD): d (ppm)?1.38 (t, J=6.7 Hz, 6H), 3.30 (s, 3H), 3.41 (q, J=4 Hz, 4H), 3.64 (t, J=4 Hz, 2H), 4.65 (t,J=4.5 Hz, 2H), 7.71 (d, J=8.03 Hz, 2H), 8.018 (d, J=7.57 Hz, 2H).

### Compound (72) N-Acetylprocainamide was Purchased from Sigma.

### Compound (73) N-(4-acetamidobenzoyl)-L-glutamic acid

This compound was synthesized based on solid phase synthesis. Fmoc-L-Glu(OtBu)-Wang resin (150 mg; 0.1 mmol) was swelled in DMF and washed with DMF. Fmoc group was removed with 20% piperidine/DMF (15 min, twice). After washing with DMF (4 times), 4-acetamidobenzoic acid (72 mg, 4eq.), TBTU (128 mg), HOBT (60 mg) and DIEA (103 mg) in DMF (10 mL) were added to the resin and were mixed for 16 h. Then the resin was washed with DMF (3 times) and DCM (3 times) and dried in vacuo. The product was cleaved from the resin with TFA (92.5%), water (5%) and triisopropylsilane (2.5%) at room temperature for 2 h and purified using preparative HPLC.

Rt. 3.46 min [system 1]; MS [M+1] 309.2; 1H NMR (500 MHz, CD₃OD): d (ppm) 2.10 (m, J=6.55 Hz, 2H), 2.15 (s, 3H), 2.46 (t, J=6.7 Hz, 2H), 4.6 (q, J=4.3 Hz, 1H), 7.66 (d, J=8.5 Hz, 2H), 7.82 (d, J=8.5 Hz, 2H).

### Compound (74) 4-(Methylamino)-5-chloro-2-methoxybenzoic acid

### 4-(Tosylamido)salicylic acid [compound (124)]

4-Aminosalicylic acid (10 g, 65 mmol) was dissolved in water (50 mL), containing NaOH (6 g) and sodium carbonate (0.7 g). The mixture was heated to 80° C. and tosyl chloride (14.7 g, 78 mmol) was added after 30 min at 80° C. The mixture was left at room temperature for 1 h and then acidified with concentrated HCl. The precipitate was used for further reactions without purification.

Rt. 7.41 min [system 1], MS [M+1] 307.9.

### 2-Methoxy-4-(N-methyl-N-tosylamido)benzoic acid [compound (125)]

4-(Tosylamido)salicylic acid (5 g, 16 mmol) was dissolved in acetone (50 mL) containing finely grounded NaOH (3.5 g). After mixing, dimethylsulphate (4.5 mL, 48 mmol) was added and the reaction solution was refluxed for 2 h. Then water (1 mL) was added and the reaction was left overnight at room temperature. The mixture was evaporated, dissolved in water, washed with ethyl acetate and acidified. The product was extracted with ethyl acetate, washed with water and brine, and dried over sodium sulphate. After evaporation the product was used for further reactions without purification.

Rt. 7.66 min [system 1], MS [M+1] 336.2.

### Ethyl 2-methoxy-4-(N-methyl-N-tosylamido)benzoate

2-Methoxy4-(N-methyl-N-tosylamido)benzoic acid (0.67 g, 2 mmol) was dissolved in ethyl alcohol (50 mL) in the presence of sulphuric acid (0.5 mL) and gently refluxed at the boiling point temperature overnight. Alcohol was evaporated in vacuo. The residue was poured into 10% sodium carbonate and extracted with ethyl acetate. The organic layer was washed with 10% sodium carbonate, water and brine, and dried over sodium sulphate. The solution was evaporated and the product was used for further reaction.

Rt. 9.32 min [system 1]; MS [M+1] 364.2.

### Ethyl 5-chloro-2-methoxy-4-(N-methyl-N-tosylamido)benzoate

Ethyl 2-methoxy-4-(N-methyl-N-tosylamido) benzoate (0.25 g, 0.7 mmol) was dissolved in acetonitrile (50 mL). The solution was heated to boiling point and N-chlorosuccinimide (230 mg, 1.7 mmol) was added gradually. The mixture was refluxed for 2 h and left overnight at room temperature. Acetonitrile was evaporated in vacuo and the solid residue was dissolved in methylene chloride, washed with 5% NaOH, water and brine and dried over sodium sulphate. The product was obtained after evaporation of the solvent and used for further reactions without purification.

Rt. 9.83 min [system 1], MS [M+1] 398.0.

### Ethyl 5-chloro-2-methoxy-4-(methylamino)benzoate

Ethyl 5-chloro-2-methoxy4-(N-methyl-N-tosylamido)benzoate (200 mg, 0.49 mmol) was dissolved in dichloromethane (400 μL) and added to cold concentrated sulphuric acid (5 mL). The solution was stirred vigorously and poured over ice after 5 min. The solution was alkalized with solid sodium carbonate on ice bath and extracted with ethyl acetate. The combined organic phases were washed with water, brine and dried over sodium sulphate. After evaporation the product was purified using preparative HPLC.

Rt 8.01 min [system 1], MS [M+1] 244.2.

### 5-Chloro-2-methoxy-4-(methylamino)benzoic acid

Ethyl 5-chloro-2-methoxy-4-(methylamino)benzoate (0.11 g, 0.45 mmol) was dissolved in methanol (50 mL) and 10% solution of sodium hydroxide (50 mL). The mixture was refluxed for 2 h, concentrated, acidified and extracted with ethyl acetate. The organic phase was washed with water, brine and dried over sodium sulphate. The product was purified using preparative HPLC.

Rt. 5.85 min [system 1]; MS [M+1] 216.1; 1H NMR (500 MHz, CD₃OD): d ppm) 1.32 (t, J=7 Hz, 3H), 2.93 (s, 3H), 3.88 (s, 3H), 4.23 (q, J=7.2 Hz, 2H), 6.22 (s, 1H), 7.72 (s, 1H).

### Compound (75) Ethyl 5-chloro-2-methoxy-4-(methylamino)benzoate

### 4-(Tosylamido)salicylic acid

4-Aminosalicylic acid (10 g, 65 mmol) was dissolved in water (50 mL), containing NaOH (6 g) and sodium carbonate (0.7 g). The mixture was heated to 80° C. and tosyl chloride (14.7 g, 78 mmol) was added after 30 min at 80° C. The mixture was left at room temperature for 1 h and then acidified with concentrated HCl. The precipitate was used for further reactions without purification.

Rt. 7.41 min [system 1], MS [M+1] 307.9.

### 2-Methoxy-4-(N-methyl-N-tosylamido)benzoic acid

4-(Tosylamido)salicylic acid (5 g, 16 mmol) was dissolved in acetone (50 mL) containing finely grounded NaOH (3.5 g). After mixing, dimethylsulphate (4.5 mL, 48 mmol) was added and the reaction solution was refluxed for 2 h. Then water (1 mL) was added and the reaction was left overnight at room temperature. The mixture was evaporated, dissolved in water, washed with ethyl acetate and acidified. The product was extracted with ethyl acetate, washed with water and brine, and dried over sodium sulphate. After evaporation the product was used for further reactions without purification.

Rt. 7.66 min [system 1], MS [M+1] 336.2.

### Ethyl 2-methoxy-4-(N-methyl-N-tosylamido)benzoate

2-Methoxy-4-(N-methyl-N-tosylamido) benzoic acid (0.67 g, 2 mmol) was dissolved in ethyl alcohol (50 mL) in the presence of sulphuric acid (0.5 mL) and gently refluxed at the boiling point temperature overnight. Alcohol was evaporated in vacuo. The residue was poured into 10% sodium carbonate and extracted with ethyl acetate. The organic layer was washed with 10% sodium carbonate, water and brine, and dried over sodium sulphate. The solution was evaporated and the product was used for further reaction.

Rt. 9.32 min [system 1]; MS [M+1] 364.2.

### Ethyl 5-chloro-2-methoxy-4-(N-methyl-N-tosylamido)benzoate

Ethyl 2-methoxy-4-(N-methyl-N-tosylamido) benzoate (0.25 g, 0.7 mmol) was dissolved in acetonitrile (50 mL). The solution was heated to boiling point and N-chlorosuccinimide (230 mg, 1.7 mmol) was added gradually. The mixture was refluxed for 2 h and left overnight at room temperature. Acetonitrile was evaporated in vacuo and the solid residue was dissolved in methylene chloride, washed with 5% NaOH, water and brine and dried over sodium sulphate. The product was obtained after evaporation of the solvent and used for further reactions without purification. Rt. 9.83 min [system 1], MS [M+1] 398.0.

### Ethyl 5-chloro-2-methoxy-4-(methylamino)benzoate

Ethyl 5-chloro-2-methoxy-4-(N-methyl-N-tosylamido) benzoate (200 mg, 0.49 mmol) was dissolved in dichloromethane (400 μL) and added to cold concentrated sulphuric acid (5 mL). The solution was stirred vigorously and poured over ice after 5 min. The solution was alkalized with solid sodium carbonate on ice bath and extracted with ethyl acetate. The combined organic phases were washed with water, brine and dried over sodium sulphate. After evaporation the product was purified using preparative HPLC.

Rt 8.01 min [system 1], MS [M+1] 244.2. 1H NMR (500 MHz, CD₃OD): d ppm) 1.32 (t, J=7 Hz, 3H), 2.93 (s, 3H), 3.88 (s, 3H), 4.23 (q, J=7.2 Hz, 2H), 6.22 (s, 1H), 7.72 (s, 1H)

### Compound (76) 2-Diethylaminoethyl-5-chloro-2-methoxy-4-(methylamino)-benzoate

### 4-(Tosylamido)salicylic acid

4-Aminosalicylic acid (10 g, 65 mmol) was dissolved in water (50 mL), containing NaOH (6 g) and sodium carbonate (0.7 g). The mixture was heated to 80° C. and tosyl chloride (14.7 g, 78 mmol) was added after 30 min at 80° C. The mixture was left at room temperature for 1 h and then acidified with concentrated HCl. The precipitate was used for further reactions without purification.

Rt. 7.41 min [system 1], MS [M+1] 307.9.

### 2-Methoxy-4-(N-methyl-N-tosylamido)benzoic acid

4-(Tosylamido)salicylic acid (5 g, 16 mmol) was dissolved in acetone (50 mL) containing finely grounded NaOH (3.5 g). After mixing, dimethylsulphate (4.5 mL, 48 mmol) was added and the reaction solution was refluxed for 2 h. Then water (1 mL) was added and the reaction was left overnight at room temperature. The mixture was evaporated, dissolved in water, washed with ethyl acetate and acidified. The product was extracted with ethyl acetate, washed with water and brine, and dried over sodium sulphate. After evaporation the product was used for further reactions without purification.

Rt. 7.66 min [system 1], MS [M+1] 336.2.

### (2-Diethylamino)ethyl 2-methoxy-4-(N-methyl-N-tosylamido)benzoate

2-Methoxy4-(N-methyl-N-tosylamido)benzoic acid (500 mg, 1.5 mmol) was dissolved in 0.5 M DCC/CH₂Cl₂ (10 mL), and HOBt (100 mg), DMAP (30 mg) and 2-diethylamino)ethanol (300 μL) were added to the solution. The mixture was left for 24 h, then dicyclohexylurea was filtered off, dichloromethane was evaporated and the product was dissolved in ethyl acetate, washed with 10% sodium carbonate, water, brine and dried over sodium sulphate. After evaporation the product was used for further reaction.

Rt. 6.47 min [system 1], MS [M+1] 435.2.

### (2-Diethylamino)ethyl 5-chloro-2-methoxy-4-N-methyl-N-tosylamido)benzoate

(2-Diethylamino)ethyl 2-methoxy-4-(N-methyl-N-tosylamido) benzoate (300 mg, 0.7 mmol) was dissolved in acetonitrile (50 mL). The solution was heated to the boiling point and N-chlorosuccinimide (230 mg, 1.7 mmol) was added gradually. The mixture was refluxed for 2 h and left overnight at room temperature. Acetonitrile was evaporated in vacuo and the solid residue was dissolved in methylene chloride, washed with 5% NaOH, water and brine, and dried over sodium sulphate. The product was obtained after evaporation of the solvent, and used for further reactions without purification.

Rt. 6.87 min [system 1], MS [M+1] 469.3.

### (2-Diethylamino)ethyl 5-chloro-2-methoxy-4-(methylamino)benzoate

(2-Diethylamino)ethyl 5-chloro-2-methoxy-4-(N-methyl-N-tosylamido)benzoate (230mg, 0.5 mmol) was dissolved in dichloromethane (400 μL) and added to cold concentrated sulphuric acid (5 mL). The solution was stirred vigorously and poured over ice after 5 min. The solution was alkalized with solid sodium carbonate on ice bath and the product was extracted with ethyl acetate. The combined organic phases were washed with water, brine and dried over sodium sulphate. After evaporation of the solvent, the product was purified using preparative HPLC.

Rt. 5.30 min [system 1]; MS [M+1] 315.3; 1H NMR (500 MHz, CD₃OD): d (ppm)?1.36 (t, J=7.5 Hz, 6H), 2.97 (s, 3H), 3.55 (q, J=4 Hz, 4H), 3.93 (s, 3H), 4.56 (t, J=4.5 Hz, 2H), 6.27 (s, 1H), 7.85 (s, 1H).

### Compound (77) N-(2-Diethylamino)ethyl4-(methylamino)-5-chloro-2-methoxybenzamide hydrochloride

### 4-(Tosylamido)salicylic acid

4-Aminosalicylic acid (10 g, 65 mmol) was dissolved in water (50 mL), containing NaOH (6 g) and sodium carbonate (0.7 g). The mixture was heated to 80° C. and tosyl chloride (14.7 g, 78 mmol) was added after 30 min at 80° C. The mixture was left at room temperature for 1 h and then acidified with concentrated HCl. The precipitate was used for further reactions without purification.

Rt: 7.41 min [system 1], MS [M+1] 307.9.

### 2-Methoxy-4-(N-methyl-N-tosylamido)benzoic acid

4-(Tosylamido)salicylic acid (5 g, 16 mmol) was dissolved in acetone (50 mL) containing finely grounded NaOH (3.5 g). After mixing, dimethylsulphate (4.5 mL, 48 mmol) was added and the reaction solution was refluxed for 2 h. Then water (1 mL) was added and the reaction was left overnight at room temperature. The mixture was evaporated, dissolved in water, washed with ethyl acetate and acidified. The product was extracted with ethyl acetate, washed with water and brine, and dried over sodium sulphate. After evaporation the product was used for further reactions without purification.

Rt. 7.66 min [system 1], MS [M+1] 336.2.

### 2-Diethylamino)ethyl 2-methoxy-4-(N-methyl-N-tosylamido)benzamide

2-Methoxy-4-(N-methyl-N-tosylamido) benzoic acid (500 mg, 1.5 mmol) was dissolved in 0.5 M DCC/CH₂Cl₂ (10 mL), and HOBt (100 mg), DMAP (30 mg) and 2-diethylamino)ethylamine (300 μL) were added to the solution. The mixture was left for 24 h, then dicyclohexylurea was filtered off, dichloromethane was evaporated and the product was dissolved in ethyl acetate, washed with 10% sodium carbonate, water, brine and dried over sodium sulphate. After evaporation the oil was used for further reaction.

Rt 6.34 min [system 1], MS [M+1] 434.1

### 2-Diethylamino)ethyl 5-chloro-2-methoxy-4-(N-methyl-N-tosylamido)benzamide

(2-Diethylamino)-ethyl 2-methoxy-4-(N-methyl-N-tosylamido) benzamide (300 mg, 0.7 mmol) was dissolved in 50 mL acetonitrile. The solution was heated to the boiling point and N-chlorosuccinimide (230 mg, 1.7 mmol) was added gradually. The mixture was refluxed for 2 h and left overnight at room temperature. Acetonitrile was evaporated in vacuo and the solid residue was dissolved in methylene chloride, washed with 5% NaOH, water and brine, and dried over sodium sulphate. The oily product was obtained after evaporation of the solvent, and used for further reactions without purification.

Rt. 6.80 min [system 1], MS [M+1] 468.2.

### N-(2-Diethylamino)ethyl 4-(methylamino)5-chloro-2-methoxybenzamide

(2-Diethylamino)-ethyl 5-chloro-2-methoxy-4-(N-methyl-N-tosylamido) benzamide (230 mg, 0.5 mmol) was dissolved in dichloromethane (400 μL) and added to cold concentrated sulphuric acid (5 mL). The solution was stirred vigorously and poured over ice after 5 min. The solution was alkalized with solid sodium carbonate on ice bath and the product was extracted with ethyl acetate. The combined organic phases were washed with water, brine and dried over sodium sulphate. After evaporation of the solvent, the product was purified using preparative HPLC and was transformed into hydrochloride salt.

Rt. 5.29 min; MS [M+1] 468.2; 1H NMR (500 MHz, CD₃OD): d (ppm)?1.34 (t, J=7.3 Hz, 6H), 2.95 (s, 3H), 3.32 (m, J=6.8 Hz, 4H), 3.35 (m, J=6.2 Hz, 2H), 3.74 (t,J=6.3 Hz, 2H), 4.02 (t, 6.3 Hz, 3H), 6.28 (s, 1H), 7.88 (s, 1H).

### Compound (78) N-(-4-(methylamino)-5-chloro-2-methoxybenzoyl)-L-glutamic acid

### 4-(Tosylamido)salicylic acid

4-Aminosalicylic acid (10 g, 65 mmol) was dissolved in water (50 mL), containing NaOH (6 g) and sodium carbonate (0.7 g). The mixture was heated to 80° C. and tosyl chloride (14.7 g, 78 mmol) was added after 30 min at 80° C. The mixture was left at room temperature for 1 h and then acidified with concentrated HCl. The precipitate was used for further reactions without purification.

Rt. 7.41 min [system 1], MS [M+1] 307.9.

### 2-Methoxy4-(N-methyl-N-tosylamido) benzoic acid

4-(Tosylamido)salicylic acid (5 g, 16 mmol) was dissolved in acetone (50 mL) containing finely grounded NaOH (3.5 g). After mixing, dimethylsulphate (4.5 mL, 48 mmol) was added and the reaction solution was refluxed for 2 h. Then water (1 mL) was added and the reaction was left overnight at room temperature. The mixture was evaporated, dissolved in water, washed with ethyl acetate and acidified. The product was extracted with ethyl acetate, washed with water and brine, and dried over sodium sulphate. After evaporation the product was used for further reactions without purification.

Rt. 7.66 min [system 1], MS [M+1] 336.2.

### Di-tert-butyl N-(2-methoxy-4-(N-methyl-N-tosylamido) benzoyl)-L-glutamate

2-Methoxy-4-(N-methyl-N-tosylamido) benzoic acid (500 mg, 1.5 mmol) was dissolved in DMF (20 mL), and di-tert-butyl-glutamate hydrochloride (500 mg, 1.9 mmol), TBTU (480 mg), HOBt (200 mg) and DIEA (200 μL) were added. The mixture was left overnight, and then was poured into 10% solution of sodium carbonate. The product was extracted with ethyl acetate. Organic phase was washed with 10% sodium carbonate, water, hydrogen potassium sulphate solution, water and brine, and dried over sodium sulphate. After evaporation, the product was used for further reactions without purification.

Rt. 11.19 min [system 1], MS [M+1] 577.3.

### Di-tert-butyl N-(5-chloro-2-methoxy4-(N-methyl-N-tosylamido) benzoyl)-L-glutamate [compound (126)]

Di-tert-butyl N-(2-methoxy-4-(N-methyl-N-tosylamido) benzoyl)-L-glutamate (400 mg, 0.7 mmol) was dissolved in acetonitrile (50 mL). The solution was heated to the boiling point and N-chlorosuccinimide (230 mg, 1.7 mmol) was added gradually. The mixture was refluxed for 2 h and left overnight at room temperature. Acetonitrile was evaporated in vacuo and the solid residue was dissolved in methylene chloride, washed with 5% NaOH, water and brine, and dried over sodium sulphate. The product was obtained after evaporation of the solvent, and used for further reactions without purification.

Rt. 11.51 min [system 1], MS [M+1] 611.5.

### N-(5-chloro-2-methoxy4-(methylamino)benzoyl)-L-glutamic acid

Di-tert-butyl N-(5-chloro-2-methoxy4-(N-methyl-N-tosylamido) benzoyl)-L-glutamate (150 mg, 0.24 mmol) was dissolved in concentrated sulphuric acid (10 mL) and poured over ice after 5 min. The pH was adjusted to 3-4 using solid sodium carbonate, and the product was extracted with ethyl acetate. The organic phase was washed with water, brine and dried. The product was purified using preparative HPLC.

Rt. 5.60 min [system 1]; MS [M+1] 345.2; 1H NMR (500 MHz, CD₃OD): d (ppm)?2.05 (m, J=6.55 Hz, 2H), 2.38 (m, J=6.7 Hz, 2H), 2,93 (s, 3H), 4.03 (s, 3H), 4.6 (t, J=5.4 Hz, 1 H), 6.27 (s,1H), 7.84 (s, 1H).

### Compound (79) 4-Acetamido-5-chloro-2-methoxybenzoic acid

5-Chloro-2-methoxybenzoic acid (200 mg, 1.0 mmol) was dissolved in 5 mL acetyl anhydride and 4-dimethylaminopyridine (100 mg) was added as a catalyst. The mixture was refluxed for 24 h. The mixture was then neutralized with 10% sodium carbonate and acidified to pH 4 with 1N HCl. The product was extracted with ethyl acetate. The organic layer was washed with 10% sodium carbonate and brine, and dried over sodium sulphate. After evaporation, the residue was purified using preparative HPLC.

Rt. 4.60 min [system 1]; MS [M+1] 244.1; 1H NMR (500 MHz, CD₃OD): d (ppm) 2.23 (s, 3H), 3.89 (s, 3H), 7.84 (s, 1H), 7.92 (s, 1H).

### Compound (80) Ethyl 4-acetamido-5-chloro-2-methoxybenzoate

Ethyl 4-amino-5-chloro-2-methoxybenzoate [compound (13)] (690 mg, 3 mmol) was dissolved in DMF (10 mL), and acetic anhydride (3 mL) was added. The reaction mixture was left overnight, then poured into water, neutralized and extracted with ethyl acetate. The combined organic layer was washed with 10% sodium carbonate, water and brine, and dried over sodium sulphate. The solution was evaporated to dryness and the product was purified using preparative HPLC.

Rt. 6.72 min [system 1]; MS [M+1] 272.0; 1H NMR (500 MHz, CD₃OD): d (ppm) 1.34 (t, J=7 Hz, 3H), 2.23 (s, 3H), 3.86 (s, 3H), 4.29 (q, J=7.2 Hz, 2H), 7.81 (s, 1H), 7.93 (s, 1H).

### Compound (81) (2-Diethylamino)ethyl 4-acetamido-5-chloro-2-methoxybenzoate

(2-Diethylamino)ethyl 4-amino-5-chloro-2-methoxybenzoate [compound (15)] (510 mg, 1.7 mmol) was dissolved in DMF (10 mL), and acetic anhydride (3 mL) was added to the solution. The mixture was left overnight, then poured into water, alkalized with solid sodium carbonate and extracted three times with ethyl acetate. The combined organic layer was washed with 10% sodium carbonate, water and brine, and dried over sodium sulphate. The solution was evaporated to dryness and the resulting residue was purified using preparative HPLC.

Rt. 4.32 min [system 1]; MS [M+1] 279.3; 1H NMR (500 MHz, CD₃OD): d (ppm) 1.34 (t, J=6.8 Hz, 6H), 2.24 (s, 3H), 3.37 (q, J=4 Hz, 4H), 3.61 (t, J=4 Hz, 2H), 3.88 (s, 3H), 4.61 (t, J=4.5 Hz, 2H), 7.94 (s, 1H), 7.99 (s, 1H).

### Compound (82) N-(2-Diethylamino)ethyl-4-acetamido-5-chloro-2-methoxybenzamide hydrochloride

4-Acetamido-5-chloro-2-methoxybenzoic acid [compound (79)] (160 mg; 0.657 mmol) was dissolved in DMF (3 mL). 2-Diethylaminoethylamine (68.7 mg: 590 mmol), TBTU (164 mg) and DIEA (128 mg) were added and the mixture was left at room temperature for 15 h. The mixture was poured into 1N sodium hydroxide and the product was extracted with ethyl acetate. The organic layer was washed with 10% sodium carbonate and brine and dried over sodium sulphate. After evaporation, the product was purified by preparative HPLC.

Rt. 4.20 min [system 1]; MS [M+1] 342.0; 1H NMR (500 MHz, CD₃OD): d (ppm) 1.35 (t, J=7.3 Hz, 6H), 2.24 (s, 3H), 3.31 (m, J=6.8 Hz, 4H), 3.38 (m, J=6.2 Hz, 2H), 3.78 (t, J=6.3 Hz, 2H), 3.99 (t, 6.3 Hz, 3H), 7.99 (s, 1H), 8.02 (s, 1H).

### Compound (83) N-(4-acetamido-5-chloro-2-methoxybenzoyl)-L-glutamic acid

This compound was synthesized based on solid phase synthesis. Fmoc-Glu-resin (150 mg; 0.1 mmol) was swelled in DMF and washed with DMF. Fmoc group was removed by 20% piperidine/DMF solution (15 min, twice). After washing with DMF (4 times), 4-acetamido-5-chloro-2-methoxybenzoic acid [compound (79)] (96 mg; 4 eq.), TBTU (128 mg), HOBT (60 mg) and DIEA (103 mg) in 10 mL DMF were added to the resin and mixed for 16 h. Then the resin was washed with DMF (3 times) and DCM (3 times) and dried in vacuo. The compound was cleaved from the resin with TFA (92.5%), water (5%) and triisopropylsilane (2.5%) at room temperature for 2 h. The product was purified using preparative HPLC.

Rt. 4.56 min [system 1]; MS [M+1] 373.1; 1H NMR (500 MHz, CD₃OD): d (ppm) 2.07 (m, J=6.55 Hz, 2H), 2.41 (m, J=6.7 Hz, 2H), 4.01 (s, 3H), 4.66 (q, J=4.9 Hz, 1H), 7.98 (s, 1H), 7.99 (s, 1H).

### Compound (84) 4-(Methylamino)salicylic acid

### Methyl 4-nitrosalicylate

4-Nitrosalicylic acid (10 g, 55 mmol) was dissolved in methanol (200 mL) in the presence of sulphuric acid (0.5 mL) and gently refluxed at the boiling point temperature overnight. Alcohol was evaporated in vacuo. The residue was poured into 10% sodium carbonate and extracted with ethyl acetate. The organic layer was washed with 10% sodium carbonate, water and brine, and dried over sodium sulphate. The product was used for further reactions without purification.

Rt. 8.02 min [system 1], MS [M+1] 198.1.

### Methyl 2-methoxymethyloxy4-nitrobenzoate [compound (127)]

Methyl 4-nitrosalicylate (4.0 g, 20 mmol) was dissolved in dichloromethane (50 mL) and DIEA (20 mL). Chloromethyl methyl ether (7.6 mL 100 mmol) was added and the mixture was stirred for 4 h. After evaporation in vacuo, the product was dissolved in water and extracted with ethyl acetate. The organic layer was washed with water and brine, and dried. After evaporation the product was used for further reaction without purification.

Rt. 7.60 min [system 1], MS [M+1] 242.0.

### 4-Amino-2-methoxymethyloxybenzoic acid

Methyl 2-methoxymethyloxy-4-nitrobenzoate (4.8 g, 20 mmol) was dissolved in ammonia (100 mL) and water (100 mL), and zinc powder (7 g) was gradually added. The mixture was left stirring overnight. After filtering off the solid residue, the product was concentrated, neutralized to pH 8 and extracted with ethyl acetate. The organic layer was washed with water and brine and dried over sodium sulphate. The product was used for further reaction without purification.

Rt. 4.36 min [system 1], MS [M+1] 197.9.

### 2-Methoxymethyloxy-4-(N-tosylamido)benzoic acid

4-Amino-2-methoxymethyloxy-benzoic acid (3.0 g, 15 mmol) was dissolved in 100 mL water, containing NaOH (6 g) and sodium carbonate (0.7 g). The mixture was heated to 80° C. and tosyl chloride (4.0 g, 21 mmol) was added after 30 min at 80° C. The mixture was left at room temperature for 1 h and then acidified with concentrated HCl. The precipitate was filtered and used for further reactions without purification.

Rt. 8.06 min [system 1], MS [M+1] 351.9.

### 2-Methoxymethyloxy-4-(N-methyl-N-tosylamido)benzoic acid

2-Methoxymethyloxy-4-(N-tosylamido) benzoic acid (1.5 g, 4.3 mmol) was dissolved in acetone (50 mL) containing finely ground NaOH (1.7 g). After mixing, dimethylsulphate (1.6 ml, 17 mmol) was added and the reaction was refluxed for 2 h. Then water (300 μL) was added and the reaction was left overnight at room temperature. The mixture was evaporated, dissolved in water, washed with ethyl acetate and acidified. The product was extracted with ethyl acetate, washed with water, brine and dried over sodium sulphate. The product was used for further synthesis without purification.

Rt. 7.91 min [system 1], MS [M+1] 366.0.

### 4-(Methylamino)salicylic acid

2-Methoxymethyloxy-4-(N-methyl-N-tosylamido)benzoic acid (200 mg, 0.55 mmol) was dissolved in concentrated sulphuric acid (10 mL) and poured over ice after 5 min. The pH was adjusted to 3-4 using solid sodium carbonate, and the solution was extracted with ethyl acetate. The organic phase was washed with water, brine and dried. The product was purified using preparative HPLC.

Rt. 4.75 min [system 1]; MS [M+1] 168.0; 1H NMR (500 MHz, CD₃OD): d (ppm) 2.71 (s, 3H), 5.99 (s, 1H), 6.09 (s, 1H), 7.53 (s, 1H).

### Compound (85) Ethyl 4-(methylamino)salicylate

### Methyl 4-nitrosalicylate

4-Nitrosalicylic acid (10 g, 55 mmol) was dissolved in methanol (200 mL) in the presence of sulphuric acid (0.5 mL) and gently refluxed at the boiling point temperature overnight. Alcohol was evaporated in vacuo. The residue was poured into 10% sodium carbonate and extracted with ethyl acetate. The organic layer was washed with 10% sodium carbonate, water and brine, and dried over sodium sulphate. The product was used for further reactions without purification.

Rt. 8.02 min [system 1], MS [M+1] 198.1.

### Methyl 2-methoxymethyloxy-4-nitrobenzoate

Methyl 4-nitrosalicylate (4.0 g, 20 mmol) was dissolved in dichloromethane (50 mL) and DIEA (20 mL). Chloromethyl methyl ether (7.6 mL 100 mmol) was added and the mixture was stirred for 4 h. After evaporation in vacuo, the product was dissolved in water and extracted with ethyl acetate. The organic layer was washed with water and brine, and dried. After evaporation the product was used for further reaction without purification.

Rt. 7.60 min [system 1], MS [M+1] 242.0.

### 4-Amino-2-methoxymethyloxybenzoic acid

Methyl 2-methoxymethyloxy-4-nitrobenzoate (4.8 g, 20 mmol) was dissolved in ammonia (100 mL) and water (100 mL), and zinc powder (7 g) was gradually added. The mixture was left stirring overnight. After filtering off the solid residue, the product was concentrated, neutralized to pH 8 and extracted with ethyl acetate. The organic layer was washed with water and brine and dried over sodium sulphate. The product was used for further reaction without purification.

Rt. 4.36 min [system 1], MS [M+1] 197.9.

### 2-Methoxymethyloxy-4-(N-tosylamido)benzoic acid

4-Amino-2-methoxymethyloxy-benzoic acid (3.0 g, 15 mmol) was dissolved in 100 mL water, containing NaOH (6 g) and sodium carbonate (0.7 g). The mixture was heated to 80° C. and tosyl chloride (4.0 g, 21 mmol) was added after 30 min at 80° C. The mixture was left at room temperature for 1 h and then acidified with concentrated HCl. The precipitate was filtered and used for further reactions without purification.

Rt. 8.06 min [system 1], MS [M+1] 351.9.

### 2-Methoxymethyloxy-4-(N-methyl-N-tosylamido)benzoic acid

2-Methoxymethyloxy-4-(N-tosylamido)benzoic acid (1.5 g, 4.3 mmol) was dissolved in acetone (50 mL) containing finely ground NaOH (1.7 g). After mixing, dimethylsulphate (1.6 ml, 17 mmol) was added and the reaction was refluxed for 2 h. Then water (300 μL) was added and the reaction was left overnight at room temperature. The mixture was evaporated, dissolved in water, washed with ethyl acetate and acidified. The product was extracted with ethyl acetate, washed with water, brine and dried over sodium sulphate. The product was used for further synthesis without purification.

Rt. 7.91 min [system 1], MS [M+1] 366.0.

### Ethyl 4-(N-methyl-N-tosylamido)salicylate

2-Methoxymethyloxy-4-(N-methyl-N-tosylamido)benzoic acid (730 mg, 2 mmol) was dissolved in ethyl alcohol (50 mL) in the presence of sulphuric acid (0.5 mL) and gently refluxed at the boiling point temperature overnight. Alcohol was evaporated in vacuo. The residue was poured into 10% sodium carbonate and extracted with ethyl acetate. The organic layer was washed with 10% sodium carbonate, water and brine, and dried over sodium sulphate. After evaporation of the solvent, the product was used for further reaction.

Rt. 8.12 min [system 1], MS [M+1] 350.0.

### Ethyl 4-(methylamino)salicylate

Ethyl 4-(N-methyl-N-tosylamido)salicylate (110 mg, 0.3 mmol) was dissolved in concentrated sulphuric acid (5 mL) and poured over ice after 5 min. The mixture was alkalized using solid sodium carbonate and the product was extracted with ethyl acetate. The organic phase was washed with water, brine and dried over sodium sulphate. After evaporation the product was purified using preparative HPLC. Rt. 8.05 min [system 1]; MS [M+1] 196.2; 1H NMR (500 MHz, CD₃OD): d (ppm) 1.34 (t, J=7 Hz, 3H), 2.78 (s, 3H), 4.29 (q, J=7.2 Hz, 2H), 5.96 (s, 1H), 6.11 (d, J=8.6 Hz, 1H), 7.53 (d, J=8.9 Hz, 1H).

### Compound (86) (2-diethylamino)ethyl 4-(methylamino)salicylate

### Methyl 4-nitrosalicylate

4-Nitrosalicylic acid (10 g, 55 mmol) was dissolved in methanol (200 mL) in the presence of sulphuric acid (0.5 mL) and gently refluxed at the boiling point temperature overnight. Alcohol was evaporated in vacuo. The residue was poured into 10% sodium carbonate and extracted with ethyl acetate. The organic layer was washed with 10% sodium carbonate, water and brine, and dried over sodium sulphate. The product was used for further reactions without purification.

Rt. 8.02 min [system 1], MS [M+1] 198.1.

### Methyl 2-methoxymethyloxy-4-nitrobenzoate

Methyl 4-nitrosalicylate (4.0 g, 20 mmol) was dissolved in dichloromethane (50 mL) and DIEA (20 mL). Chloromethyl methyl ether (7.6 mL 100 mmol) was added and the mixture was stirred for 4 h. After evaporation in vacuo, the product was dissolved in water and extracted with ethyl acetate. The organic layer was washed with water and brine, and dried. After evaporation the product was used for further reaction without purification.

Rt. 7.60 min [system 1], MS [M+1] 242.0.

### 4-Amino-2-methoxymethyloxybenzoic acid

Methyl 2-methoxymethyloxy-4-nitrobenzoate (4.8 g, 20 mmol) was dissolved in ammonia (100 mL) and water (100 mL), and zinc powder (7 g) was gradually added. The mixture was left stirring overnight. After filtering off the solid residue, the product was concentrated, neutralized to pH 8 and extracted with ethyl acetate. The organic layer was washed with water and brine and dried over sodium sulphate. The product was used for further reaction without purification.

Rt. 4.36 min [system 1], MS [M+1] 197.9.

### 2-Methoxymethyloxy-4-(N-tosylamido)benzoic acid

4-Amino-2-methoxymethyloxy-benzoic acid (3.0 g, 15 mmol) was dissolved in 100 mL water, containing NaOH (6 g) and sodium carbonate (0.7 g). The mixture was heated to 80° C. and tosyl chloride (4.0 g, 21 mmol) was added after 30 min at 80° C. The mixture was left at room temperature for 1 h and then acidified with concentrated HCl. The precipitate was filtered and used for further reactions without purification.

Rt. 8.06 min [system 1], MS [M+1] 351.9.

### 2-Methoxymethyloxy-4-(N-methyl-N-tosylamido)benzoic acid

2-Methoxymethyloxy4-(N-tosylamido)benzoic acid (1.5 g, 4.3 mmol) was dissolved in acetone (50 mL) containing finely ground NaOH (1.7 g). After mixing, dimethylsulphate (1.6 ml, 17 mmol) was added and the reaction was refluxed for 2 h. Then water (300 μL) was added and the reaction was left overnight at room temperature. The mixture was evaporated, dissolved in water, washed with ethyl acetate and acidified. The product was extracted with ethyl acetate, washed with water, brine and dried over sodium sulphate. The product was used for further synthesis without purification.

Rt. 7.91 min [system 1], MS [M+1] 366.0.

### (2-Diethylamino)ethyl 2-methoxymethyloxy 4-(N-methyl-N-tosylamino)benzoate

2-Methoxymethyloxy4-(N-methyl-N-tosylamido) benzoic acid (500 mg, 1.37 mmol) was dissolved in 0.5 M DCC/CH₂Cl₂ (10 mL) and HOBt (100 mg), DMAP (100 mg) and 2-diethylamino)ethanol (500 μL) were added. The mixture was left for 12 h, then dicyclohexylurea was filtered off, CH₂Cl₂ was evaporated, and the product was dissolved in ethyl acetate, washed with 10% solution of sodium carbonate, water, brine and dried over sodium sulphate. After evaporation the procedure was used for further reaction without purification.

Rt. 6.77 min [system 1], MS [M+1] 465.0.

### (2-Diethylamino)ethyl 4-(methylamino)salicylate

(2-Diethylamino)ethyl 2-methoxymethyloxy 4-(N-methyl-N-tosylamino)benzoate (400 mg, 0.86 mmol) was dissolved in concentrated sulphuric acid (5 mL) and poured over ice after 5 min. The mixture was alkalized using solid sodium carbonate and the product was extracted with ethyl acetate. The organic phase was washed with water, brine and dried over sodium sulphate. After evaporation the product was purified using preparative HPLC.

Rt. 4.72 min [system 1]; MS [M+1] 267.0; 1H NMR (500 MHz, CD₃OD): d (ppm) 1.34 (t, J=6.8 Hz, 6H), 2.79 (s, 3H), 3.34 (q, J=4 Hz, 4H), 3.60 (t, J=4 Hz, 2H), 4.61 (t, J=4.5 Hz, 2H), 5.99 (s, 1H), 6.15 (d, J=8.59 Hz, 1H), 7.58 (d, J=9.26 Hz, 1H).

### Compound (87) (2-Diethylamino)ethyl 4-(methylamino)salicylamide

### Methyl 4-nitrosalicylate

4-Nitrosalicylic acid (10 g, 55 mmol) was dissolved in methanol (200 mL) in the presence of sulphuric acid (0.5 mL) and gently refluxed at the boiling point temperature overnight. Alcohol was evaporated in vacuo. The residue was poured into 10% sodium carbonate and extracted with ethyl acetate. The organic layer was washed with 10% sodium carbonate, water and brine, and dried over sodium sulphate. The product was used for further reactions without purification.

Rt. 8.02 min [system 1], MS [M+1] 198.1.

### Methyl 2-methoxymethyloxy-4-nitrobenzoate

Methyl 4-nitrosalicylate (4.0 g, 20 mmol) was dissolved in dichloromethane (50 mL) and DIEA (20 mL). Chloromethyl methyl ether (7.6 mL 100 mmol) was added and the mixture was stirred for 4 h. After evaporation in vacuo, the product was dissolved in water and extracted with ethyl acetate. The organic layer was washed with water and brine, and dried sodium sulphate. After evaporation the product was used for further reaction without purification.

Rt. 7.60 min [system 1], MS [M+1] 242.0.

### 4-Amino-2-methoxymethyloxybenzoic acid

Methyl 2-methoxymethyloxy-4-nitrobenzoate (4.8 g, 20 mmol) was dissolved in ammonia (100 mL) and water (100 mL), and zinc powder (7 g) was gradually added. The mixture was left stirring overnight. After filtering off the solid residue, the product was concentrated, neutralized to pH 8 and extracted with ethyl acetate. The organic layer was washed with water and brine and dried over sodium sulphate. The product was used for further reaction without purification.

Rt. 4.36 min [system 1], MS [M+1 197.9.

### 2-Methoxymethyloxy-4-(N-tosylamido)benzoic acid

4-Amino-2-methoxymethyloxy-benzoic acid (3.0 g, 15 mmol) was dissolved in 100 mL water, containing NaOH (6 g) and sodium carbonate (0.7 g). The mixture was heated to 80° C. and tosyl chloride (4.0 g, 21 mmol) was added after 30 min at 80° C. The mixture was left at room temperature for 1 h and then acidified with concentrated HCl. The precipitate was filtered and used for further reactions without purification.

Rt. 8.06 min [system 1], MS [M+1] 351.9.

### 2-Methoxymethyloxy-4-(N-methyl-N-tosylamido)benzoic acid

2-Methoxymethyloxy-4-(N-tosylamido) benzoic acid (1.5 g, 4.3 mmol) was dissolved in acetone (50 mL) containing finely ground NaOH (1.7 g). After mixing, dimethylsulphate (1.6 ml, 17 mmol) was added and the reaction was refluxed for 2 h. Then water (300 μL) was added and the reaction was left overnight at room temperature. The mixture was evaporated, dissolved in water, washed with ethyl acetate and acidified. The product was extracted with ethyl acetate, washed with water, brine and dried over sodium sulphate. The product was used for further synthesis without purification.

Rt. 7.91 min [system 1], MS [M+1] 366.0.

### (2-Diethylamino)ethyl 2-methoxymethyloxy 4-(N-methyl-N-tosylamino)benzamide

2-Methoxymethyloxy-4-(N-methyl-N-tosylamido) benzoic acid (250 mg, 0.68 mmol) was dissolved in DMF (10 mL) and TBTU (210 mg), HOBt (100 mg) and DIEA (100 μL) and 2-diethylamino)ethylamine (300 μL) were added. The mixture was left overnight, then it was poured into 10% sodium carbonate (50 mL) and extracted with ethyl acetate. The organic phase was washed with 10% solution of sodium carbonate, water, brine and dried over sodium sulphate. After evaporation the product was used for further reaction without purification.

Rt. 6.62 min [system 1], MS [M+1] 464.2.

### (2-Diethylamino)ethyl 4-(methylamino)salicylamide

(2-Diethylamino)ethyl 2-methoxymethyloxy 4-(N-methyl-N-tosylamino)benzamide (160 mg, 0.34 mmol) was dissolved in concentrated sulphuric acid (5 mL) and poured over ice after 5 min. The mixture was alkalized using solid sodium carbonate and the product was extracted with ethyl acetate. The organic phase was washed with water, brine and dried over sodium sulphate. After evaporation the product was purified using preparative HPLC.

Rt. 3.89 min [system 1]; MS [M+1] 366.1; 1H NMR {500 MHz, CD₃OD): d (ppm) 1.33 (t, J=7.3 Hz, 6H), 2.77 (s, 3H), 3.30 (m, J=6.8 Hz, 4H), 3.35 (m, J=6.2 Hz, 2H), 3.69 (t, J=6.3 Hz, 2H), 5.98 (s, 1H), 6.15 (d, J=8.4 Hz, 1H), 7.47 (d, J=9, 1H).

### Compound (88) N-(2-hydroxy-4-(methylamino)-benzoyl)glutamic acid

### Methyl 4-nitrosalicylate

4-Nitrosalicylic acid (10 g, 55 mmol) was dissolved in methanol (200 mL) in the presence of sulphuric acid (0.5 mL) and gently refluxed at the boiling point temperature overnight. Alcohol was evaporated in vacuo. The residue was poured into 10% sodium carbonate and extracted with ethyl acetate. The organic layer was washed with 10% sodium carbonate, water and brine, and dried over sodium sulphate. The product was used for further reactions without purification.

Rt. 8.02 min [system 1], MS [M+1] 198.1.

### Methyl 2-methoxymethyloxy-4-nitrobenzoate

Methyl 4-nitrosalicylate (4.0 g, 20 mmol) was dissolved in dichloromethane (50 mL) and DIEA (20 mL). Chloromethyl methyl ether (7.6 mL 100 mmol) was added and the mixture was stirred for 4 h. After evaporation in vacuo, the product was dissolved in water and extracted with ethyl acetate. The organic layer was washed with water and brine, and dried sodium sulphate. After evaporation the product was used for further reaction without purification.

Rt. 7.60 min [system 1], MS [M+1] 242.0.

### 4-Amino-2-methoxymethyloxybenzoic acid

Methyl 2-methoxymethyloxy4-nitrobenzoate (4.8 g, 20 mmol) was dissolved in ammonia (100 mL) and water (100 mL), and zinc powder (7 g) was gradually added. The mixture was left stirring overnight. After filtering off the solid residue, the product was concentrated, neutralized to pH 8 and extracted with ethyl acetate. The organic layer was washed with water and brine and dried over sodium sulphate. The product was used for further reaction without purification.

Rt. 4.36 min [system 1], MS [M+1] 197.9.

### 2-Methoxymethyloxy-4(N-tosylamido)benzoic acid

4-Amino-2-methoxymethyloxybenzoic acid (3.0 g, 15 mmol) was dissolved in 100 mL water, containing NaOH (6 g) and sodium carbonate (0.7 g). The mixture was heated to 80° C. and tosyl chloride (4.0 g, 21 mmol) was added after 30 min at 80° C. The mixture was left at room temperature for 1 h and then acidified with concentrated HCl. The precipitate was filtered and used for further reactions without purification.

Rt. 8.06 min [system 1], MS [M+1] 351.9.

### 2-Methoxymethyloxy-4-(N-methyl-N-tosylamido)benzoic acid

2-Methoxymethyloxy4-(N-tosylamido)benzoic acid (1.5 g, 4.3 mmol) was dissolved in acetone (50 mL) containing finely ground NaOH (1.7 g). After mixing, dimethylsulphate (1.6 ml, 17 mmol) was added and the reaction was refluxed for 2 h. Then water (300 μL) was added and the reaction was left overnight at room temperature. The mixture was evaporated, dissolved in water, washed with ethyl acetate and acidified. The product was extracted with ethyl acetate, washed with water, brine and dried over sodium sulphate. The product was used for further synthesis without purification.

Rt. 7.91 min [system 1], MS [M+1] 366.0.

Di-tert-butyl N-(2-methoxymethyloxy-4-(N-methyl-N-tosylamido)-benzoyl) glutamate 2-Methoxymethyloxy-4-(N-methyl-N-tosylamido)benzoic acid (250 mg, 0.68 mmol) was dissolved in DMF (15 mL), and di-tert-butylglutamate hydrochloride (400 mg, 1.35 mmol), TBTU (210 mg), HOBt (100 mg) and DIEA (100 ?L) were added. The mixture was left overnight, then was poured into 10% solution of sodium carbonate. The product was extracted with ethyl acetate, washed with 10% sodium carbonate, water, 0.5 M hydrogen potassium sulphate solution, water and brine, and dried sodium sulphate. After evaporation the product was used for further reactions without purification.

Rt 11.18 min [system 1], MS [M+1] 607.2

### N-(2-hydroxy-4-(methylamino)-benzoyl)glutamic acid

Di-tert-butyl N-(2-methoxymethyloxy-4-(N-methyl-N-tosylamido)-benzoyl) glutamate (300 mg, 0.5 mmol) was dissolved in concentrated sulphuric acid (5 mL) and poured over ice after 5 min. The pH was adjusted to 34 with solid sodium carbonate, and the product was extracted with ethyl acetate, washed with water, brine and dried sodium sulphate. The product was purified using preparative HPLC.

Rt. 3.93 min [system 1]; MS [M+1] 297.0; 1H NMR (500 MHz, CD₃OD): d (ppm) 2.06 (m, J=6.55 Hz, 2H), 2.43 (m, J=6.7 Hz, 2H), 2.77 (s, 3H), 4.60 (q, J=4.9 Hz, 1H), 5.99 (s, 1H), 6.15 (d, J=8.47 Hz, 1H), 7.552 (d, J=8.29 Hz, 1H).

### Compound (89) 4-Acetamidosalicylic acid was Purchased from Sigma.

### Compound (90) Ethyl 4-acetamidosalicylate

Ethyl 4-aminosalicylate [compound (62)] (200 mg, 1.1 mmol) was dissolved in DMF (10 mL), and acetic anhydride (3 mL was added. The reaction mixture was left overnight, then poured into water, and neutralized. The product was extracted with ethyl acetate. The combined organic layer was washed with 10% sodium carbonate, water and brine, and dried over sodium sulphate. The solvent was evaporated and the product was purified using preparative HPLC.

Rt. 6.20 min [system 1]; MS [M+1] 224.0; 1H NMR (500 MHz, CD₃OD): ? 1.33 (t, J=7 Hz, 3H), 2.14 (s, 3H), 4.26 (q, J=7.2 Hz, 2H), 7.42 (dd, J=2.41 Hz, J=6.39 Hz, J=2.18 Hz, 1H), 7.53 (d, J=2.2 Hz, 1H), 8.84 (d, J=8.84 Hz, 1H).

### Compound (91) 4-acetylamino-2-hydroxybenzoic acid 2-(N,N-diethylamino)ethyl ester

### 4-Acetylamino-2-hydroxybenzoic acid

The 4-amino-2-hydroxybenzoic acid (2.5 g; 16.5 mmol) was dissolved in a mixture of acetic acid-acetic anhydride (1:1) (50 mL). The mixture was heated and kept under reflux overnight and then poured into cold water. The precipitate was separated by suction on Schott funnel, washed several times with cold water and dried. The product was used for further synthesis without purification.

Rt. 4.13 min [system 1], MS [M+1] 154.1.

### 4-Acetylamino-2-hydroxybenzoic acid 2-(N,N-diethylamino)ethyl ester.

4-Acetylamino-2-hydroxybenzoic acid (0.5 g; 2.6 mmol), DCC (540 mg; 2.6 mmol) and DMAP (310 mg; 2.6 mmol) were dissolved in methylene chloride (30 mL). After 20 min, 2-(N,N-diethylamino)ethanol (1.22 g; 10.4 mmol) was added. The mixture was stirred at room temperature for 24 h. The precipitate was separated by suction and washed several times with methylene chloride (total 50 mL). Methylene chloride was removed in the stream of nitrogen and the residue was purified using preparative HPLC,

Rt. 4.03 min [system 1]; MS [M+1] 295.2; 1H NMR (500 MHz, CD₃OD): d (ppm) 1.35 (t, J=6.7 Hz, 6H), 2.13 (s, 3H), 3.35 (q, J=4 Hz, 4H), 3.64 (t, J=4 Hz, 2H), 4.68 (t, J=4.5 Hz, 2H), 7.067 (s,1 H), 7.37 (s,1H), 7.81 (d, J=8.77 Hz,1H).

### Compound (92) N-(2-Diethylamino)ethyl 4-acetamido-salicylamide

4-Acetamidosalicylic acid [compound (89)] (100 mg, 0.51 mmol) was dissolved in DMF (3 mL). 2-Diethylaminoethylamine (48 mg, 0.41 mmol), TBTU (164 mg) and DIEA (170 μL) were added and the mixture was left at room temperature for 4 h. Then it was poured into 10% solution of sodium carbonate and it was extracted with ethyl acetate. The organic phase was washed with 10% sodium carbonate, water and brine, and dried over sodium sulphate. After evaporation the product was purified using preparative HPLC.

Rt. 3.83 min [system 1]; MS [M+1] 294.2; 1H NMR (500 MHz, CD₃OD): d (ppm)?1.33 (t, J=7.3 Hz, 6H), 2.12 (s, 3H), 3.32 (m, J=6.8 Hz, 4H), 3.36 (m, J=6.2 Hz, 2H), 3.75 (t, J=6.3 Hz, 2H), 7.00 (d, J=7.5 Hz, 1 H), 7.4 (s, 1H), 7.73 (d, J=8.56 Hz,1H).

### Compound (93) N-(4-amino-2-hydroxybenzoyl)-L-glutamic acid

4-Acetamidosalicylic acid [compound (89)] (120 mg; 0.62 mmol) was dissolved in DMF (15 mL). L-glutamic acid di-t-butyl ester hydrochloride (66 mg, 0.23 mmol), TBTU (210 mg), HOBT (92 mg) and DIEA (160 mg) were added and mixed at room temperature for 15 h. The mixture was poured into 10% sodium carbonate. The product was extracted with ethyl acetate, washed with 10% sodium carbonate and brine and dried over sodium sulphate. After evaporation, t-butyl group was removed with TFA (92.5%), water (5%) and triisopropylsilane (2.5%) for 2 h. The product was purified using preparative HPLC.

Rt. 4.05 min [system 1]; MS [M+1] 325.1; 1H NMR (500 MHz, CD₃OD): d (ppm)2.08 (m, J=6.5 Hz, 2H), 2.15 (s, 3H), 2.44 (m, J=6.7 Hz, 2H), 4.60 (q, J=4.9 Hz, 1H), 7.00 (d, J=8.5 Hz, 1H), 7.35 (s, 1 H), 7.76 (d, J=8.4 Hz, 1H).

### Compound (94) 4-Amino-N-isopropyl-2-methoxybenzamide

### 2-Methoxy-4-nitro-N-isopropylbenzamide [compound (128)]

2-Methoxy-4-nitrobenzoic acid (500 mg, 2.5 mmol) was heated under reflux with thionyl chloride (25 mL) for 2 h. Thionyl chloride was removed in the stream of nitrogen, and then isopropylamine (15 mL) was added. The mixture was stirred and gently heated (up to 35° C.) for 1 h. The excess of amine was removed by the stream of nitrogen. Solid residue was washed several times with slightly acidified water (hydrochloric acid) and then with water. The product was dried in the slow stream of air and used for further reaction without purification.

Rt 6.76 min [system 1], MS [M+1] 239.1.

### 4-amino-2-methoxy-N-isopropylbenzamide

2-Methoxy4-nitro-N-isopropylbenzamide (190 mg, 0.7 mmol), tin chloride (500 mg, 3 mmol) and water (0.1 mL) were dissolved in DMF (5 mL). The mixture was left overnight at room temperature. Then the mixture was poured into water containing 3 g of sodium bicarbonate. The product was extracted with ethyl acetate four times. The collected organic layer was washed with slightly alkaline water containing small amount of sodium bicarbonate, and then the product was extracted with 50 mL of 1% HCl four times. Collected water phases were alkalized with slight excess of NaHCO₃, and the product was extracted several times with small portions of ethyl acetate. Organic layers were collected and dried over anhydrous sodium sulphate. Inorganic part was separated by suction and washed with a small volume of ethyl acetate twice. Organic layers were collected and solvent was removed on rotary evaporator. The product was recrystallized.

Rt. 3.97 min [system 1]; MS [M+1] 209.1; 1H NMR (500 MHz, (CD₃)₂CO): d (ppm) 1.17 (d, J=6.62 Hz, 6H), 3.89 (s, 3H), 4.12 (q, J=6.37, 1H), 6.31 (d, J=8.4, 1H), 6.37 (s, 1 H), 7.83 (d, J=8.27, 1H), 7.97 (bs,1NH).

### Compound (95) 4-Amino-benzoic acid 3-methyl-but-2-enyl ester

A mixture of 4-aminobenzoic acid (200 mg, 1.46 mmol), 3-methyl-2-buten-1-ol (250 mg, 2.92 mmol), DCC (300 mg, 1.46 mmol) and catalytic amount of DMAP (20 mg, 0.15 mmol) in acetonitrile (10 mL) was stirred at room temperature for 18 h. The reaction mixture was filtered and subjected to silica-gel column chromatography (ethyl acetate:hexane=1:1) and re-crystallized with ambient solvent.

Rt. 7.39 min [system 1]; MS [M+1] 206.1; 1H NMR (500 MHz, CD₃OD): d (ppm) 1.78 (d, J=6.27, 6H), 4.00 (bs, —NH₂), 4.73 (d, J=7.26 Hz, 2H), 5.43 (m, J=6.67 Hz, 1H), 6.62 (dd, J=1.54 Hz, J=7.2 Hz, 2H), 7.71 (dd, J=2.61 Hz, J=8.8 Hz, 2H).

### Compound (96) 4-Amino-3-chloro-N-pentylbenzamide

A mixture of 4-amino-3-chlorobenzoic acid (200 mg, 1.17 mmol), 1-pentylamine (0.25 mL, 2.57 mmol), DCC (240 mg, 1.17 mmol) and HOBT (180 mg, 1.17 mmol) in acetonitrile (10 mL) was stirred at room temperature for 12 h. The reaction mixture was filtered and subjected to silica-gel column chromatography (ethyl acetate:hexane=2:1) and re-crystallized with ambient solvent.

Rt. 7.51 min [system 1]; MS [M+1] 240.1; ^{1l H-nmr (}500 MHz, (CD₃)₂CO): d (ppm) 0.93 (t, 3H), 1.36 (m, 4H), 1.58-1.60 (m, 2H), 6.80 (d, 1 H, aromatic), 7.53 (d, 1 H, aromatic), 7.73 (s, 1H, aromatic).

### Compound (97) 4-Amino-5-chloro-N,N-diethyl-2-methoxybenzamide

4-Amino-5-chloro-2-methoxybenzoic acid (200 mg, 1.00 mmol), diethylamine (0.35 mL, 5.0 mmol) and TBTU (320 mg, 1.00 mmol) were added to acetonitrile (10 mL) and the reaction solution was stirred at room temperature for 18 h. The product was extracted with ethyl acetate with 10% aq. NaOH solution, and the organic layer was dried over Na₂SO₄ and concentrated in vacuo. The residue was subjected to silica-gel column chromatography (ethyl acetate:hexane=2:1) and re-crystallized with ambient solvent.

Rt. 6.22 min [system 1]; MS [M+1] 257.3; ¹H-nmr (500 MHZ, CD₃OD): d (ppm) 1.07 (t, 2H, J=7.0 Hz), 1.21 (t, 2H, J=70 Hz), 3.23 (q, 2H, J=7.0 Hz), 3.50 (bs, 2H), 3.76 (s, 3H, OCH3), 6.50 (s, 1H, aromatic), 6.98 (s, 1H, aromatic).

### Compound (98) (2-Hydroxyethyl) 4-aminobenzoate

A mixture of 4-aminobenzoic acid (200 mg, 1.46 mmol), ethylene glycol (1.0 mL, 17.7 mmol), DCC (300 mg, 1.46 mmol) and catalytic amount of DMAP (20 mg, 0.15 mmol) in MeCN (10 mL) was stirred at room temperature for 18 h. The reaction mixture was filtered and subjected to silica-gel column chromatography (ethyl acetate:hexane=1:1) and re-crystallized with ambient solvent.

Rt. 2.78 min [system 1]; MS [M+1] 182.1; 1H NMR (500 MHz, CD₃OD): d (ppm) 2.15 (s, —OH), 3.82 (t, J=3.3 Hz, 2H), 4.00 (bs, —NH₂), 4.28 (t, J=4.3 Hz, 2H), 6.62 (dd, J=8.8 Hz, 2H), 7.77 (dd, J=8.8 Hz, 2H).

### Compound (99) 4-Amino-5-chloro-N-(4-chloro-phenyl)-2-methoxybenzamide

A mixture of 4-amino-5-chloro-2-methoxybenzoic acid (200 mg, 1.00 mmol), 4-chloroaniline (130 mg, 1.0 mmol), DCC (210 mg, 1.00 mmol) and catalytic amount of DMAP (15 mg, 1.0 mmol) were added to acetonitrile (10 mL) and the reaction solution was stirred at room temperature for 12 h. The reaction mixture was filtered and subjected to silica-gel column chromatography (ethyl acetate:hexane=2:1) and recrystallized with ambient solvent.

Rt. 9.39 min [system 1]; MS [M+1] 311.2, [M+2] 312.0; ¹H NMR (500 MHz, (CD₃)₂CO): d (ppm) 4.05 (s, 3H, OCH₃), 6.67 (s, 1H, aromatic), 7.34 (d, 2H, aromatic), 7.80 (d, 2H, aromatic), 7.99 (s, 1 H, aromatic), 9.85 (s, 1H, NH amide).

### Compound (100) Isopropyl-4-aminobenzoate was Purchased from Avocado Research Chemicals Ltd.

### Compound (101) 4-Amino-benzoic acid 2-morpholin-4-yl-ethyl ester

A mixture of 4-aminobenzoic acid (200 mg, 1.46 mmol), 4-(2-hydroxyethyl)morpholine (0.5 mL, 3.92 mmol), DCC (300 mg, 1.46 mmol) and catalytic amount of DMAP (20 mg, 4.21 mmol) in acetonitrile (10 mL) was stirred at room temperature for 18 h. The reaction mixture was filtered and subjected to silica-gel column chromatography (ethyl acetate:hexane=3:1) and re-crystallized with ambient solvent.

Rt. 2.40 min [system 1]; MS [M+1] 251.0; ¹H NMR (500 MHz, CD₃OD): d (ppm) 2.590 (m, J=5 Hz, 4H), 2.75 (t, J=5.4 Hz, 2H), 3.71 (m, J=6.0 Hz, 4H), 4.37 (t, J=5.3 Hz, 2H), 6.62 (d, J=8.28 Hz, 2H), 7.73 (d, J=8.32 Hz, 2H).

### Compound (102) 4-Amino-N,N-diethyl-benzamide

A mixture of 4-aminobenzoic acid (200 mg, 1.46 mmol), phenol (1.0 mL, 9.64 mmol), DCC (300 mg, 1.46 mmol) and a catalytic amount of DMAP (20 mg, 0.15 mmol) in MeCN (10 mL) was stirred at room temperature for 18 h. The reaction mixture was filtered and subjected to silica-gel column chromatography (ethyl acetate:hexane=2:1) and re-crystallized with ambient solvent to give 120 mg (43%) of white powder.

Rt. 3.35 min [system 1]; MS [M+1] 193.0; 1H NMR (500 MHz, CD₃OD): d (ppm) 1.17 (t, J=6.9 Hz,6H), 3.44 (q, J=6.5 Hz, 4H), 4.00 (bs, —NH₂), 6.69 (dd, J=1.34 Hz, J=4.62 Hz, J=2.25 Hz,2H), 7.14 (dd, J=1.52 Hz, J=4.61 Hz, J=1.75 Hz, 2H).

### Compound (103) 4-Amino-benzoic acid 2-(2-diethylamino-ethoxy)-ethyl ester

A mixture of 4-aminobenzoic acid (200 mg, 1.46 mmol), phenol (0.5 mL, 3.42 mmol), DCC (300 mg, 1.46 mmol) and catalytic amount of DMAP (20 mg, 0.15 mmol) in acetonitrile (10 mL) was stirred at room temperature for 18 h. The reaction mixture was filtered and subjected to silica-gel column chromatography (ethyl acetate:hexane=2:1).

Rt. 3.75 min [system 1]; MS [M+1] 281.1; ¹H NMR (500 MHz, (CD₃)₂CO): d (ppm) 0.96 (t, 6H, 7.0 Hz), 2.61 (t, 2H, J=6.0 Hz), 2.83 (br. s, 4H), 3.57 (t, 2H, J=6.0 Hz), 3.73 (m, 2H), 4.32 (m, 2H), 6.68 (d, 2H, aromatic), 7.75 (d, 2H, aromatic).

### Compound (104) 3.4-Diaminobenzoic acid was purchased from Aldrich.

### Compound (105) 4-Amino-3-methoxybenzoic acid

### Ethyl 3-methoxy-4-nitrobenzoate

3-Methoxy-4-nitrobenzoic acid (1 g, 5 mmol) was refluxed with thionyl chloride (5 mL) for 30 min, then the unreacted thionyl chloride was evaporated, and the resulting acid chloride was mixed with ethyl alcohol (100 mL) containing triethylamine (5 mL). The mixture was left overnight. After evaporation the mixture was dissolved in ethyl acetate and washed with 10% sodium carbonate and water. Then the mixture was acidified with 0.1 M HCl and washed again with water, brine and dried over sodium sulphate. After evaporation the residue was used for further reaction without purification.

Rt. 8.27 min [system 1], MS [M+1] 225.5.

### Ethyl 4-amino-3-methoxybenzoate

Ethyl 3-methoxy-4-nitrobenzoate (0.5 g, 2.2 mmol) was reduced by tin chloride hydrate (5 g) in DMF (20 mL) overnight. The resulting mixture was filtered, neutralized and extracted with ethyl acetate the combined organic layer was washed with water, brine and dried over sodium sulphate. After evaporation the residue was used for further reaction.

Rt. 5.95 min [system 1], MS [M+1] 196.3.

### 4-Amino-3-methoxybenzoic acid

Ethyl 4-amino-3-methoxybenzoate (0.2 g, 1 mmol) was refluxed in methanol (50 mL) and 10% NaOH solution (50 mL) for 2 h. then the mixture was concentrated, neutralized and extracted with ethyl acetate. The organic layer was washed with water and brine and dried over sodium sulphate. The product was purified by preparative HPLC.

Rt. 2.69 min [system 1]; MS [M+1] 168.0; 1H NMR (500 MHz, CD₃OD): d (ppm) 3.90 (s, 3H), 6.79 (d, J=8.15 Hz, 1H), 7.48 (s, 1H), 7.51 (d, J=7.7 Hz, 1H).

### Compound (106) 4-Amino-N-phenyl-benzamide

A mixture of 4-aminobenzoic acid (200 mg, 1.46 mmol), aniline (0.27 mL, 2.92 mmol), DCC (300 mg, 1.46 mmol) and a catalytic amount of DMAP (20 mg, 0.15 mmol) in MeCN (10 mL) was stirred at room temperature for 12 h. The reaction mixture was filtered and subjected to silica-gel column chromatography (ethyl acetate:hexane=2:1) and re-crystallized with ambient solvent to give 250 mg (81%) of white powder.

Rt. 4.72 min; MS [M+1] 213.3; 1H NMR (500 MHz, CD₃OD): d (ppm) 4.00 (bs, —NH₂), 6.7 (d, J=8.36 Hz, 2H), 7.08 (t, J=7.98 Hz, 1H), 7.3 (t, J=7.6 Hz, 2H), 7.62 (d, J=8 Hz, 2H), 7.71 (d, J=8.4 Hz, 2H), 8.00 (bs, —NH).

### Compound (107) 2-(Diethylamino)ethyl 4-(D-ribopyranosylamino)benzoate

Procain HCl (0.272 g; 1 mmol) and D-xylose (0.150 g; 1 mmol) were dissolved in methanol (10 ml) and incubated at 45° C. for 24 h. Then, solvent was evaporated and residue was dried in vacuo. The compound was purified by flush column chromatography using silica gel (grade 62, 60-200 mesh, 150A) and a mixture of chloroform/methanol/triethylamine (80/20/0.5) as elution solvent.

Rt. 1.09 min [system 1], MS [M+1] 396.1,

### Compound (108) 2-(Diethylamino)ethyl 4-(D-glucopyranosylamino)benzoate

Procain HCl (0.272 g; 1 mmol) and D-glucose (0.180 g; 1 mmol) were dissolved in methanol (10 ml) and incubated at 45° C. for 24 hours. Then, methanol was evaporated and residue was dried in vacuo. The compound was purified by flush column chromatography using silica gel (grade 62, 60-200 mesh, 150A) and a mixture of chloroform/methanol/triethylamine (80/20/0.5) as elution solvent.

Rt. 1.09 min [system 1], MS [M+1] 399.6.

### Compound (109) N-[2-(Diethylamino)ethyl]-4-(D-ribopyranosylamino)benzamine

Procainamide HCl (0.271 g; 1 mmol) and D-xylose (0.150 g; 1 mmol) were dissolved in methanol (10 ml) and incubated at 45° C. for 24 hours. Then, methanol was evaporated and residue was dried in vacuo. The compound was purified by flush column chromatography using silica gel (grade 62, 60-200 mesh, 150A) and a mixture of chloroform/methanol/triethylamine ( 80/20/0.5) as elution solvent.

Rt. 1.09 min [system 1], MS [M+1] 368.0.

### Compound (110) 4-Amino-3-hydroxy-benzoic acid methyl ester

The 4-amino-3-hydroxybenzoic acid (530 mg, 3.5 mmol) was dissolved in methanol (150 mL) containing 0.5 mL of sulfuric acid. The mixture was kept under reflux overnight and than about ¾ of methanol was removed on rotatory evaporator. The remaining mixture was poured into water containing excess (in relation to sulfuric acid) of sodium bicarbonate. Than the water solution was extracted four times with ethyl acetate (total 150 mL). Collected organic fractions were left for drying over anhydrous sodium sulfate. The inorganic residue was separated and ethyl acetate removed on rotatory evaporator. The product was purified by preparative HPLC.

Rt 3.02 min [system 1]; MS [M+1] 167.1; 1H NMR (500 MHz, (CD₃)₂CO) d (ppm) 3.75 (s, 3H), 6.63 (d, J=7.99 Hz, 1H), 7.39 (s, 1H), 7.43 (d, 7.51 Hz, 1H).

### Compound (111) 4-Amino-3-methoxy-benzoic acid ethyl ester

### Ethyl 3-methoxy-4-nitrobenzoate

3-Methoxy-4-nitrobenzoic acid (1 g, 5 mmol) was refluxed with thionyl chloride (5 ml) for 30 minutes, then the unreacted thionyl chloride was evaporated and the resulting acid chloride was mixed with ethyl alcohol (100 ml) containing triethylamine (5 ml). The mixture was left overnight. After evaporation the mixture was dissolved in ethyl acetate and washed with 10% sodium carbonate, water, 0.1 M HCl, water, brine and dried over sodium sulfate. After evaporation residue was used for further reaction.

Rt 8.27 min [system 1], MS [M+1] 225.5.

### Ethyl 4-amino-3-methoxybenzoate

Ethyl 3-methoxy-4-nitrobenzoate (500 mg, 2.2 mmol) was reduced by tin chloride hydrate (5.0 g) in DMF (20 ml) overnight. The resulting mixture was filtered, neutralized and extracted with ethyl acetate the combined organic layer was concentrated and subjected to column chromatography (ethyl acetate:hexane=1:1), yielding 320 mg (74%).

Rt 5.95 min [system 1]; MS [M+1] 196.3; ¹H NMR (500 MHz, (CD₃)₂CO) d (ppm) 1.31 (t, 3H, J=6.5 Hz), 3.87 (s, 3H, OCH₃), 4.25 (q, 2H, J=6.5 Hz), 6.71 (d, 1H, aromatic), 7.40 (s, 1 H, aromatic), 7.45 (d, 1 H, aromatic).

### Compound (112) 2-Acetoxy-3-methyl-benzoic acid

4 g (26mmoles) of 3-methyl salicylic acid were placed in a 250 mL round bottom flask. 10 mL of acetic anhydride were added and the mixture was stirred at room temperature for 30 minutes. 10 drops of sulphuric acid were added to the mixture and this was stirred at room temperature until the solid completely dissolved. The mixture was then heated on a water bath for 10 minutes. 50 mL of distilled water were added and the mixture was stirred until the disappearance of oily layer. The flask was heated for another 10 minutes and then left to cool at room temperature. After cooling, the solution was treated with 30-50 mL saturated NaHCO₃ and then acidified with 3M HCl. The flask was cooled in an ice bath and a white, fluffy precipitate formed and was filtered. The product (4 g) was used for the next reaction without further purification.

Rt. 5.98 min [system 1]., MS [M+1] 195.0.

### 2-Acetoxy-3-methylbenzamide

In a 100 mL round bottom flask, 1 g (5.15 mmole) of 2-acetoxy-3-methyl-benzoic acid dissolved in 20 mL dimethylformamide (DMF) was treated with aprox. 0.75 mL diisopropylcarbodiimide (DIPCD) (5.15 mmole, 0.649 g). The mixture was stirred at room temperature for about 30 minutes and then treated with 3 mL of 2M NH₃ /EtOH (5.15 mmole, 0.087 g). The reaction mixture was stirred at room temperature for about 3 hours. The mixture was treated with Na₂CO₃ and then extracted with ethyl acetate. The organic layer was then washed with water, brine and dried over Na₂SO₄. After evaporation the product was purified by preparative HPLC.

Rt. 9.155 min.[system 1]; MS [M+1] 194.0; 1H NMR (500 MHz, (CD₃)₂CO): d ppm) 2.36 (s, 3H), 5.16 (q, J=6.65 Hz, 3H), 7.27 (t, J=7.46, 1H), 7.61 (d, J=7.47 Hz, 1H), 7.83 (d, J=7.6 Hz, 1 H), 8.00 (bs, —NH₂).

Sunscreen Properties of Compounds (1) through (128)

UV-B (290-320 nm) radiation is known to be harmful for human skin. Acute negative effects include inflammation, sunburns, pigmentation changes and hyperplasia. Chronic negative effects include photoaging, immunosuppression and photocarcinogenesis, including squamous cells, basal cells and melanoma skin cancer. The UV-B radiation is also responsible for 98% of cases of delayed erythema development.

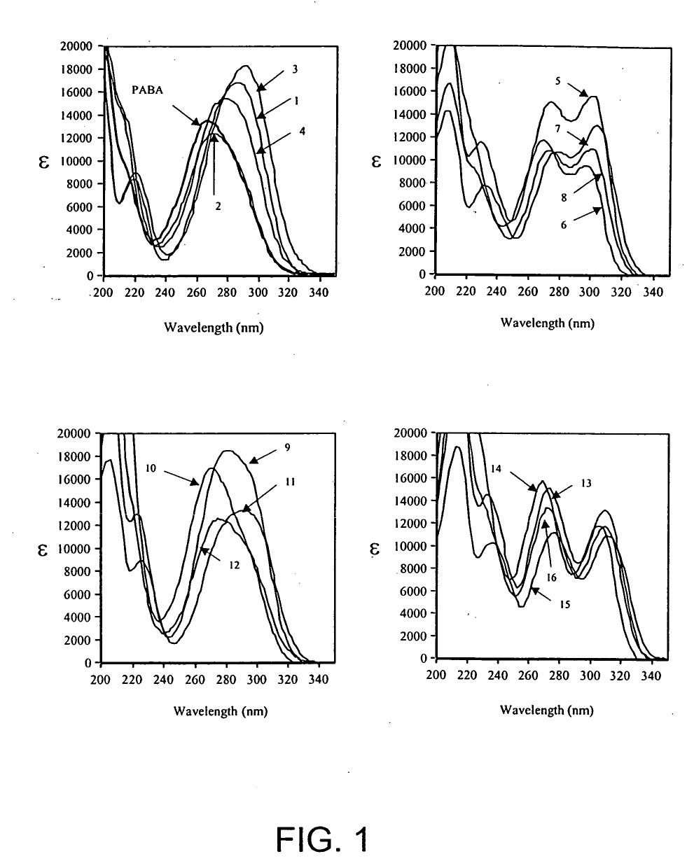

Various sunscreen agents have been developed to protect human skin from this harmful UV-B radiation. One known class of such UV-B sunscreen agents is PABA and its various derivatives. Their UV-protecting properties are due to their strong UV absorbance (e₂₆₆=15,000 for p-aminobenzoic acid). As shown in FIG. 1 to 8, all the above listed compounds (compounds (1) through (128)) are characterized by a strong UV absorbance comparable with that of p-aminobenzoic acid. As such, these compounds are useful as sunscreen agents.

Although various particular embodiments of the present invention have been described hereinbefore for purposes of illustration, it would be apparent to those skilled in the art that numerous variations may be made thereto without departing from the spirit and scope of the invention, as defined in the appended claims.

What is claimed is:

1. A method of providing a new drug, drug candidate, or biologically active chemical compound, said method comprising the steps of:
identifying a first group of compounds, said first group comprising bioactive compounds, said compounds built on a common building block,
identifying in the first group of compounds a first set of side chains modifying the building block,
generating a second set of side chains,
generating a second group of compounds, said second group comprising compounds built on the common building block of the first group of compounds and having the building block modified with side chains selected from the second set of side chains,
validating the second group of compounds as a “hot spot”, if containing an unusually large number of known drugs or biologically active compounds,
synthesizing at least one compound of the “hot spot” second group of compounds,
testing the synthesized compound for at least one biological activity, and
retaining the compound when showing the biological activity tested for.

2. A method according to claim 1, wherein the compounds of the first group are of diverse biological activities.

3. A method according to claim 2, wherein the side chains of the second set are derived entirely from the side chains of the first set.

4. A method according to claim 2, wherein the second set of side chains further includes side chains which are not derived from the first set.

5. A method according to claim 2, wherein the second set of side chains contains at least a subset of the first set of side chains.

6. A method according to claim 2, wherein at least a part of the side chains of the second set is derived from the side chains of the first set by a hybridization algorithm.

7. A method according to claim 2, wherein the compounds of the second group have the building block modified by a single substitution of a side chain of the first group of compounds or by adding a side chain to the building block.

8. A method according to claim 2, wherein the compounds of the second group have their building block modified with side chains that are frequently used in the first group of compounds.

9. A method according to claim 1, wherein the common building block is selected from the residues of para-aminobenzoic acid and salicylic acid.

10. A focused combinatorial library of chemical compounds, said library characterized by an increased probability of containing drugs, drug candidates, or biologically active compounds, said library generated by the steps of:
identifying a first group of compounds, said first group comprising bioactive compounds, said compounds built on a common building block,
identifying in the first group of compounds a first set of side chains modifying the building block,
generating a second set of side chains,
generating a library of compounds, said library comprising compounds built on the common building block of the first group of compounds and having the building block modified with side chains selected from the second set of side chains,
validating the second group of compounds as a “hot spot”, if containing an unusually large number of known drugs or biologically active compounds.

11. A focused combinatorial library according to claim 10, wherein the compounds of the first group are of diverse biological activities.

12. A focused combinatorial library according to claim 11, wherein side chains of the second set are derived entirely from the side chains of the first set.

13. A focused combinatorial library according to claim 11, wherein the second set of side chains further includes side chains which are not derived from the first set.

14. A focused combinatorial library according to claim 11, wherein the second set of side chains contains at least a subset of the first set of side chains.

15. A focused combinatorial library according to claim 11, wherein at least a part of the side chains of the second set is derived from the side chains of the first set by a hybridization algorithm.

16. A focused combinatorial library according to claim 11, wherein the compounds of the library have the building block modified by a single substitution of a side chain of the first group of compounds or by adding a side chain to the building block.

17. A focused combinatorial library according to claim 11, wherein the compounds of the library have the building block modified with side chains that are frequently used in the first group of compounds.

18. A focused combinatorial library according to claim 11, wherein the common building block is selected from the residues of para-aminobenzoic acid and salicylic acid.

19. A method of generating a focused combinatorial library of chemical compounds, said library characterized by an increased probability of containing drugs, drug candidates, or biologically active compounds, said method comprising the steps of:
identifying a first group of compounds, said first group comprising bioactive compounds built on a common building block,
identifying in the first group of compounds a first set of side chains modifying the building block,
generating a second set of side chains,
generating a library of compounds, said library comprising compounds built on the common building block of the first group of compounds and having the building block modified with side chains selected from the second set of side chains,
validating the second group of compounds as a “hot spot”, if containing by an unusually large number of drugs or biologically active compounds.

20. A method according to claim 19, wherein the compounds of the first group of compounds have diverse biological activities.

21. A method according to claim 20, wherein side chains of the second set of side chains are derived entirely from the side chains of the first set.

22. A method according to claim 20, wherein the second set of side chains further includes side chains which are not derived from the first set.

23. A method according to claim 20, wherein the second set of chains contains at least a subset of the first set of side chains.

24. A method according to claim 20, wherein at least a part of the side chains of the second set are derived from the side chains of the first set by a hybridization algorithm.

25. A method according to claim 20, wherein the compounds of the library have the building block modified by a single substitution of a side chain of the first group of compounds or by adding a side chain to the building block.

26. A method according to claim 20, wherein the compounds of the library have the building block modified with side chains that are frequently used in the first group of compounds.

27. A method according to claim 15, wherein the building block is selected from the residues of para-aminobenzoic acid and salicylic acid.

28. A chemical compound selected from the group consisting of N-ethyl4-amino-3-chlorobenzamide, (2-diethylaminoethyl)-4-amino-3-chlorobenzoate, N-ethyl-4-amino-5-chloro-2-methoxybenzamide and pharmaceutically acceptable salts thereof.

29. A chemical compound of claim 28, wherein the pharmaceutically acceptable salt is an acetate.

30. Use of compounds according to claim 28 and mixtures thereof as sunscreen agents.

31. Use as sunscreen agents of compounds or mixtures of compounds selected from the group consisting of ethyl-4-aminobenzoate, N-ethyl-4-aminobenzamide, (2-diethylaminoethyl)-4-aminobenzoate, N-(2-diethylaminoethyl)-4-aminobenzamide, ethyl-4-amino-2-methoxybenzoate, N-ethyl-4-amino-2-methoxybenzamide, (2-diethylaminoethyl)-4-amino-2-methoxybenzoate, N-(2-diethylaminoethyl)4-amino-2methoxybenzamide, ethyl-4-amino-3-chlorobenzoate, N-(2-diethylaminoethyl)-4-amino-3-chlorobenzamide, ethyl-4-amino-5-chloro-2-methoxybenzoate, (2-diethylaminoethyl)-4-amino-5-chloro-2-methoxybenzoate, N-(2-diethylaminoethyl)4-amino-5-chloro-2-methoxybenzamide, methyl-4-aminobenzoate, propyl-4-aminobenzoate, butyl4-aminobenzoate, isobutyl-4-aminobenzoate, 4-aminobenzoic acid phenyl ester, butacaine, 4-amino-N-isopropylbenzamide, 4-aminohippuric acid, N-(4-aminobenzoyl)-β-alanine, N-(4-aminobenzoyl)-L-alanine, N-(4-aminobenzoyl)-L-threonine, N-(4-aminobenzoyl)-L-aspartic acid, N-(4-aminobenzoyl)-L-glutamic acid, 4-amino-2-methoxybenzoic acid, 4-amino-2-ethoxybenzoic acid, 2-propoxy-4-aminobenzoic acid, 2-butyloxy-4-aminobenzoic acid, 4-aminosalicylic acid, 4-amino-2-chlorobenzoic, 2,4-diaminobenzoic acid, 4-amino-2-acetoxybenzoic acid, 4-amino-m-toluic acid, 4-amino-3-hydroxybenzoic acid, 3-butyloxy-4-aminobenzoic acid, 4-amino-3-chlorobenzoic acid, 4-amino-3-bromobenzoic acid, 4-amino-3-nitrobenzoic acid, 4-(methylamino)benzoic acid, 4-(propylamino)benzoic acid, 4-(butylamino)benzoic acid, 4-(D-xylosylamino)benzoic acid, 4-acetamidobenzoic acid, 4-propamidobenzoic acid, 4-(2-(N-piperidine)acetamido)benzoic acid, 4-(D-glucopyranosylamino)benzoic acid, 4-(o-tolilamido)benzoic acid, 4-(3,5-di-t-butyl-4-hydroxybenzamido)benzoic acid, 4-(3,5-diiodo-2-hydroxybenzamido)benzoic acid, N-benzoyl-tyrosyl-4-aminobenzoic acid, 4-(benzylsulfonamido)benzoic acid, 4-guanidinobenzoic acid, 4-amino-5-chloro-2-methoxybenzoic acid, N-(4-amino-5-chloro-2-methoxybenzoyl)glutamic acid, ethyl 4-aminosalicylate, (2-diethylamino)-ethyl-4-amino-salicylate, N-(2-diethylaminoethyl)-4-aminosalicylamide, N-(4-amino-2-hydroxybenzoyl)-L-glutamic acid, ethyl 4-(methylamino)benzoate, (2-diethylamino)ethyl-4-(methylamino)benzoate, N-(4-diethylaminoethyl)-4-(methylamino)benzamide, N-(4-methylaminobenzoyl)glutamic acid, ethyl 4-acetamidobenzoate, (2-diethylamino)ethyl 4-acetamidobenzoate, N-acetylprocainamide, N-(4-acetamidobenzoylyl)-L-glutamic acid, 4-(Methylamino)-5-chloro-2-methoxybenzoic acid, ethyl 5-chloro-2-methoxy-4-methylamino)benzoate, 2-diethylaminoethyl-5-chloro-2-methoxy-4-(methylamin6)benzoate, N-(2-diethylamino)ethyl-4-(methylamino)-5-chloro-2-methoxybenzamide, N-(-4-(methylamino)-5-chloro-2-methoxybenzoyl)-YL-glutamic acid, 4-acetamido-5-chloro-2-methoxybenzoic acid, ethyl 4-acetamido-5-chloro-2-methoxybenzoate, (2-diethylamino)ethyl 4-acetamido-5-chloro-2-methoxybenzoate, N-(2-diethylamino)ethyl-4-acetamido-5-chloro-2-methoxybenzamide, N-(4-acetamido-5-chloro-2-methoxybenzoyl)-L-glutamic acid, 4-(methylamino)salicylic acid, ethyl 4-(methylamino)salicylate, (2-diethylamino)ethyl 4-(methylamino)salicylate, (2-diethylamino)ethyl 4-(methylamino)salicylamide, N-(2-hydroxy-4-(methylamino)-benzoyl)-glutamic acid, 4-acetamidosalicylic acid, ethyl 4-acetamidosalicylate, 4-acetylamino-2-hydroxybenzoic acid 2-(N,N-diethylamino)ethyl ester, N-(2-diethylamino)ethyl 4-acetamidosalicylamide, N-(4-amino-2-hydroxybenzoyl)-L-glutamic acid, 4-amino-N-isopropyl-2-methoxy-benzamide, 4-amino-benzoic acid 3-methyl-but-2-enyl ester, 4-amino-3-chloro-N-pentylbenzamide, 4-amino-5-chloro-N,N-diethyl-2-methoxybenzamide, (2-hydroxyethyl) 4-aminobenzoate, 4-amino-5-chloro-N-(4-chloro-phenyl)-2-methoxybenzamide, isopropyl-4-aminobenzoate, 4-amino-benzoic acid 2-morpholin-4-yl-ethyl ester, 4-amino-N,N-diethylbenzamide, 4-aminobenzoic acid 2-(2-diethylamino-ethoxy)ethyl ester, 3,4-diaminobenzoic acid, 4-amino-3-methoxybenzoic acid, 4-amino-N-phenyl-benzamide, 2-(diethylamino)ethyl 4-(D-ribopyranosylamino)benzoate, 2-(diethylamino)ethyl 4-(D-glucopyranosylamino)benzoate, N-[2-(diethylamino)ethyl]-4-(D-ribopyranosylamino)benzamine, 4-amino-3-hydroxybenzoic acid methyl ester, 4-amino-3-methoxy-benzoic acid ethyl ester, 2-acetoxy-3-methylbenzoic acid, methyl 2-ethoxy4-nitrobenzoate, ethyl-2-hydroxy-4-nitrobenzoate, ethyl 2-propoxy4-nitrobenzoate, ethyl 2-butyloxy4-nitrobenzoate, methyl 4-nitrosalicylate, 4-(N-tosylamido)-benzoic acid, methyl 4-(N-tosylamido)benzoate, methyl 4-(N-propyl-N-tosylamido)benzoate, methyl 4-(propylamino)benzoate, ethyl 4-(2-(N-piperidine)acetamido)benzoate, ethyl 4-(3,5-di-t-butyl4-hydroxybenzamido)-benzoate, 4-(tosylamido)salicylic acid, 2-methoxy4-(N-methyl-N-tosylamido)benzoic acid, di-tert-butyl N-(5-chloro-2-methoxy4-(N-methyl-N-tosylamido)benzoyl)-L-glutamate, methyl 2-methoxymethyloxy4-nitrobenzoate, 2-methoxy4-nitro-N-isopropylbenzamide, and pharmaceutically acceptable salts thereof.
